(19) United States
(12) Patent Application Publication
(10) Pub. No.: US 2025/0360408 A1
(43) Pub. Date: Nov. 27, 2025

(54) NON-TRANSITORY COMPUTER READABLE MEDIUM, INFORMATION PROCESSING METHOD, AND GAME APPARATUS

(71) Applicant: CYGAMES, INC., Tokyo (JP)

(72) Inventors: Minoru Kotanaka, Tokyo (JP); Daisuke Kaneko, Tokyo (JP); Shingo Ikeda, Tokyo (JP); Koichi Kada, Tokyo (JP)

(73) Assignee: CYGAMES, INC., Tokyo (JP)

(21) Appl. No.: 19/292,311

(22) Filed: Aug. 6, 2025

Related U.S. Application Data
(63) Continuation of application No. PCT/JP2024/002441, filed on Jan. 26, 2024.

(30) Foreign Application Priority Data
Feb. 20, 2023 (JP) 2023-024103
Feb. 21, 2023 (JP) 2023-025080

(51) Int. Cl. A63F 13/537

(52) U.S. Cl. CPC A63F 13/537

(57) ABSTRACT

A non-transitory computer readable medium stores a program causing a computer to execute: processing of, in a game including a plurality of turns, allowing a player to select, for each of the plurality of turns, any of a plurality of commands for ending the turn; processing of storing obtainment information on a predetermined game content, based on the command selected by a player; processing of ending the turn based on the command being selected; processing of determining a special effect to activate in a case where a special command is selected by a player, based on a predetermined number of pieces of the predetermined game content obtained; and processing of activating the special effect determined, in a case where the special command is selected.

### CROSS REFERENCE TO RELATED APPLICATIONS

This application is a continuation application of International Application No. PCT/JP2024/002441, filed on Jan. 26, 2024, which claims priority to Japanese Patent Application No. 2023-024103, filed on Feb. 20, 2023, and Japanese Patent Application No. 2023-025080, filed on Feb. 21, 2023, the entire contents of which are incorporated by reference herein.

### BACKGROUND ART

### Technical Field

The present invention relates to an information processing program, an information processing method, and a game apparatus.

As described in Patent Document 1, a game including a plurality of turns is known. The player can select any of a plurality of commands for each turn. Various parameters are changed based on the command selected by the player. The turn is ended by the selection of the command, and the next turn is started.

### CITATION LIST

### Patent Literature

Patent Document 1: JP 7198902 B

### SUMMARY OF INVENTION

### Technical Problem

As described above, in the game in which a command is selected for each turn, there is a problem in that if the game lacks in strategic performance required from the player, this may cause a reduction in the player's motivation to play the game.

An object of the present invention is to provide an information processing program, an information processing method, and a game apparatus that can motivate a player to play the game by improving the strategic performance.

### Solution to Problem

To solve the problems described above, an information processing program causes a computer to execute:
processing of, in a game including a plurality of turns, allowing a player to select, for each of the plurality of turns, any of a plurality of commands for ending the turn;
processing of storing obtainment information on predetermined game content, based on the command selected by a player;
processing of ending the turn, based on the command being selected;
processing of determining a special effect to activate in a case where a special command is selected by a player, based on a predetermined number of pieces of the predetermined game content obtained; and
processing of activating the special effect determined, in a case where the special command is selected.

The special effect may include a time-limited effect with the number of turns set as an effective period, and
the time-limited effect may be active during the effective period.

The information processing program may cause a computer to execute:
processing of activating a first effect associated with the predetermined game content obtained, based on obtainment of the predetermined game content, and
processing of deactivating the first effect, based on the special command being selected.

The information processing program may cause a computer to execute:
processing of allowing a player to select the special command in a case where the number of obtained pieces of predetermined game content reaches a specified number.

The information processing program may cause a computer to execute
processing of determining a plurality of second effects, based on a plurality of pieces of predetermined game content, the number of which is less than the predetermined number, wherein
the processing of determining the special effect includes determining the special effect, based on the second effects.

The processing of determining the special effect may include determining a special effect from among a plurality of types of the special effect provided in advance.

The information processing program may cause a computer to execute:
processing of managing, for each of the plurality of types of the special effect, information associated with the number of times the special effect has been activated, wherein
a benefit of the special effect provided during the game increases with an increase in the number of times the special effect has been activated.

The information processing program may further cause a computer to execute:
processing of displaying an image corresponding to the special effect in association with the special command selectable by a player.

In order to solve the problem described above, an information processing method performed by one or more computers includes:
processing of, in a game including a plurality of turns, allowing a player to select, for each of the plurality of turns, any of a plurality of commands for ending the turn;
processing of storing obtainment information on predetermined game content, based on the command selected by a player;
processing of ending the turn, based on the command being selected;
processing of determining a special effect to activate in a case where a special command is selected by a player, based on a predetermined number of pieces of the predetermined game content obtained; and
processing of activating the special effect determined, in a case where the special command is selected.

In order to solve the problem described above, a game apparatus includes one or more computers, the one or more computers executing:
processing of, in a game including a plurality of turns, allowing a player to select, for each of the plurality of turns, any of a plurality of commands for ending the turn;
processing of storing obtainment information on predetermined game content, based on the command selected by a player;
processing of ending the turn, based on the command being selected;
processing of determining a special effect to activate in a case where a special command is selected by a player, based on a predetermined number of pieces of the predetermined game content obtained; and
processing of activating the special effect determined, in a case where the special command is selected.

### Effects of Disclosure

According to the present invention, the motivation of the players to play can be improved by improving the strategic performance.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an option setting screen. FIG. 3C is a diagram for describing an example of a profile setting screen.

FIG. 4 is a diagram for describing a rough progression flow of a nurture game.

FIG. 5A is a diagram for describing an example of scenario initial additional value data. FIG. 5B is a diagram for describing an example of scenario initial upper limit value data. FIG. 5C is a diagram for describing an example of scenario event additional value data.

FIG. 6A is a diagram for describing a nurture target character selection screen. FIG. 6B is a first diagram for describing a character detail screen. FIG. 6C is a second diagram for describing the character detail screen.

FIG. 7A is a diagram for describing an ability parameter (initial value) table. FIG. 7B is a diagram for describing an aptitude parameter (initial value) table. FIG. 7C is a diagram for describing skills. FIG. 7D is a diagram for describing an exclusive event.

FIG. 8 is a diagram for describing a character strengthening screen.

FIG. 9A is a first diagram for describing an inheritance character selection screen. FIG. 9B is a first diagram for describing a nurtured character list screen.

FIG. 9C is a second diagram for describing the inheritance character selection screen. FIG. 9D is a third diagram for describing the inheritance character selection screen.

FIG. 10 is a diagram for describing an inheritance system.

FIG. 11 is a diagram for describing factor information.

FIG. 12A is a diagram for describing the effects of basic ability factors. FIG. 12B is a diagram for describing the effects of character factors.

FIG. 13A is a diagram for describing compatibility determination targets, and FIG. 13B is a diagram for describing compatibility determination items.

FIG. 14A is a first diagram for describing a support card organization screen. FIG. 14B is a diagram for describing a support card selection screen. FIG. 14C is a second diagram for describing the support card organization screen.

FIG. 15A is a diagram for describing a support card table. FIG. 15B is a diagram for describing support effects. FIG. 15C is a diagram for describing base skills. FIG. 15D is a diagram for describing support events.

FIG. 16A is a diagram for describing a final confirmation screen. FIG. 16B is a diagram for describing a preset selection screen.

FIG. 17 is a diagram for describing selection items in each turn.

FIG. 18 is a diagram for describing a top screen.

FIG. 19A is a first diagram for describing a training screen. FIG. 19B is a second diagram for describing the training screen. FIG. 19C is a diagram for describing a training result notification screen. FIG. 19D is a diagram for describing an event screen.

FIG. 20A is a first diagram for describing an inheritance event. FIG. 20B is a second diagram for describing the inheritance event. FIG. 20C is a third diagram for describing the inheritance event. FIG. 20D is a fourth diagram for describing the inheritance event.

FIG. 21A is a first diagram for describing a skill screen. FIG. 21B is a second diagram for describing the skill screen.

FIG. 22A is a first diagram for describing a race selection screen. FIG. 22B is a diagram for describing a race start screen. FIG. 22C is a first diagram for describing a race result screen. FIG. 22D is a second diagram for describing the race result screen.

FIG. 23 is a third diagram for describing the training screen.

FIG. 24A is a diagram for describing the relationship between a special character and a fragment item. FIG. 24B is a diagram for describing an obtainment condition of a fragment item.

FIG. 25 is a first diagram for describing a knowledge table dialog.

FIG. 26 is a second diagram for describing the knowledge table dialog.

FIG. 27 is a third diagram for describing the knowledge table dialog.

FIG. 28 is a diagram for describing a Goddess' Wisdom determination method.

FIG. 29 is a diagram illustrating the effect of a fragment item.

FIG. 30 is a diagram for describing special effects.

FIG. 31A is a first diagram for describing an effect details dialog. FIG. 31B is a second diagram for describing the effect details dialog.

FIG. 32 is a diagram for describing a history dialog.

FIG. 33 is a diagram for describing a rough flow of turn-start processing.

FIG. 34 is a diagram for describing the placing percentage for training items.

FIG. 35A is a diagram for describing training levels. FIG. 35B is a diagram for describing fixed increase value (speed). FIG. 35C is a diagram for describing a fixed increase value (power) table.

FIG. 36A is a diagram for describing a nurture completion screen. FIG. 36B is a second diagram for describing the nurture completion screen. FIG. 36C is a third diagram for describing the nurture completion screen.

FIG. 37 is a diagram for describing a configuration of a memory in the player terminal and a function as a computer.

FIG. 38 is a diagram for describing a configuration of a memory in the server and a function as a computer.

FIG. 39 is a sequence diagram for describing processing of the player terminal and the server related to the nurture game.

FIG. 40 is a flowchart for describing preparation stage processing in the player terminal.

FIG. 41 is a flowchart for describing preparation stage processing in the server.

FIG. 42 is a flowchart for describing nurture stage processing in the server.

FIG. 43 is a flowchart for describing turn-start processing in the server.

FIG. 44 is a flowchart for describing nurture stage processing in the player terminal.

FIG. 45 is a flowchart for describing knowledge table-related processing in the player terminal.

FIG. 46 is a flowchart for describing selection command reception processing in the server.

FIG. 47 is a flowchart for describing fragment item obtainment processing in the server.

FIG. 48 is a flowchart for describing result information reception processing in the player terminal.

FIG. 49 is a flowchart for describing nurture game end processing in the server.

FIG. 50 is a diagram for describing selection items in each turn.

FIG. 51 is a diagram for describing the top screen.

FIG. 52A is a first diagram for describing a training screen. FIG. 52B is a second diagram for describing the training screen. FIG. 52C is a diagram for describing the training result notification screen. FIG. 52D is a diagram for describing the event screen.

FIG. 53A is a first diagram for describing an inheritance event. FIG. 53B is a second diagram for describing the inheritance event. FIG. 53C is a third diagram for describing the inheritance event. FIG. 53D is a fourth diagram for describing the inheritance event.

FIG. 54A is a first diagram for describing a skill screen. FIG. 54B is a second diagram for describing the skill screen.

FIG. 55A is a first diagram for describing a race selection screen. FIG. 55B is a diagram for describing the race start screen. FIG. 55C is a first diagram for describing the race result screen. FIG. 55D is a second diagram for describing the race result screen.

FIG. 56 is a third diagram for describing the training screen.

FIG. 57A is a diagram for describing the relationship between a special character and game content. FIG. 57B is a diagram for describing the relationship between an effect and game content. FIG. 57C is a diagram for describing an obtainment condition for game content.

FIG. 58 is a first diagram for describing a knowledge table dialog.

FIG. 59 is a second diagram for describing the knowledge table dialog.

FIG. 60 is a third diagram for describing the knowledge table dialog.

FIG. 61 is a diagram for describing a method of determining game content.

FIG. 62 is a diagram for describing the effect of game content.

FIG. 63 is a diagram for describing special effects.

FIG. 64A is a first diagram for describing an effect details dialog. FIG. 64B is a second diagram for describing the effect details dialog.

FIG. 65 is a diagram for describing the history dialog.

FIG. 66 is a diagram for describing a rough flow of turn-start processing.

FIG. 67 is a diagram for describing the placing percentage for training items.

FIG. 68A is a diagram for describing training levels. FIG. 68B is a diagram for describing obtainment conditions for training points.

FIG. 69A is a diagram for describing fixed increase value (speed). FIG. 69B is a diagram for describing a fixed increase value (power) table.

FIG. 70A is a diagram for describing a nurture completion screen. FIG. 70B is a second diagram for describing the nurture completion screen. FIG. 70C is a third diagram for describing the nurture completion screen.

FIG. 71 is a diagram for describing a configuration of a memory in the player terminal and a function as a computer.

FIG. 72 is a diagram for describing a configuration of a memory in the server and a function as a computer.

FIG. 73 is a sequence diagram for describing processing of the player terminal and the server related to the nurture game.

FIG. 74 is a flowchart for describing preparation stage processing in the player terminal.

FIG. 75 is a flowchart for describing preparation stage processing in the server.

FIG. 76 is a flowchart for describing nurture stage processing in the server.

FIG. 77 is a flowchart for describing turn-start processing in the server.

FIG. 78 is a flowchart for describing nurture stage processing in the player terminal.

FIG. 79 is a flowchart for describing knowledge table-related processing in the player terminal.

FIG. 80 is a flowchart for describing selection command reception processing in the server.

FIG. 81 is a flowchart for describing game content obtainment processing in the server.

FIG. 82 is a flowchart for describing result information reception processing in the player terminal.

FIG. 83 is a flowchart for describing nurture game end processing in the server.

### DESCRIPTION OF EMBODIMENTS

Hereinafter, an aspect of an embodiment of the present invention will be described in detail with reference to the accompanying drawings. Numerical values and the like described in the embodiment are merely examples for facilitating understanding, and do not limit the present invention unless otherwise specified. In this specification and the drawings, elements having substantially the same function and configuration are denoted by the same reference numerals, and redundant description thereof will be omitted, and elements not directly relating to the present invention will not be illustrated.

### Overall Configuration of Information Processing System S

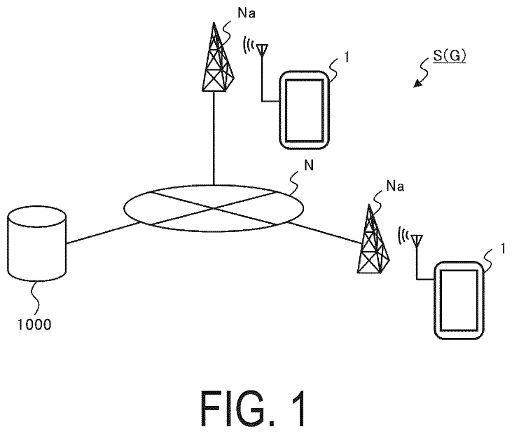

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of the game, and the game can progress via cooperation between the player terminal 1 and the server 1000.

The player terminal 1 can establish communication with the server 1000 via the communication network N. The player terminal 1 widely includes an electronic device capable of establishing a wireless or wired communication connection with the server 1000. Examples of the player terminal 1 include a smartphone, a mobile phone, a tablet device, a personal computer, a game console, and the like. In the present embodiment, a case where a smartphone is used as the player terminal 1 will be described.

The server 1000 is communicatively connected to a plurality of player terminals 1. The server 1000 accumulates various types of information for each player who plays the game. In addition, the server 1000 mainly performs processing such as updating the accumulated information and downloading images and various types of information to the player terminal 1, based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and establishes a wireless or wired communication connection between the player terminal 1 and the server 1000.

### Hardware Configuration of Player Terminal 1 and Server 1000

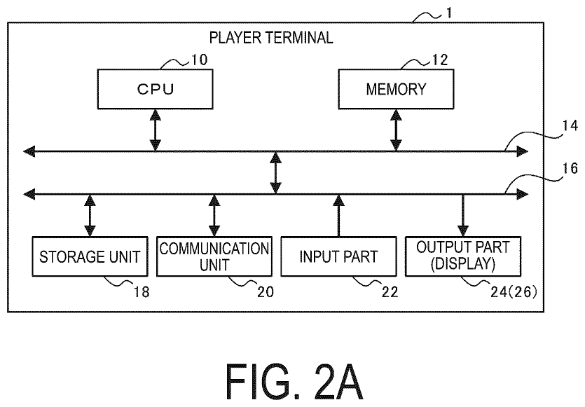

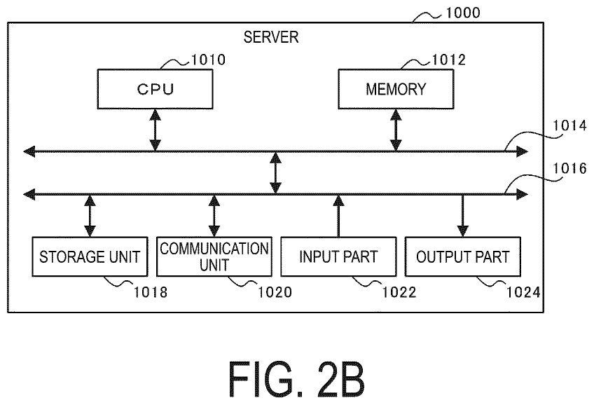

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 widely includes apparatuses that allow the player to identifiably input their intention.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Details of Game

Next, a game provided by the information processing system S and the game apparatus G of the present embodiment will be described. The player can possess game content obtained through a lottery called a gacha or game content distributed from a management side. In the present embodiment, the player can possess character cards and support cards as game content. That is, one character is always associated with a character card or support card. The character associated with the character card is a nurture target in the nurture game. Hereinafter, a character associated with a character card may be referred to simply as a character.

As will be described in detail below, in the game according to the present embodiment, a nurture game is provided. In the nurture game, the player can nurture a character and create a nurtured character associated with various parameters. In addition, the nurture game according to the present embodiment has a game property of nurturing a character associated with a character card while having the character participate in a race simulating horse racing.

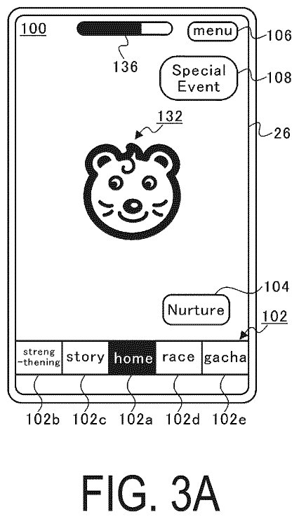

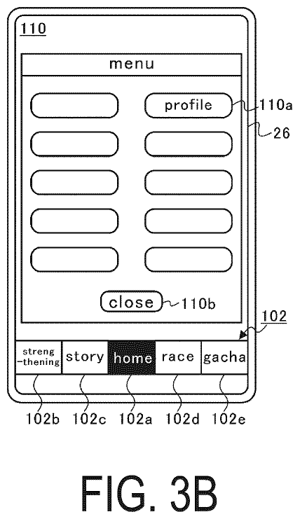

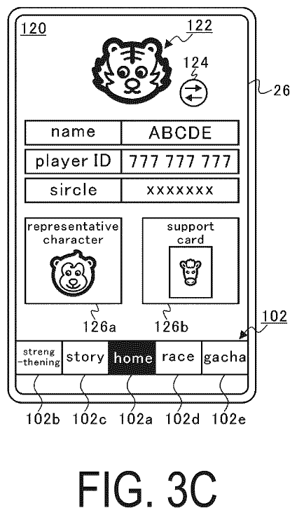

FIG. 3A is a diagram for describing an example of a home screen 100. When the game application is run on the player terminal 1, the home screen 100 is displayed on the display 26. A menu bar 102 is displayed at a lower portion of the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a gacha screen selection operation portion 102e. In the menu bar 102, the operation portion corresponding to the screen being displayed is highlighted so that the screen being displayed on the display 26 can be identified.

When the home screen selection operation portion 102a is tapped, the home screen 100 illustrated in FIG. 3A is displayed on the display 26.

When the strengthening screen selection operation portion 102b is tapped, a strengthening screen (not illustrated) is displayed. On the strengthening screen, it is possible to strengthen the character or the support card possessed by the player. The player can increase the level set for the character or the support card by strengthening the character or the support card. Various parameters are set for the character and the support card, and the parameter increases as the level increases. By increasing the parameters of the character and the support card, the player can nurture the nurtured character to have higher stats in the nurture game.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided in which a nurtured character nurtured in the nurture game which will be described can be caused to participate. On the racing game selection screen, the player can select a racing game in which the nurtured character is entered. An example of a racing game is a team competition game in which a team formed by a plurality of nurtured characters and a team of other players selected by a computer are made to compete with each other. The team competition game has a game property of competing with other players for ranking.

When the gacha screen selection operation portion 102e is tapped, a gacha screen (not illustrated) is displayed. On the gacha screen, the player can play a so-called gacha lottery by spending in-game currency or tickets. With the gacha lottery, a character card or support card can be obtained.

In addition, on the home screen 100, a nurture game operation portion 104 is provided above the menu bar 102. When the nurture game operation portion 104 is tapped, a nurture game screen is displayed, and a nurture game which will be described below is started. The nurture game is roughly divided into a preparation stage and a nurture stage. First, in the preparation stage, the player selects one character from among characters possessed by the player and sets the character as a character to be nurtured (hereinafter referred to as a nurture target character).

Further, in the preparation stage, the player sets a deck to be used when nurturing the nurture target character. The deck is formed of a plurality of inheritance characters, which will be described in detail below, and a plurality of support cards. Thus, in the nurture game, the inheritance characters and the support cards forming the deck are used.

When the settings for the nurture target character and the deck (the inheritance characters and the support cards) are completed, the processing transitions from the preparation stage to the nurture stage, and the game for nurturing the nurture target character is started. In the nurture game, parameters of the nurture target character can be changed. The player can possess the character nurtured in the nurture game as a nurtured character. As described above, the player can form a team of nurtured characters possessed by the player and use the nurtured characters in a team competition game or the like.

As described above, the main purpose of the game according to the present embodiment is to create nurtured characters via the nurture game and to increase the ranking in the team competition game using the nurtured characters.

In addition, in the present embodiment, a function for sharing a nurtured character or a support card among players and a function for sharing information among a plurality of players are provided. The player can set a nurtured character and a support card that can be used by another player in the nurture game. To be specific, as illustrated in FIG. 3A, a setting operation portion 106 is provided in an upper right portion of the home screen 100. When the setting operation portion 106 is tapped, an option setting screen 110 is displayed.

FIG. 3B is a diagram for describing an example of the option setting screen 110. The option setting screen 110 is a screen on which various types of information can be confirmed and set. The option setting screen 110 is provided with a plurality of operation portions, and when an operation portion is tapped, information corresponding to the operation portion can be confirmed and set.

The operation portions of the option setting screen 110 include a profile setting operation portion 110a and a close operation portion 110b. When the close operation portion 110b is tapped, the option setting screen 110 is closed and the home screen 100 is displayed. When the profile setting operation portion 110a is tapped, a profile setting screen 120 is displayed.

FIG. 3C is a diagram for describing an example of the profile setting screen 120. On the profile setting screen 120, the player can confirm and set their own profile information. The profile information includes a profile character, a player name, a player ID, a circle the player belongs to, a representative character, and a rental card.

The profile character functions as a character that is displayed when the player's information is viewed by another player. For example, the profile character is displayed when the player uses a function of a circle being a place for sharing information with other players. On the profile setting screen 120, a profile character image 122 that is currently set is displayed. Near the profile character image 122, a change button 124 is provided. When the change button 124 is tapped, a profile character change screen (not illustrated) is displayed. The player can change the profile character on the profile character change screen.

The profile setting screen 120 displays the player name set by the player, the player ID given to the player, and the name of the circle the player belongs to. The profile setting screen 120 is provided with a representative character setting operation portion 126a and a rental card setting operation portion 126b.

When the representative character setting operation portion 126a is tapped, a representative character setting screen (not illustrated) is displayed. The player can set any one of the nurtured characters nurtured by the player as a representative character on the representative character setting screen. In the representative character setting operation portion 126a, an icon image indicating the currently set representative character is displayed. As will be described in detail below, the representative character can be used for forming a deck as an inheritance character in the nurture game played by another player.

When the rental card setting operation portion 126b is tapped, a rental card setting screen (not illustrated) is displayed. The player can set any one of the support cards possessed by the player as a rental card on the rental card setting screen. In the rental card setting operation portion 126b, an icon image indicating the currently set rental card is displayed. As described above, a support card set as a rental card can be used for forming a deck by another player and is used in the nurture game played by another player.

Although a detailed description is omitted, when the setting of the profile information is changed on the profile setting screen 120, setting change information is transmitted to the server 1000. In the server 1000, profile information is stored for each player.

In addition, in the present embodiment, various limited-time events are held irregularly. A special event icon 108 is displayed on the home screen 100 during the active period of the special event which is a limited-time event. When the special event icon 108 is tapped, a special event screen is displayed. On the special event screen, for example, the player can exchange special event points provided only in the special event with various rewards.

When the nurture game operation portion 104 is tapped on the home screen 100, a nurture game screen is displayed and the nurture game is started. The player can play the nurture game by spending game points. The game points are given to the player at a rate of a predetermined value (for example, +1) every predetermined amount of time (for example, 10 minutes). An upper limit value (for example, 100) is set for the game points that can be possessed by the player, and the player can possess game points within the range of the upper limit value. A game point display bar 136 is provided in an upper portion of the home screen 100, and a ratio of the currently possessed game points to the upper limit value is visually displayed.

The game points are subtracted by a predetermined value (for example,-30) at a time when the nurture game is started. Thus, when the player does not possess the required game points, the player cannot start the nurture game. However, the player can possess an item for recovering game points and can recover game points using the item. For example, this item can be given as a reward in the nurture game or the team competition game or can be obtained by spending in-game currency. Hereinafter, the nurture game will be described in detail.

### Nurture Game

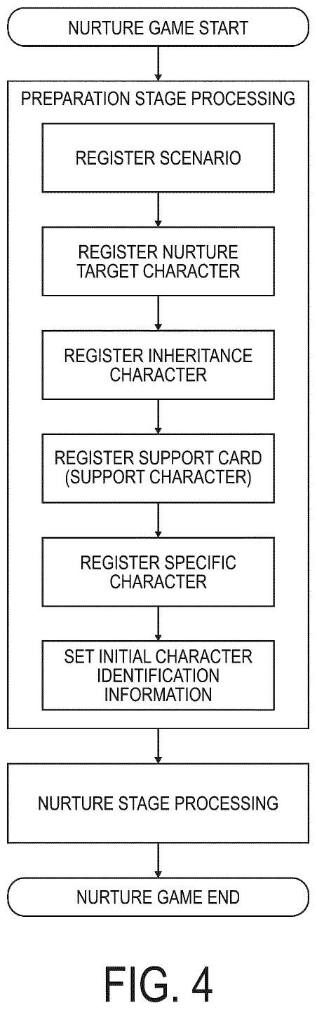

FIG. 4 is a diagram for describing a rough flow of the nurture game. The nurture game is roughly divided into a setting game and a nurture main game. As will be described in detail below, the nurture main game is a game in which one character selected from among the characters possessed by the player is nurtured as a character to be nurtured (hereinafter, also referred to as a nurture target character).

In addition, the setting game is a game in which the player registers the nurture target character and a deck (inheritance characters and support cards), and is corresponding to the preparation stage of the nurture game. Hereinafter, the processing executed in the setting game is referred to as preparation stage processing, and the processing executed in the nurture main game is referred to as nurture stage processing. Here, in order to facilitate understanding, a rough flow of the preparation stage processing and the nurture stage processing will be described first.

As illustrated in FIG. 4, in the preparation stage processing, scenario registration, nurture target character registration, inheritance character registration, support card registration, and specific character registration are performed in this order. Note that the order of the registration and setting processing described above is merely an example. Thus, the order of the registration and setting processing described above can be changed as appropriate.

### Preparation Stage Processing

In the preparation stage processing, registration of a scenario, registration of a nurture target character, registration of a deck (inheritance characters and support cards) are mainly performed. Note that the support cards are for assisting the nurturing of the nurture target character. One character is always associated with each support card, and the character associated with the support card registered in the preparation stage processing assists the nurturing of the nurture target character. Hereinafter, a character associated with a support card is referred to as a support character.

### Scenario Registration

When the player taps the nurture game operation portion 104 on the home screen 100, a scenario selection screen (not illustrated) is displayed. In the present embodiment, a plurality of scenarios of the nurture main game are provided. In each scenario of the nurture main game, a final goal, a goal for during the game, and the like are set. The player needs to sequentially clear the goal set for each scenario. The goal, a time period until the goal is achieved, the game difficulty, and the like are different for each scenario.

Furthermore, the nurture main game has a story component, and the game progresses following the story. Also, during the nurture main game, events occur at various timings. Events that occur during the nurture main game include events specific to scenarios. Thus, in the plurality of scenarios, at least a portion of the events that occur during the nurture main game are different from each other. The player can select any one of the plurality of scenarios on the scenario selection screen.

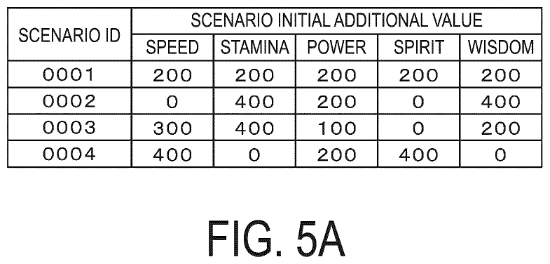

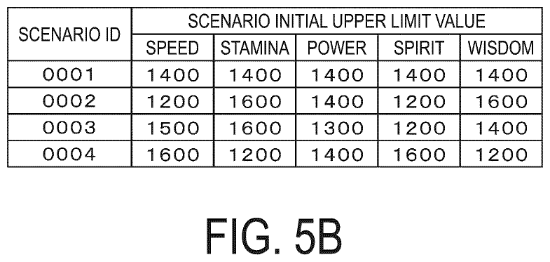

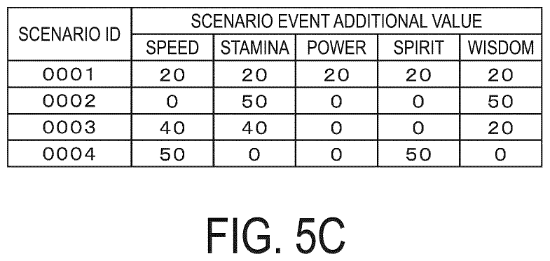

FIG. 5A is a diagram for describing an example of scenario initial additional value data. FIG. 5B is a diagram for describing an example of scenario initial upper limit value data. FIG. 5C is a diagram for describing an example of scenario event additional value data. As illustrated in FIG. 5A, each scenario is associated with a unique scenario ID. When the player selects a scenario on the scenario selection screen, a scenario ID associated with the selected scenario is registered. In this example, four scenario IDs 0001 to 0004 are provided.

As will be described in detail below, the goal of the nurture game includes increasing the ability parameters of a nurture target character. The five ability parameters provided correspond to speed, stamina, power, spirit, and wisdom. Higher values for the five ability parameters mean that races will develop more advantageously for the nurture target character.

However, an upper limit value is set for each ability parameter, and in the nurture main game, the value for each ability parameter is updated only within the range of the upper limit value, and updating of the ability parameter exceeding the upper limit value is restricted. At the start of the nurture main game, an initial upper limit value for each ability parameter is set. This initial upper limit value is different for each scenario. The upper limit value for each ability parameter may increase from the initial upper limit value during the game.

The scenario initial additional value data is stored in the player terminal 1 and the server 1000. The scenario initial additional value data is data in which the respective initial additional values of the five ability parameters are associated with the scenario ID. In the present embodiment, at the start of the nurture main game, the initial upper limit value for each ability parameter is set based on the scenario initial additional value data.

Specifically, a common base value is preset for each ability parameter. In the present embodiment, “1200” is set as the common base value. This common base value is common for all scenarios and all ability parameters. However, the common base value may be different for each scenario or may be different for each ability parameter. Then, at the start of the nurture main game, the scenario initial additional value corresponding to the scenario selected by the player is added to the common base value, and the initial upper limit value for each ability parameter is set.

For example, as illustrated in FIG. 5A, according to the scenario initial additional value data, “200” is set as the scenario initial additional values of the five ability parameters associated with the scenario ID “0001”. Thus, when the scenario ID “0001” is selected and the nurture main game is started, the initial upper limit values for the five ability parameters are all “1400”.

Furthermore, for example, when the scenario ID “0002” is selected and the nurture main game is started, the initial upper limit values for the ability parameters of speed and spirit are “1200”, which is the common base value, the initial upper limit values for the ability parameters of stamina and the wisdom are “1600”, and the initial upper limit value of the ability parameter of power is “1400”.

Here, the initial upper limit value is derived by adding the initial additional value of the ability parameter to the common base value. However, as illustrated in FIG. 5B, scenario initial upper limit value data may be provided, and the initial upper limit value for each ability parameter may be derived based on the scenario initial upper limit value data. According to the scenario initial upper limit value data, the initial upper limit value for each of the five ability parameters is associated with the scenario ID. In the scenario initial upper limit value data, the value of the initial upper limit value associated with each scenario ID is a value obtained by adding the initial additional value of the scenario initial additional value data to the common base value.

As described above, the scenario initial upper limit value associated with the scenario ID may be set as the initial upper limit value for each ability parameter. Alternatively, a value obtained by adding the scenario initial additional value to the common base value may be set as the initial upper limit value for each ability parameter.

In the nurture main game, a scenario event in which the upper limit value for each ability parameter increases may occur at a predetermined timing. When a scenario event occurs, the scenario event additional value associated with the scenario event is added to the upper limit value at that point in time. For example, when a predetermined scenario event occurs in the nurture main game having the scenario ID of “0001”, the upper limit values of the five ability parameters increase by “20”.

As illustrated in FIG. 5C, the upper limit value of the ability parameter to be increased by the scenario event differs for each scenario. Note that a plurality of scenario events in which the upper limit values of the ability parameters are increased may be provided for one scenario or may not be provided for a scenario. In addition, the occurrence timing of the scenario event may be common for all scenarios or may be different.

As described above, the upper limit values for the ability parameters vary depending on the scenario selected by the player. As a result, it is possible to nurture characters having different abilities and characteristics for each scenario. Thus, the player's motivation to play in various scenarios is improved.

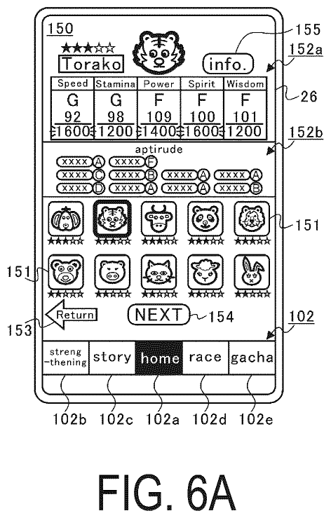

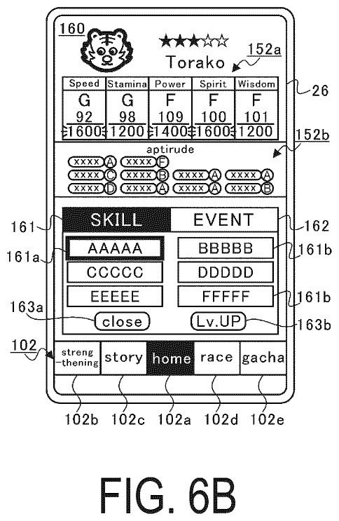

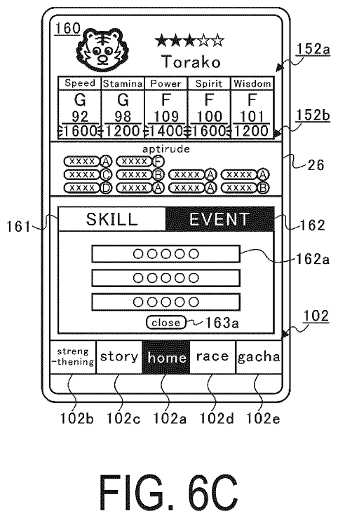

Registration of Nurture Target Character FIG. 6A is a diagram for describing a nurture target character selection screen 150. When the player selects a scenario on the scenario selection screen, the nurture target character selection screen 150 illustrated in FIG. 6A is displayed. At a central portion of the nurture target character selection screen 150, a plurality of character icons 151 are displayed and a list of characters possessed by the player is displayed.

In addition, an ability parameter display portion 152a and an aptitude parameter display portion 152b are displayed in an upper portion of the nurture target character selection screen 150. In addition, a return operation portion 153 and a next operation portion 154 are displayed in a lower portion of the nurture target character selection screen 150.

In the present embodiment, the initial values for the ability parameters are set for each character. The initial values for the ability parameters of the character corresponding to a character icon 151 selected by the player are displayed as a value in an ability parameter display portion 152a. In the present embodiment, the larger the numerical value of the ability parameter is, the higher the ability is.

The initial upper limit value for each ability parameter is displayed in the ability parameter display portion 152a. In other words, the upper limit value for each ability parameter set at the start of the nurture main game is displayed in the ability parameter display portion 152a in a state where the player can select a scenario or after the player has selected a scenario. In the ability parameter display portion 152a, the initial upper limit value corresponding to the scenario selected by the player is displayed as the denominator, and the initial value of the ability parameter of the character selected by the player is displayed in the numerator.

Here, in the ability parameter display portion 152a, the initial upper limit value exceeding the common base value are identifiably displayed. For example, in the example illustrated in FIG. 6A, the initial upper limit values of speed, power, and spirit exceed “1200”, which is the common base value. Thus, in the ability parameter display portion 152a, the initial upper limit values of speed, power, and spirit are identifiably displayed with respect to the initial upper limit values of stamina and wisdom. Here, as the identification display, the initial upper limit value exceeding the common base value is displayed blinking or in a different color.

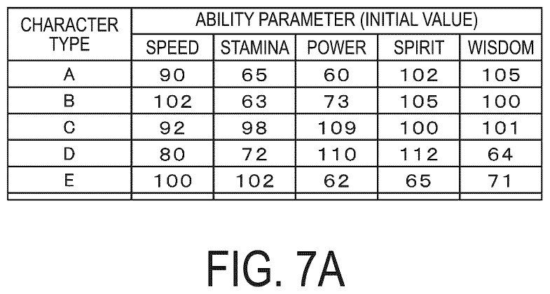

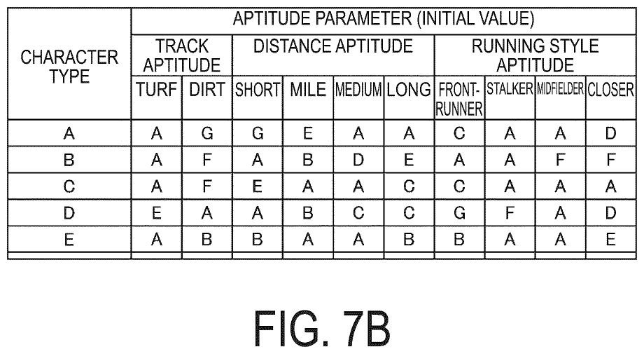

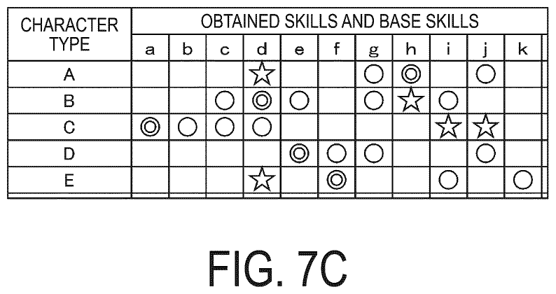

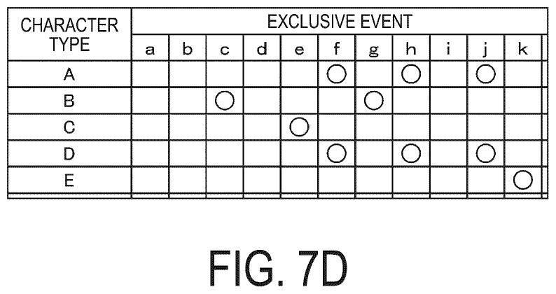

FIG. 7A is a diagram for describing an ability parameter (initial value) table. In the present embodiment, as illustrated in FIG. 7A, initial values of ability parameters for each character are stored in the ability parameter (initial value) table. Then, based on the initial values of the ability parameters stored in the ability parameter (initial value) table, the initial values of the ability parameters are displayed in the ability parameter display portion 152a.

In the present embodiment, an initial value of an ability parameter is set for each one of a plurality of types of abilities for each character. To be more specific, a speed ability parameter denoted by “Speed” in the ability parameter display portion 152a, a stamina ability parameter denoted by “Stamina” in the ability parameter display portion 152a, a power ability parameter denoted by “Power” in the ability parameter display portion 152a, a spirit ability parameter denoted by “Spirit” in the ability parameter display portion 152a, and a wisdom ability parameter denoted by “Wisdom” in the ability parameter display portion 152a are provided as the ability parameters.

Note that the initial values for the ability parameters of each character are increased by strengthening the character (character card). For example, each character is provided with stat levels of five stages, and the player can increase the stat level of the character by spending in-game currency and predetermined items. As the stat level of the character increases, the initial value of the ability parameter of the character increases.

The initial values when the character is at a predetermined level are illustrated in FIG. 7A. Note that the player can increase the value of the ability parameters in the nurture main game. That is, the goal of the nurture main game is to nurture a character to have higher numerical values for the ability parameters.

In the present embodiment, an aptitude parameter (initial value) is set for each character. As illustrated in FIG. 6A, the initial values of the aptitude parameters of the character corresponding to the character icon 151 selected by the player are displayed with an alphabetical letter in the aptitude parameter display portion 152b.

FIG. 7B is a diagram for describing an aptitude parameter (initial value) table. In the present embodiment, as illustrated in FIG. 7B, the initial values of the aptitude parameters for each character are stored in the aptitude parameter (initial value) table. The initial values of the aptitude parameters are set to any of seven levels of alphabetical letters A to G. For the initial values of the aptitude parameters, A indicates the highest aptitude and G indicates the lowest aptitude. Based on the initial values of the aptitude parameters stored in the aptitude parameter (initial value) table, the initial values of the aptitude parameters are displayed in the aptitude parameter display portion 152b.

In the present embodiment, an initial value of the aptitude parameter is set for each one of a plurality of types of aptitude for each character. Specifically, the aptitude parameters include aptitude parameters related to track aptitude for turf and dirt; aptitude parameters related to distance aptitude for short distance, mile, medium distance, and long distance; and aptitude parameters related to running style aptitude for front-runner, stalker, midfielder, and closer.

In the nurture game, the player can enter the nurture target character in various races. At this time, if the aptitude of the nurture target character that matches the race content is high, the nurture target character will be more advantageous in the developments of the race.

The initial values of the aptitude parameters for each character may be increased by spending in-game currency. Further, the values of the aptitude parameters may change in the nurture main game. Further, in the nurture main game, the aptitude parameter may be set to S, which is a higher aptitude than A.

FIG. 6B is a first diagram for describing a character detail screen 160. FIG. 6C is a second diagram for describing the character detail screen 160. When tapping and holding the character icon 151 on the nurture target character selection screen 150, the character detail screen 160 is displayed on the display 26. On the character detail screen 160, the details of the abilities of the character corresponding to the character icon 151 which was tapped and held on the nurture target character selection screen 150 are displayed.

A skill operation portion 161 and an event operation portion 162 are displayed at a central portion of the character detail screen 160. As illustrated in FIG. 6B, when the character detail screen 160 is first displayed, the skill operation portion 161 is highlighted, and the skills provided for each character are displayed. A skill is an ability that may be activated when a predetermined condition is satisfied while a race or a team race is being executed as will be described below. Activating skills gives each character an advantage in the developments of the race.

FIG. 7C is a diagram for describing skills. As illustrated in FIG. 7C, each character possesses a plurality of skills. As illustrated in FIG. 6B, the skills possessed by the character (hereinafter referred to as base skills) are displayed on the character detail screen 160. In the nurture main game, the base skills of the nurture target character can be obtained when a predetermined condition is satisfied. Note that a skill is not activated just by being in possession of it during a race and first becomes possible to be activated by the base skill being obtained. Hereinafter, a skill in a state of being able to be activated by the character, that is, a skill obtained by the character, is referred to as an obtained skill.

One obtained skill is set for the character from the beginning of the nurture main game. In addition to the obtained skill, a plurality of base skills are set for the character. A base skill can be obtained by spending skill points which will be described below after the start of the nurture main game. That is, a base skill can become an obtained skill in exchange for skill points.

In the present embodiment, a skill indicated by “⊚” in FIG. 7C is displayed as an obtained skill on the character detail screen 160 in FIG. 6B. Also, a skill indicated by “◯” in FIG. 7C is displayed as a base skill on the character detail screen 160 in FIG. 6B. In the present embodiment, as illustrated in the character detail screen 160 in FIG. 6B, the obtained skill is highlighted so that the obtained skill and the base skill can be easily distinguished from each other.

Specifically, on the character detail screen 160 illustrated in FIG. 6B, one obtained skill is displayed in an obtained skill display field 161a and seven base skills are displayed in a base skill display field 161b. Note that the number of obtained skills and base skills may be different for each character. Further, for example, the number of obtained skills or base skills for each character may be increased by an increase in the level of the character, spending of in-game currency or items, and the like.

Here, base skills include awakening skills. The awakening skill is a skill that becomes a base skill when an unlock condition is satisfied. That is, an awakening skill with an unsatisfied unlock condition is not a base skill. Thus, the awakening skill with an unsatisfied unlock condition cannot be obtained in the nurture main game.

In FIG. 7C, an awakening skill is indicated by a star symbol. Here, four awakening skills are set for each character. However, the number of awakening skills may be different for each character. Note that the awakening skills differ for each character. In addition, for example, skill d in the diagram is set as an awakening skill for character A, set as an obtained skill for character B, and set as a normal base skill for character C. As described above, skills include skills set differently, such as an obtained skill, a base skill, and an awakening skill, depending on the character.

In the present embodiment, the awakening level of the character is set as the condition for unlocking the awakening skill. The characters (character cards) are associated with the stat levels described above and the awakening level. The player can individually increase the stat levels and the awakening level. As illustrated in FIG. 6B, a close operation portion 163a and a strengthening operation portion 163b are provided on the character detail screen 160. When the strengthening operation portion 163b is tapped, a character strengthening screen 165 is displayed on the display 26.

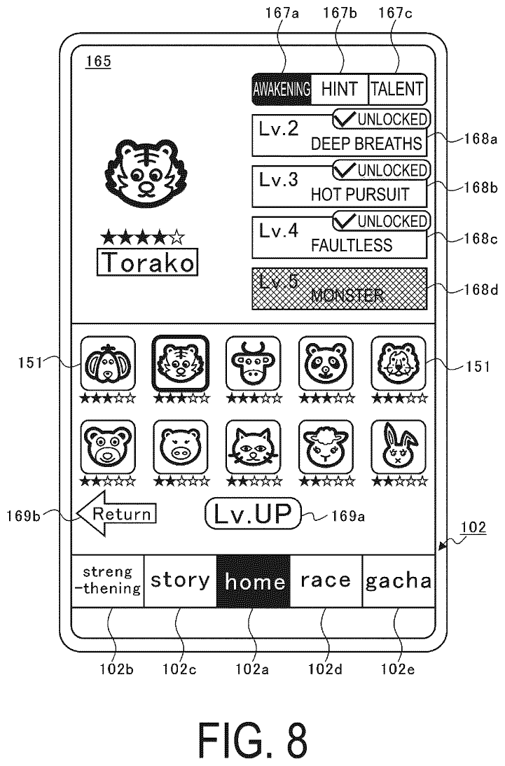

FIG. 8 is a diagram for describing the character strengthening screen 165. The character strengthening screen 165 is displayed when the strengthening operation portion 163b of the character detail screen 160 is tapped and when the strengthening screen selection operation portion 102b is tapped. The character icon 151 corresponding to a possessed character is displayed from the center to the lower side of the character strengthening screen 165. When the character icon 151 is tapped by the player, the character corresponding to the tapped character icon 151 is put in a selected state.

When the strengthening operation portion 163b of the character detail screen 160 is tapped and the character strengthening screen 165 is displayed, the character that is in the selected state on the character detail screen 160 is also put in the selected state when the display of the character strengthening screen 165 is started. In the upper portion of the character strengthening screen 165, information related to the character in the selected state is displayed.

Specifically, the character strengthening screen 165 is provided with an awakened tab 167a, a hint tab 167b, and a stats tab 167c. When the awakened tab 167a is tapped, the awakening skill display fields 168a, 168b, 168c, and 168d are displayed. At the start of display of the character strengthening screen 165, the awakened tab 167a is in a selected state, and the awakening skill display fields 168a, 168b, 168c, and 168d are displayed. The names of the awakening skills corresponding to the awakening levels are listed in the awakening skill display fields 168a, 168b, 168c, and 168d.

Below the character strengthening screen 165, an awakening level up button 169a is provided. When the awakening level up button 169a is tapped, a confirmation screen (not illustrated) is displayed. The confirmation screen displays the item necessary for increasing the awakening level and that the awakening level will increase by consuming the item. Then, when a predetermined operation is input on the confirmation screen, the awakening level of the character in the selected state increases.

In the present embodiment, the awakening level is set to level 1 in the initial state of each character. The player can increase the awakening level of the character up to level 5 by consuming items. One awakening skill is associated with each awakening level. By increasing the awakening level, the awakening skill corresponding to the increased awakening level is unlocked. Specifically, when the awakening level becomes level 2, the awakening skill corresponding to level 2 is unlocked. Similarly, when the awakening level becomes level 5, the awakening skill corresponding to level 5 is unlocked.

As described above, each character is set with four awakening skills. Then, by increasing the awakening level, the player can unlock the same number of awakening skills as the number of increases in the awakening level. The awakening skills function as an obtained base skill when unlocked.

In the awakening skill display fields 168a, 168b, 168c, and 168d, the awakening skills unlocked at awakening levels 2, 3, 4, and 5 are displayed, respectively. At this time, “unlocked” is written in the awakening skill display fields 168a, 168b, 168c, and 168d for the awakening skills that have been unlocked. On the other hand, for the locked awakening skills, the awakening skill display fields 168a, 168b, 168c, and 168d are grayed out. FIG. 8 illustrates a state in which the awakening level is level 4 and three awakening skills are unlocked.

Although detailed description is omitted, when the awakening skill display fields 168a, 168b, 168c, and 168d are long-pressed, detailed information such as the content of each awakening skill is displayed. When the hint tab 167b is tapped, a hint level strengthening screen (not illustrated) is displayed. On the hint level strengthening screen, it is possible to increase the hint level of a base skill, which will be described later, by consuming an item.

Also, when the stats tab 167c is tapped, a stat level strengthening screen (not illustrated) is displayed. On the stat level strengthening screen, it is possible to increase the stat level of the character by consuming an item. The character strengthening screen 165 is provided with a return operation portion 169b. When the return operation portion 169b is tapped, the character strengthening screen 165 is closed and the character detail screen 160 is displayed.

When the player taps the event operation portion 162 of the character detail screen 160, the content of the character detail screen 160 is switched as illustrated in FIG. 6C, and an exclusive event display field 162a indicating an exclusive event provided for each character is displayed. An exclusive event occurs when a predetermined condition is satisfied in the nurture main game. When an exclusive event occurs, a story image relating to the character appearing in the nurture game may be displayed, the values of the ability parameters may change, and the like.

FIG. 7D is a diagram for describing an exclusive event. As illustrated in FIG. 7D, each character is associated with a plurality of exclusive events. As illustrated in FIG. 6C, the exclusive events associated with the characters are displayed on the character detail screen 160. Note that the exclusive event includes a hint event that enables a character to possess or obtain a skill, an ability event that increases or decreases the numerical value of an ability parameter of the character, and the like.

Also, the exclusive event displayed in the character detail screen 160 illustrated in FIG. 6C may be entirely executed during the nurture main game, may be at least partially executed during the nurture main game, or need not be entirely executed during the nurture main game when a predetermined condition is not satisfied. Also, for example, the number of exclusive events provided for each character may increase due to an increase in the level of the character, spending of in-game currency or items, and the like. In addition, when a predetermined condition is satisfied, an exclusive event that is not displayed as an exclusive event may be executed during the nurture main game.

As illustrated in FIGS. 6B and 6C, the close operation portion 163a is displayed at the lower portion of the character detail screen 160. When the close operation portion 163a of the character detail screen 160 is tapped, the display of the character detail screen 160 is terminated, and the nurture target character selection screen 150 is displayed on the display 26.

When the return operation portion 153 is tapped on the nurture target character selection screen 150 illustrated in FIG. 6A, the home screen 100 illustrated in FIG. 3A is displayed on the display 26. The nurture target character selection screen 150 is provided with a nurture information display button 155. When the nurture information display button 155 is tapped, a nurture information display screen (not illustrated) is displayed. The player can confirm the information related to the character selected on the nurture target character selection screen 150 on the nurture information display screen.

The goal of the nurture game is to produce a stronger nurtured character by nurturing a character selected as the nurture target character, which is the nurture target, from among characters possessed by the player. As will be described in detail below, the nurture main game includes a plurality of turns, and the player needs to make the nurture target character train or participate in a race for each turn.

A plurality of clear goals are set for each character. On the nurture information display screen, a clear goal set for the selected character can be checked. A race in which the nurture target character can be entered is predetermined for each turn. The clear goal includes entering the nurture target character in a predetermined race at a predetermined turn and the nurture target character getting a predetermined place.

Further, when the nurture target character, which is the nurture target, is entered in a race, the nurture target character can obtain fans. In each race, the base obtaining number of fans are determined for each placing, and the higher the placing, the larger the number of obtained fans. In addition, a difficulty is set for each race, and in a race with a higher difficulty, more fans can be obtained.

Here, the number of fans that can be obtained by running in the race is calculated by adding a bonus obtaining number to the base obtaining number determined for each placing. Specifically, a correction value is determined based on the race result, and the bonus obtaining number is calculated by multiplying the base obtaining number by the correction value. The total number of the bonus obtaining number and the base obtaining number is the number of fans obtained by the nurture target character. For example, when the race result is first place, the correction value increases as the difference between the nurture target character and the second place character increases. In addition, when the race result is from second to fifth place, the correction value increases as the difference between the nurture target character and the first character decreases.

The nurture target character activates a skill (obtained skill) at a predetermined probability during the race. At this time, as the number of activated skills increases, the correction value increases. As described above, in each race, the condition for adding the number of fans is determined, and the number of fans to be obtained increases depending on various race results other than the placing and the progress of the race. However, the number of fans obtained by the nurture target character is at least equal to or greater than the base obtaining number corresponding to the placing.

In some races, the number of fans is set as a race entry condition. When the number of fans obtained by the nurture target character is less than the number of fans set as the race entry condition, the player cannot enter the nurture target character in the race. The higher the difficulty of a race, the greater the number of fans required to enter in the race. Thus, in a case where a race with the number of fans set as the race entry condition is set as a race that is a target of a clear goal (hereinafter referred to as a target race), the nurture target character needs to obtain the number of fans set for the target race by the turn in which the target race is run.

The clear goal includes obtaining a predetermined number or more of fans by a predetermined turn. In addition, the clear goal includes, for example, placing first in a race of a high difficulty (for example, GI) a predetermined number of times or more within a predetermined turn range. In this way, a plurality of clear goals are set for each character. By achieving a clear goal, the player can continue the nurture main game until the final turn. On the other hand, when the clear goal cannot be achieved, the nurture main game ends in this turn.

Thus, if the number of fans set for the target race is not obtained by the turn in which the target race is run, the nurture target character cannot enter in the target race. In this case, the clear goal is not achieved, and the nurture game ends.

In the nurture main game, since various parameters of the nurture target character increase each turn, a stronger nurtured character can be created as the turn number increases. Thus, in playing the nurture main game, it is necessary to increase the parameters of the nurture target character so that all of the clear goals can be cleared.

Basically, the clear goals set for each character are fixed, and the same clear goals are set as tasks every time the nurture game is played. However, a clear goal that changes according to the progress status of the nurture main game may be set, or a character that allows the player to select a clear goal may be included.

When the nurture game is completed, a nurtured character is created. Evaluation scores are derived for the nurtured character when the nurture game ends, and a nurture rank is derived based on the evaluation scores. The evaluation scores are calculated, based on a preset calculation formula such as a score calculated using various parameters of the nurture target character at the time of nurture completion, a score calculated using the obtained skills, or the like. The nurture information display screen displays information indicating the rank, the evaluation scores, the name, and the registration date of the top three nurtured characters having highest evaluation scores among the nurtured characters nurtured based on the selected character.

Although a detailed description is omitted, a plurality of scenarios are provided in the nurture game. The basic game specifications are common to each scenario, but some functions are different for each scenario. On the nurture information display screen, a scenario selected when each nurtured character is nurtured is displayed.

As described above, the player can select a nurture target character while checking various information on each character on the nurture target character selection screen 150 illustrated in FIG. 6A. When the next operation portion 154 is tapped on the nurture target character selection screen 150, the selected character is set as the nurture target character, and an inheritance character selection screen 170 is displayed on the display 26.

### Registration of Inheritance Character

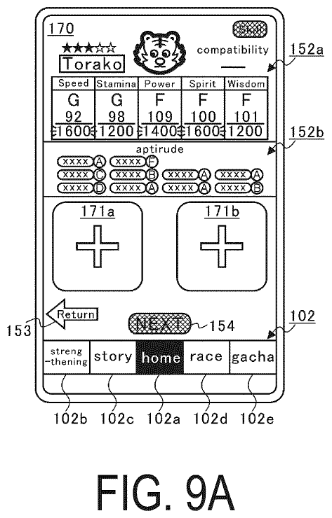

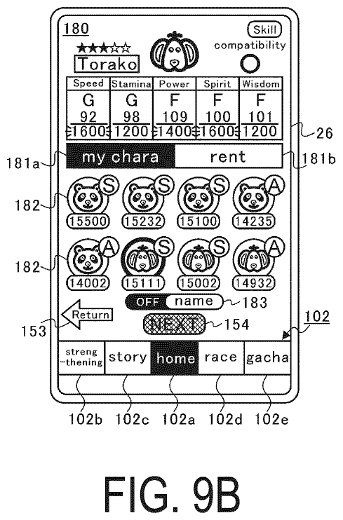

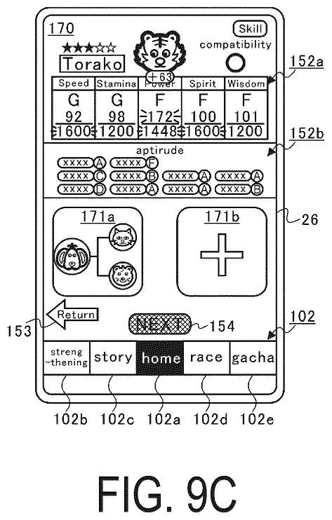

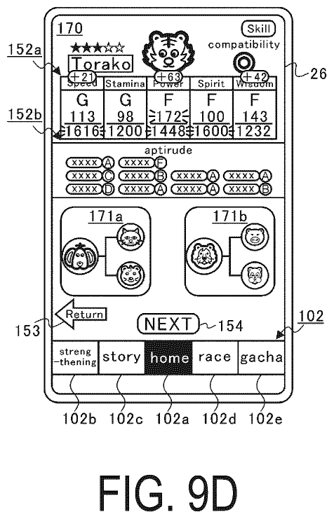

FIG. 9A is a first diagram for describing the inheritance character selection screen 170. FIG. 9B is a first diagram for describing a nurtured character list screen 180. FIG. 9C is a second diagram for describing the inheritance character selection screen 170. FIG. 9D is a third diagram for describing the inheritance character selection screen 170. The inheritance character selection screen 170 is a screen for the player to register an inheritance character.

An inheritance character is a character that causes the nurture target character to inherit an ability value, a skill, or the like. The player can select two inheritance characters from the nurtured characters possessed by the player and representative characters of other players extracted in accordance with a predetermined extraction condition, such as the representative characters of friends such as followers, and use the representative characters to form a deck and register the representative characters. Note that only one representative character of another player can be used as an inheritance character to form a deck in one nurture game.

The inheritance character selection screen 170 is provided with the ability parameter display portion 152a, the aptitude parameter display portion 152b, a first inheritance character selection region 171a, and a second inheritance character selection region 171b. When the screen transitions from the nurture target character selection screen 150 to the inheritance character selection screen 170, the first inheritance character selection region 171a and the second inheritance character selection region 171b are displayed as blank fields as illustrated in FIG. 9A.

When the first inheritance character selection region 171a or the second inheritance character selection region 171b is tapped, the nurtured character list screen 180 illustrated in FIG. 9B is displayed. The nurtured character list screen 180 is provided with a my character tab 181a and a rental tab 181b. Below the my character tab 181a and the rental tab 181b, a nurtured character list display region is provided. A nurtured character icon 182 is displayed in the nurtured character list display region.

In a state where the my character tab 181a is selected, the nurtured character icons 182 corresponding to the nurtured characters possessed by the player are displayed as illustrated in FIG. 9B. Although not illustrated, in a state where the rental tab 181b is selected, the representative character of a friend, that is, the nurtured character icon 182 corresponding to the nurtured character nurtured by a friend is displayed.

Further, when the nurtured character icon 182 is tapped, the nurtured character corresponding to the nurtured character icon 182 is put in a provisionally selected state. When the nurtured character icon 182 is tapped, the inheritance character selection screen 170 is displayed as illustrated in FIG. 9C. At this time, for example, when the first inheritance character selection region 171a is tapped to display the nurtured character list screen 180 and the nurtured character icon 182 is tapped on the nurtured character list screen 180, an image indicating the nurtured character in the provisionally selected state is displayed in the first inheritance character selection region 171a.

In this state, for example, when the second inheritance character selection region 171b is tapped to display the nurtured character list screen 180 and the nurtured character icon 182 is tapped on the nurtured character list screen 180, an image indicating the nurtured character in the provisionally selected state is displayed in the second inheritance character selection region 171b as illustrated in FIG. 9D.

In addition, the nurtured character is stored in association with information related to the inheritance character used in the nurturing. In the first inheritance character selection region 171a, information related to the inheritance character used when nurturing the nurtured character is displayed.

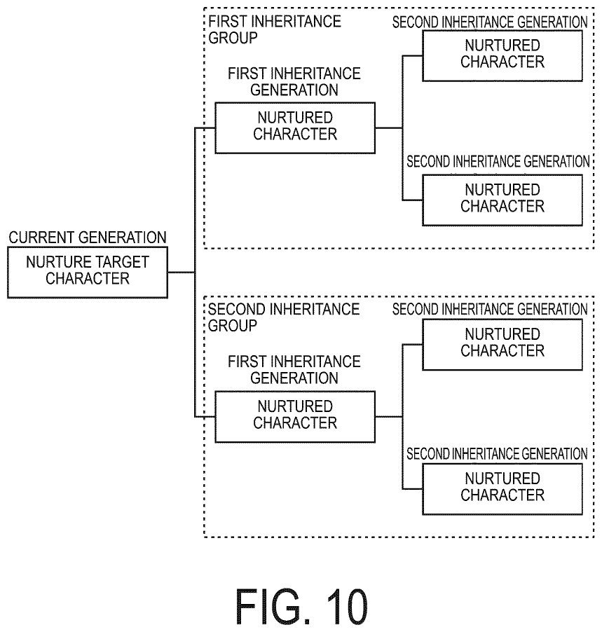

FIG. 10 is a diagram for describing an inheritance system. In the nurture game, various effects such as an increase in the values of an ability parameter and an aptitude parameter of the nurture target character are achieved based on the factor information of the inheritance character. Here, two inheritance characters are set for one nurture target character, and these inheritance characters are the previously produced nurtured characters. Thus, when a nurtured character set as an inheritance character is produced, two inheritance characters are set for the nurtured character.

As illustrated in FIG. 10, the nurture target character, which is the nurture target, of the nurture main game to be started is set to the current generation. Further, two nurtured characters set as inheritance characters for the nurture target character are set as first inheritance generation. Further, two nurtured characters are set as inheritance characters at the start of the nurturing of the first inheritance generation nurtured character. The two nurtured characters set as inheritance characters when the nurtured character of the first inheritance generation is produced are set as second inheritance generation.

In this case, as illustrated in FIG. 10, the nurtured characters of the first inheritance generation and the second inheritance generation have an effect on the nurture target character of the current generation. As described above, since two inheritance characters (first inheritance generation) are set for one nurture target character, a total of six nurtured characters have an effect on one nurture target character.

For example, one of the two first inheritance generation nurtured characters and the two second inheritance generation nurtured characters that are inheritance characters of this nurtured character form a first inheritance group. In a similar manner, the other of the two first inheritance generation nurtured characters and the two second inheritance generation nurtured characters that are inheritance characters of this nurtured character form a second inheritance group.

As illustrated in FIG. 9D, in the first inheritance character selection region 171a, icons corresponding to one first inheritance generation nurtured character and two second inheritance generation nurtured characters forming the first inheritance group are displayed. In a similar manner, in the second inheritance character selection region 171b, icons corresponding to one first inheritance generation nurtured character and two second inheritance generation nurtured characters forming the second inheritance group are displayed.

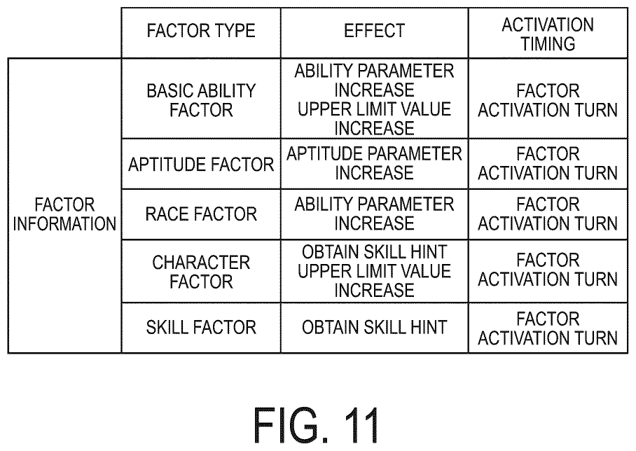

FIG. 11 is a diagram for describing factor information. As will be described in detail below, when the nurture game is completed, the nurture target character is registered as a nurtured character, and at this time, factor information is stored in association with the nurtured character. Specifically, when the nurturing of the nurtured character is completed, a factor to be obtained by the nurtured character is determined through a lottery or the like. Then, factor information indicating the determined factor is associated with the nurtured character. In other words, at the completion of the nurture game, the nurtured character can obtain the factor gained through the lottery.

However, the factor obtained by the nurtured character does not affect the abilities of the nurtured character themselves. For example, the nurtured character can be entered in a racing game such as a team competition game. At this time, in the race, a simulation, that is, computational processing of determining the placing and the race developments is performed based on the ability parameters, the aptitude parameters, the obtained skills, and the like of all the nurtured characters running. Since the factor of the nurtured character is not used in the computational processing, even if the nurtured character has a large number of factors, the nurtured character is not given an advantage in the race.

When the nurtured character is set as the inheritance character, the factor of the nurtured character affects only the nurture target character. Factors that can be obtained by the nurtured character are classified into a plurality of types. FIG. 11 illustrates a basic ability factor, an aptitude factor, a race factor, a character factor, and a skill factor as factor types. Each factor is set to any of a plurality of levels. Here, three factor levels, level 1, level 2, and level 3, are provided as factor levels.

The factor level is determined through a lottery. At this time, after the factors to be obtained by the nurtured character are determined, the factor level may be determined through the lottery for each of the obtained factors. Alternatively, a success ratio may be set for each combination pattern of a factor and a factor level, and any combination pattern may be determined based on the set success ratio. In this case, the factor to be obtained and the factor level are determined at the same time.

For factor levels, level 3 has the largest effect and level 1 has the least effect. In the lottery for determining the factor level, the success probability of level 3 is set to be the lowest and the success probability of level 1 is set to be the highest. However, the success probability of the factor to be obtained or the success probability of the factor level may be changed depending on the result of the nurture game. In this case, for example, a higher factor level may be determined for a nurtured character that has a higher ability parameter or evaluation score.

The basic ability factor increases the values for the ability parameters of the nurture target character and the upper limit values of the ability parameters. Five basic ability factors are provided including a speed factor, a stamina factor, a power factor, a spirit factor, and a wisdom factor. The nurtured character always obtains one basic ability factor from among the five basic ability factors. The five basic ability factors correspond to the five ability parameters for speed, stamina, power, spirit, and wisdom. For example, when the nurtured character of the first inheritance generation or the second inheritance generation has a speed factor, the value of the ability parameter and the upper limit value for speed of the nurture target character increases.

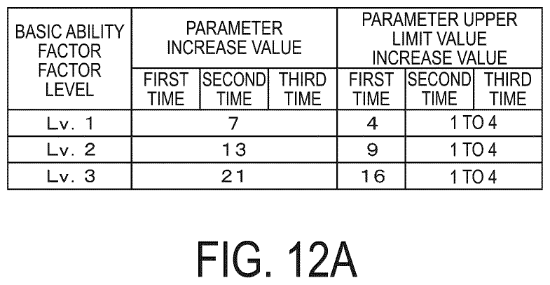

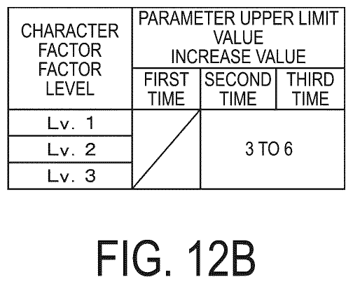

FIG. 12A is a diagram for describing the effects of basic ability factors. The increase value for each ability parameter and the increase value of the upper limit value vary depending on the factor level of the basic ability factor. For example, when the factor level of the speed factor is level 1, the ability parameter for speed for the nurture target character increases by “7”; when the factor level is level 2, the ability parameter increases by “13”; and when the factor level is level 3, the ability parameter increases by “21”.

Thus, if a total of six nurtured characters including two first inheritance generation characters and four second inheritance generation characters all have a speed factor of level 3, the ability parameter for speed for the nurture target character increases by a maximum of 126 (increase value 21×6).

However, an activation timing and an activation condition are set for each factor. Thus, even if the inheritance character has a factor, if the activation condition is not satisfied at the activation timing, there is no effect on the nurture target character.

As described above, the nurture main game is composed of a plurality of turns, and of these, a predetermined turn is set as a factor activation turn. For example, three turns, namely the first turn, the 31st turn, and the 55th turn of the nurture main game are set as factor activation turns. In this case, the first turn is the first activation timing, the 31st turn is the second activation timing, and the 55th turn is the third activation timing. In each factor activation turn, whether to activate is determined for each factor (inheritance character), and in a case where it is determined to activate the factor, the activation condition of the factor is satisfied, and the effect corresponding to the factor is achieved.

Whether to activate the basic ability factor is determined through a lottery. At this time, the probability of success in the lottery as to whether to activate the basic ability factor, that is, the probability of activating the basic ability factor (hereinafter referred to as the activation probability) may be different in the three factor activation turns. Here, in the first turn, the activation probability of the basic ability factor is set to 100% regardless of the factor level. Also, in the 31st turn and the 55th turn, the activation probability of the basic ability factor varies depending on the factor level. For example, in the 31st turn and the 55th turn, the activation probability of a level 3 basic ability factor is set to 100%, the activation probability of a level 2 basic ability factor is set to 90%, and the activation probability of level 1 basic ability factor is set to 80%.

On the inheritance character selection screen 170, an increase value that increases the ability parameter in the first turn is displayed. For example, in FIG. 9C, one inheritance character in the first inheritance group is provisionally selected. In this case, the type of the ability parameter to be increased in the first turn and the increase value thereof are displayed for the one inheritance character being provisionally selected. Here, “+63” is displayed above the power ability parameter, which indicates that the power ability parameter increases by 63 points in the first turn. Further, in the ability parameter display portion 152a, the value to which the increase value increased in the first turn is added is displayed.

Further, in FIG. 9D, two inheritance characters in the first inheritance group and the second inheritance group are provisionally selected. In this case, the type of the ability parameter to be increased in the first turn and the increase value thereof are displayed for the two inheritance characters being provisionally selected. Here, “+21”, “+63”, and “+42” are displayed above the ability parameters for speed, power, and wisdom, respectively, which indicate that the ability parameters for speed, power, and wisdom increase by 21 points, 63 points, and 42 points, respectively, in the first turn.

In the inheritance character selection screen 170, the increase value of the ability parameter to be increased by the inheritance character in the first inheritance group and the increase value of the ability parameter to be increased by the inheritance character in the second inheritance group are displayed in a distinguishable manner. For example, in FIG. 9D, the “+63” displayed above the power ability parameter and the “+21” and “+42” displayed above the speed and wisdom ability parameters are displayed in different colors.

When the basic ability factor is activated, the upper limit value of the corresponding ability parameter increases. At this time, the increase value of the upper limit value of the ability parameter varies depending on the factor level of the basic ability factor. In addition, the increase value of the upper limit value of the ability parameter varies depending on the activation timing. For example, when the factor level of the speed factor is level 1, the upper limit value of the ability parameter of speed for the nurture target character increases by “4” at the first activation timing, and the upper limit value of the ability parameter of speed increases by a number in the range of “1” to “4” at the second and third activation timings.

Also, when the factor level of the speed factor is level 2, the upper limit value of the ability parameter of speed for the nurture target character increases by “9” at the first activation timing, and the upper limit value of the ability parameter of speed increases by a number in the range of “1” to “4” at the second and third activation timings. Also, when the factor level of the speed factor is level 3, the upper limit value of the ability parameter of speed for the nurture target character increases by “16” at the first activation timing, and the upper limit value of the ability parameter of speed increases by a number in the range of “1” to “4” at the second and third activation timings.

Here, at the first activation timing, the upper limit value of the ability parameter is always increased by the increase value corresponding to the factor level. On the other hand, at the second and third activation timings, a lottery for determining whether to activate is performed. When it is determined to activate, a lottery for determining the increase value of the upper limit value is performed. In this case, the higher the factor level is, the higher the probability may be set for determining activation. Further, the increase value of the upper limit value may be set to increase as the factor level increases.

In addition, whether to activate the basic ability factor may be determined on a factor basis or may be separately determined for each effect. For example, in a case where whether to activate one basic ability factor is determined on a factor basis, it is assumed that activating the basic ability factor has been determined. In this case, according to the factor level, the value of the corresponding ability parameter increases and the upper limit value of the same ability parameter increases.

On the other hand, in a case where whether to activate one basic ability factor is determined for each effect, the determination of whether to increase the value of the ability parameter and the determination of whether to increase the upper limit value are made through separate lotteries. Thus, in this case, for example, only any one of the value of the ability parameter and the upper limit value of the ability parameter may be increased. In any case, in the present embodiment, the basic ability factor is always activated at the first activation timing. Thus, with the start of the nurture main game, the value of the ability parameter and the upper limit value increase in accordance with the factor level.

As illustrated in FIGS. 9C and 9D, the initial upper limit value of the ability parameter displayed in the ability parameter display portion 152a of the inheritance character selection screen 170 is updated to a value obtained by adding the additional value of the upper limit value increased by the basic ability factor. In this manner, by displaying the initial upper limit value in which the scenario initial additional value and the additional value from the basic ability factor are taken into account, the user-friendliness in selecting the inheritance character is improved.

The aptitude factor illustrated in FIG. 11 increases the aptitude parameter of the nurture target character. The aptitude factors include six factors: a turf factor, a dirt factor, a short distance factor, a mile factor, a medium distance factor, and a long distance factor. The nurtured character always obtains one aptitude factor from among the six aptitude factors. The six aptitude factors correspond to turf aptitude, dirt aptitude, short distance aptitude, mile aptitude, medium distance aptitude, and long distance aptitude. For example, when the nurtured character of the first inheritance generation or the second inheritance generation includes a nurtured character having a turf factor, the aptitude parameter for the turf aptitude of the nurture target character increases.

The activation timing and the activation condition are also set for the aptitude factor, and whether to activate is determined for each aptitude factor in the same factor activation turn as that of the basic ability factor. If activation of the aptitude factor is determined, the corresponding aptitude parameter is increased by one level. In this example, in the first turn, the activation probability of the aptitude factor is set to 100% regardless of the factor level.

For example, the aptitude factors of three nurtured characters belonging to the first inheritance group are the turf factor, the short distance factor, and the mile factor; and the aptitude factors of three nurtured characters belonging to the second inheritance group are the turf factor, the short distance factor, and the medium distance factor. In this case, the turf aptitude and the short distance aptitude of the nurture target character are each increased by two levels, and the mile aptitude and the medium distance aptitude are each increased by one level.

Further, for example, the aptitude factors of the three nurtured characters belonging to the first inheritance group are all the turf factor, and the aptitude factors of the three nurtured characters belonging to the second inheritance group are all the short distance factors. In this case, the turf aptitude and the short distance aptitude of the nurture target character each increase by three levels. In another example, the aptitude factors of the three nurtured characters belonging to the first inheritance group are all the turf factor, and the aptitude factors of the three nurtured characters belonging to the second inheritance group are the turf factor, the short distance factor, and the mile factor. In this case, the turf aptitude of the nurture target character increases by four levels, and the short distance aptitude and the mile aptitude each increase by one level.

However, for the first turn, a limit is placed on the increase value of the aptitude parameter. Specifically, in the first turn, the upper limits of all the aptitude parameters are set to A. Thus, if the initial value of the turf aptitude of the nurture target character is A, the turf aptitude does not increase in the first turn even if the inheritance character has the turf factor.

On the other hand, in the 31st turn and the 55th turn, a lottery is used to determine whether to activate based on the factor level for each aptitude factor. As an example, in the 31st turn and the 55th turn, the activation probability of a level 3 aptitude factor is set to 5%, the activation probability of a level 2 aptitude factor is set to 3%, and the activation probability of a level 1 aptitude factor is set to 1%. In the 31st turn or the 55th turn, when the activation of the aptitude factor is determined through a lottery, the aptitude parameter corresponding to the aptitude factor increases. In the 31st turn and the 55th turn, the upper limit of each aptitude is raised from A to S. Thus, in the 31st turn and the 55th turn, the value of the aptitude parameter can be increased to S by activation of the aptitude factor.

The value of the aptitude parameter increased in the first turn is displayed in the aptitude parameter display portion 152b of the inheritance character selection screen 170.

The race factor increases the ability parameter of the nurture target character. The race factor is provided for each race with a high difficulty (hereinafter referred to as a factor target race), such as GI races, from among the races that can be entered in the nurture main game. When the nurture game is completed, a lottery to determine whether a race factor is obtained is performed for each factor target race in which the nurture target character comes in first place. The nurtured character can obtain a race factor via a successful lottery.

Note that the race factor is provided with factor levels, and the factor level is determined through a lottery for each race factor determined to be obtained. Here, there is no upper limit to the number of race factors that can be obtained by one nurtured character, and the nurtured character can obtain a plurality of race factors.

For each race factor, an ability parameter to be increased by activation and an increase value thereof are set in advance. For example, race factors may include a factor to increase the speed ability parameter and a factor to increase the power ability parameter. At this time, the higher the factor level, the greater the increase value of the ability parameter.

In addition, the activation timing and the activation condition are also set for the race factor, and whether to activate is determined for each race factor in the factor activation turn. If activation of a race factor is determined, the ability parameter corresponding to the race factor is increased. The factor activation turns of the race factor are limited to the 31st turn and the 55th turn. In addition, the activation probability of the race factor in the factor activation turn varies depending on the factor level, and the higher the factor level, the higher the activation probability.

The character factor is a factor specific to the character, and for example, only when a character strengthened to a predetermined level is nurtured as a nurture target character, the character factor set for the character is always given to the nurtured character at the completion of the nurture game. Since only one character factor is set for one character, the maximum number of character factors that one nurtured character can obtain is one. When a nurtured character is produced based on a character that is not strengthened to a predetermined level, a character factor cannot be obtained.

The character factor can be activated in a factor activation turn set in advance and is activated by a successful lottery executed in the factor activation turn. When a character factor is activated, a hint event set for each character factor occurs, and a skill hint can be obtained as described above. When a character factor is activated, the upper limit value of a predetermined ability parameter increases.

FIG. 12B is a diagram for describing the effects of character factors. The increase in the upper limit value of the ability parameter by the character factor is restricted to the second and third activation timings. However, the character factor may be activated at the first activation timing. When the character factor is activated at the first activation timing, as described above, the nurture target character obtains a hint for the skill, but the upper limit value of the ability parameter does not increase.

When the character factor is activated at the second or third activation timing, the upper limit value of the ability parameter increases in addition to obtaining a hint for the skill. Here, regardless of the factor level, the upper limit value of the ability parameter increases by a value within the range of “3” to “6”. The increase value of the upper limit value is determined through a lottery, for example. At this time, the increase value may be set to increase as the factor level increases.

In the present embodiment, the ability parameter with an upper limit value that is increased by the activation of the character factor is set in advance for each character factor. For example, according to character factor A, the upper limit value of stamina is increased by a value in the range of “3” to “6”; and according to character factor B, the upper limit value of speed is increased by “1” and the upper limit value of spirit is increased by “2”, the upper limit value of speed is increased by “2” and the upper limit value of spirit is increased by “2”, or the like. As with the basic ability factor, whether to activate the character factor may be determined on a factor basis or may be determined separately for each effect.

The skill factor illustrated in FIG. 11 is given based on the obtained skill obtained by the nurtured character. Specifically, at the completion of the nurture game, for each obtained skill obtained by the nurtured character, whether a skill factor is obtained is determined through a lottery. By being successful in the lottery, a skill factor is given to the nurtured character. In other words, the nurtured character can obtain some or all of the skill factors corresponding to the obtained skills. When it is determined to obtain a skill factor, the factor level of the skill factor is determined through a lottery.

The skill factor can be activated in a factor activation turn set in advance and is activated by a successful lottery executed in the factor activation turn. At this time, the higher the factor level, the higher the success probability. When a skill factor is activated, a hint event set for each skill factor occurs, and a skill hint can be obtained. Thus, the nurture target character can obtain the same skill as the obtained skill obtained by the inheritance character or the like.

As described above, whether the skill factor is obtained is determined from within a range of the obtained skill obtained by the nurtured character. Thus, the more obtained skills the nurtured character has, the higher the possibility of obtaining the skill factor. However, since whether a skill factor is obtained is determined through a lottery, even if the nurtured character has many obtained skills, a skill factor may not be obtained.

Although the nurtured character obtains the skill factor separately from the obtained skill, the skill that can be obtained by the nurture target character may be determined based on the obtained skill of the nurtured character as the inheritance character without providing the skill factor.

As described above, the ability parameter of the nurture target character greatly changes depending on the inheritance character used to form the deck. In addition, even if the ability of the nurtured character itself is high, since whether a factor is obtained is determined through a lottery, the nurtured character with higher ability does not necessarily correspond to the inheritance character. On the other hand, even when the ability of the nurtured character itself is not high, the nurtured character may effectively function as an inheritance character by obtaining a large number of factors having a high factor level. In this manner, by making it possible to form a deck using the inheritance characters, not only simply nurturing a strong nurtured character, but also nurturing a nurtured character that is effective as an inheritance character is made enjoyable.

Furthermore, in the present embodiment, the compatibility between the nurture target character, the nurtured character of the first inheritance generation, and the nurtured character of the second inheritance generation is determined. Then, in the case of a combination of characters having good compatibility, an advantageous factor activation condition is achieved.

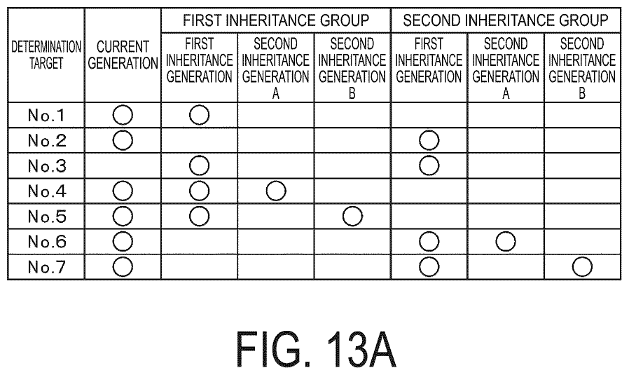

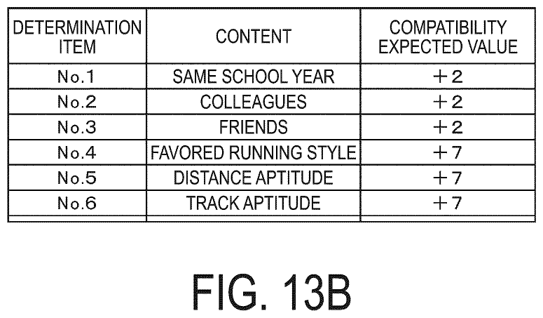

FIG. 13A is a diagram for describing a compatibility determination target, and FIG. 13B is a diagram for describing compatibility determination items. As illustrated in FIG. 13A, in the present embodiment, seven determination targets from No. 1 to No. 7 are provided. The first determination target (No. 1) is the nurture target character of the current generation and the nurtured character of the first inheritance generation in the first inheritance group. The second determination target (No. 2) is the nurture target character of the current generation and the nurtured character of the first inheritance generation in the second inheritance group.

The third determination target (No. 3) is the nurtured character of the first inheritance generation in the first inheritance group and the nurtured character of the first inheritance generation in the second inheritance group. The fourth determination target (No. 4) is the nurture target character of the current generation, the nurtured character of the first inheritance generation in the first inheritance group, and one of the nurtured characters (nurtured character A) of the second inheritance generation in the first inheritance group. The fifth determination target (No. 5) is the nurture target character of the current generation, the nurtured character of the first inheritance generation in the first inheritance group, and the other nurtured character (nurtured character B) of the second inheritance generation in the first inheritance group.

The sixth determination target (No. 6) is the nurture target character of the current generation, the nurtured character of the first inheritance generation in the second inheritance group, and one of the nurtured characters (nurtured character A) of the second inheritance generation in the second inheritance group. The seventh determination target (No. 7) is the nurture target character of the current generation, the nurtured character of the first inheritance generation in the second inheritance group, and the other nurtured character (nurtured character B) of the second inheritance generation in the second inheritance group.

For each determination target, it is determined whether the condition is satisfied for each one of the plurality of determination items. Example of the determination items are illustrated in FIG. 13B. In the present embodiment, the world view of the game is set such that characters that can be selected as nurture target characters are students and each character performs training in a school.

As illustrated in FIG. 13B, settings including same school year, colleagues, and friends are set in advance for each character. The determination items include, for example, whether the two or three determination target characters are in the same school year, are colleagues, or are friends. In addition, the determination items include whether the running style, the distance aptitude, and the track aptitude that the determination target character is good at match.

Each determination item is associated with a compatibility expected value, and the compatibility expected values of the determination items established between the determination target characters are accumulated. Here, the compatibility expected value differs depending on the determination item, but the compatibility expected value may be common to all the determination items.

For example, in the case of determining the compatibility, first, it is determined whether all determination items are established between the nurture target character of the current generation which is a first determination target and the nurtured character of the first inheritance generation of the first inheritance group. At this time, the compatibility expected values associated with the established determination items are accumulated and counted. As described above, the calculation of the compatibility expected value is sequentially performed from the first determination target to the seventh determination target, and the activation probability of the factor is corrected based on the finally calculated compatibility expected value. That is, the higher the compatibility expected value, the higher the activation probability of all the factors, and the lower the compatibility expected value, the lower the activation probability of all the factors.

The activation probability may be calculated by using the calculated compatibility expected value as a correction value. For example, a correction value for correcting the activation probability of a factor may be set for each compatibility level, and the compatibility level may be determined based on the calculated compatibility expected value.

As described above, since the activation probability of the factor varies depending on the compatibility between the nurture target character and the inheritance character or the compatibility between the inheritance characters, the combination of the two inheritance characters greatly affects the nurturing of the nurture target character. In other words, the compatibility between characters is an important criterion for selecting an inheritance character.

As illustrated in FIGS. 9B, 9C, and 9D, in a state in which the inheritance character is selected, a compatibility mark indicating compatibility is displayed on an upper right of the inheritance character selection screen 170 and the nurtured character list screen 180. Here, the compatibility level of the selected characters is indicated by three compatibility marks: ⊚, ◯, and Δ. As illustrated in FIG. 9A, the compatibility mark is not displayed in a state in which an inheritance character is not selected.

As illustrated in FIG. 9B, a switch display button 183 is provided on the nurtured character list screen 180. When the switch display button 183 is operated, a display condition setting screen (not illustrated) is displayed. On the display condition setting screen, the player can rearrange or filter the nurtured character icons 182 displayed on the nurtured character list screen 180, that is, the nurtured characters selectable as inheritance characters.

### Registration of Support Card

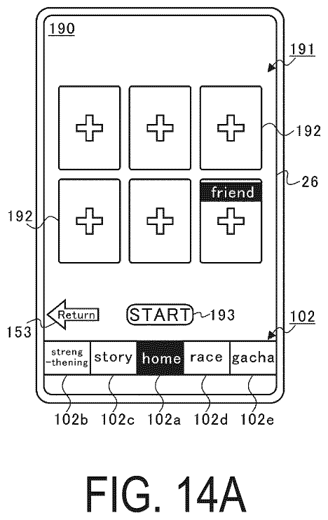

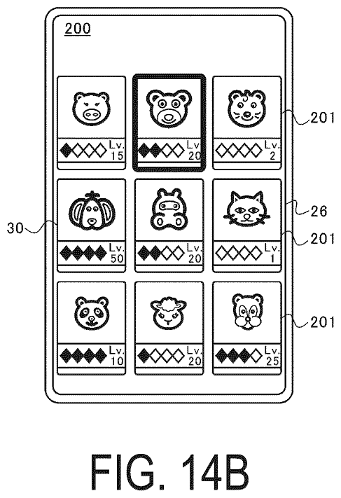

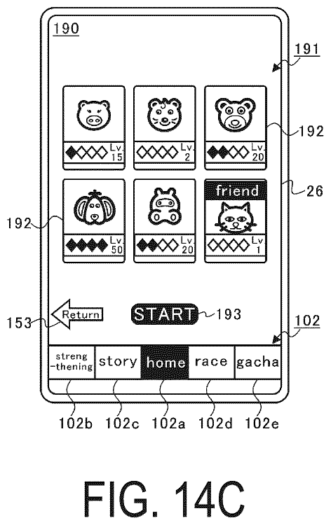

FIG. 14A is a first diagram for describing the support card organization screen 190. When two inheritance characters are registered on the inheritance character selection screen 170, the support card organization screen 190 illustrated in FIG. 14A is displayed. A support card display region 191 is provided at a central portion of the support card organization screen 190. The support card display region 191 includes a plurality of support card display frames 192. In addition, the return operation portion 153 and a start operation portion 193 are displayed at a lower portion of the support card organization screen 190.

In the support card display region 191, a plurality of (here, six) support card display frames 192 are displayed. The number of support card display frames 192 displayed is the same as the number of support cards that can be set by the player. When the support card organization screen 190 is first displayed, the support card display frames 192 are blank.

In the present embodiment, the player can set six types of support cards in the deck. One or more (for example, five types) of the six types that can be set by the player can be selected from among the support cards possessed by the player. In addition, the remaining (for example, one type) of the six types that can be set by the player can be selected from support cards set as rental cards by other players such as friends.

FIG. 14B is a diagram for describing a support card selection screen 200. When the support card display frame 192 (excluding the support card display frame 192 displayed at a lower right) is tapped on the support card organization screen 190 of FIG. 14A, the support card selection screen 200 illustrated in FIG. 14B is displayed on the display 26. The support card selection screen 200 displays a list of card icons 201 corresponding to the support cards owned by the player. By tapping the card icon 201 displayed on the support card selection screen 200, the player can select a support card.

Although not illustrated, when the support card display frame 192 displayed at the lower right of the support card organization screen 190 is tapped, a support card set as a rental card by a friend or a player extracted based on a predetermined condition such as a lottery is displayed on the support card selection screen 200. At this time, the player can select one friend support card by tapping a support card displayed on the support card selection screen 200. In this manner, the player can use a support card possessed by another player in the nurture game.

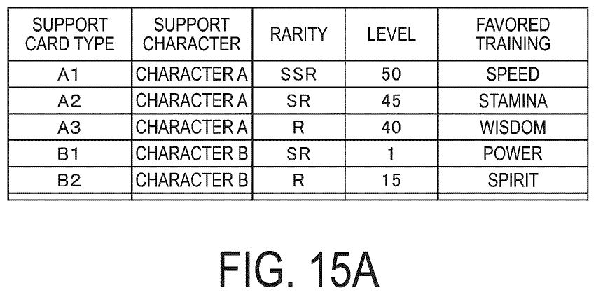

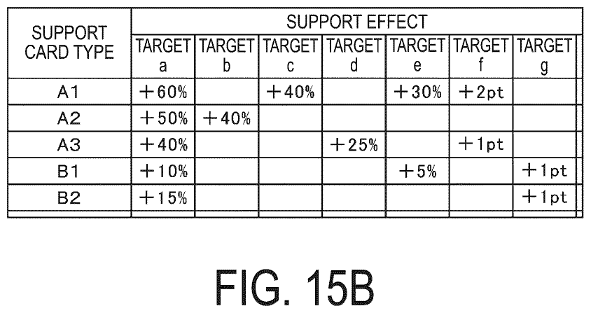

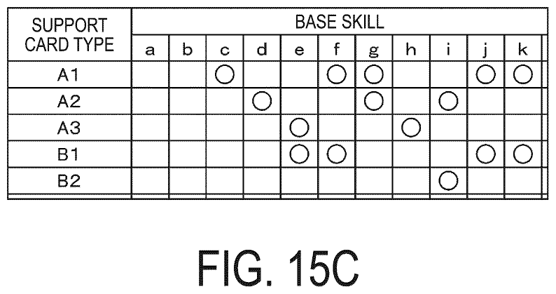

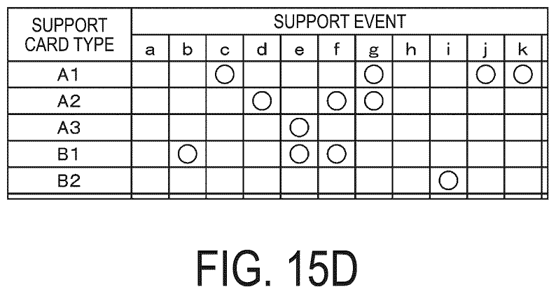

FIG. 15A is a diagram for describing a support card table. As illustrated in FIG. 15A, the support card table stores the type of support character (that is, a character ID), rarity, level, and favored training for each type of support card possessed by the player (that is, support card ID). The support characters are in one-to-one correspondence with the types of support cards. That is, one character ID is always associated with a support card ID. In other words, one support card is always associated with one support character.

In the present embodiment, a rarity is set for each support card. The rarity has three levels: R (rare), SR (super rare), and SSR (super special rare). R is set to the lowest rarity and SSR is set to the highest rarity. In the present embodiment, a support card having a higher rarity tends to have a higher support effect to be described below. In the present embodiment, the number of base skills and the number of support events to be described below tend to increase as the rarity of a support card increases.

For the levels of the support card, 50 levels from level 1 to level 50 are provided. The level of the support card can be increased by the player, and the level increased by the player is stored for each support card. The level of the support card can be raised by using in-game currency, an item, or the like. The level of the support card has an upper limit depending on rarity.

For example, level 20 is set as the upper limit for a support card with a rarity of R, level 25 is set as the upper limit for a support card with a rarity of SR, and level 30 is set as the upper limit for a support card with a rarity of SSR.

The upper limit of the level can be raised incrementally when a predetermined condition is satisfied. For example, a support card with a rarity of R may have its upper limit raised to level 40, a support card with a rarity of SR may have its upper limit raised to level 45, and a support card with a rarity of SSR may have its upper limit raised to level 50.

FIG. 15B is a diagram for describing support effects. As illustrated in FIG. 15B, each support card stores a plurality of support effects. The support effects increase various stats in the nurture main game. A support card has support effects for a plurality of targets. Examples of the support effect targets include energy, speed, stamina, power, spirit, and wisdom.

FIG. 15C is a diagram for describing base skills. As illustrated in FIG. 15C, each support card is set with a plurality of base skills. In the present embodiment, base skills are also associated with support cards so that each character possesses a base skill. The base skill set for each support card can be obtained by the nurture target character selected by the player when a hint event occurs during the nurture main game.

FIG. 15D is a diagram for describing support events. As illustrated in FIG. 15D, each support card is associated with a plurality of support events. A support event is an event that may occur during the nurture main game. When a support event occurs, the values of various stats in the nurture main game may increase or decrease.

For example, a support event that occurs according to the turn number, or a support event that occurs according to a predetermined lottery may be determined. A plurality of support events to occur may be selected in one turn. In any case, the support event to occur may be determined according to a predetermined determination method set in advance.

Note that the support events may include a hint event and an ability event. Also, hint events may include a first hint event that may occur at the start of a turn in the nurture game and a second hint event that may occur after training is performed in the nurture game which will be described below. Also, ability events may include a first ability event that may occur at the start of a turn in the nurture game and a second ability event that may occur after training is performed in the nurture game.

The first hint event and the second hint event are events that make it possible to possess or obtain a skill. Further, the first ability event and the second ability event are events for increasing or decreasing the numerical value of an ability parameter of the character. Hereinafter, the first hint event and the first ability event are collectively referred to as a first event, and the second hint event and the second ability event are collectively referred to as a second event.

FIG. 14C is a second diagram for describing the support card organization screen 190. In the present embodiment, when all six support cards are selected, the start operation portion 193 becomes operable as illustrated in FIG. 14C. On the other hand, when all the six support cards are not selected, the start operation portion 193 cannot be operated as illustrated in FIG. 14A.

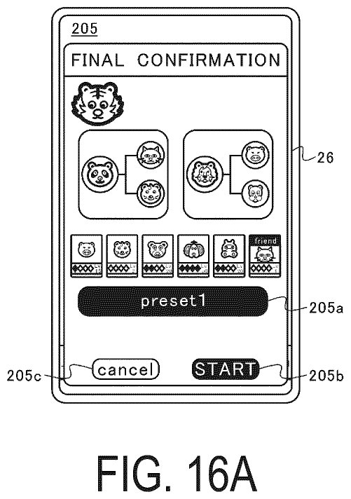

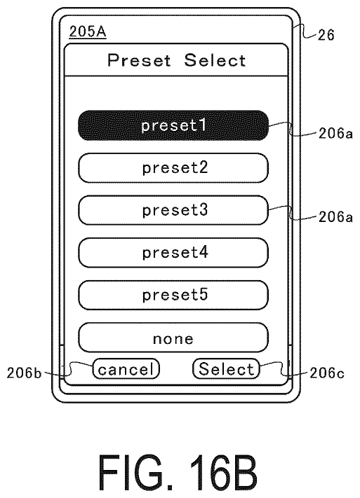

When the return operation portion 153 is operated on the support card organization screen 190, the inheritance character selection screen 170 illustrated in FIG. 9D is displayed on the display 26. Further, as illustrated in FIG. 14C, when the start operation portion 193 is tapped on the support card organization screen 190, the selected support card is temporarily registered, and a final confirmation screen 205 is displayed as illustrated in FIG. 16A.

FIG. 16A is a diagram for describing the final confirmation screen 205. FIG. 16B is a diagram for describing a preset selection screen 205A. On the final confirmation screen 205, the nurture target character selected by the player, the nurtured character in the first inheritance group, the nurtured character in the second inheritance group, and the support cards are displayed. Further, a preset display portion 205a is displayed on the final confirmation screen 205. In the preset display portion 205a, the number of the preset currently selected is indicated.

Here, the preset is reservation information on a race in which the nurture target character is entered in the nurture main game. The player can select any race from all the races to create a preset. A plurality of presets can be stored, and one preset can be selected from the stored presets on the final confirmation screen 205. To be more specific, when the preset display portion 205a is tapped, the preset selection screen 205A illustrated in FIG. 16B is displayed.

On the preset selection screen 205A, preset read buttons 206a corresponding to stored presets are displayed. The player can set a preset by tapping any of the preset read buttons 206a and then tapping a select operation portion 206c. When the select operation portion 206c is tapped, the preset selection screen 205A is closed, and the final confirmation screen 205 is displayed. When a cancel operation portion 206b of the preset selection screen 205A is tapped, the preset selection screen 205A is displayed without changing the preset.

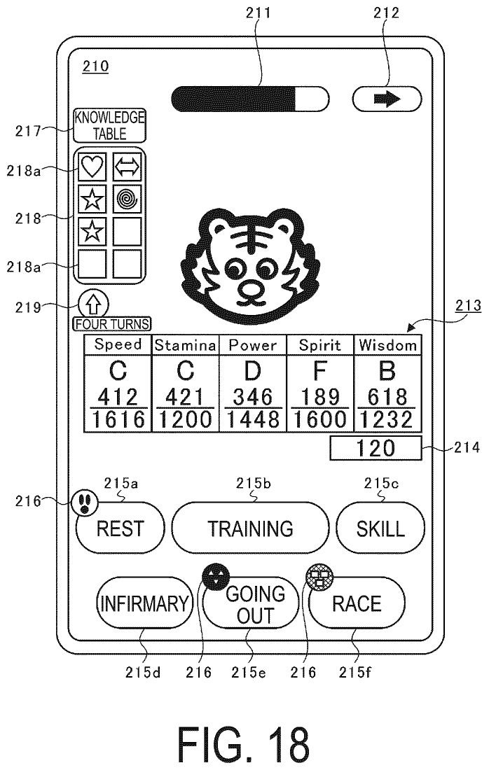

When a cancel operation portion 205c is tapped on the final confirmation screen 205, the support card organization screen 190 is displayed. On the other hand, when a start operation portion 205b is tapped, a top screen 210 (FIG. 18A) is displayed on the display 26.

### Registration of Specific Character

As illustrated in FIG. 4, after a scenario, a nurture target character, an inheritance character, and a support card are registered, next, a specific character is registered. The specific character is predetermined for each scenario, and a character corresponding to the scenario selected by the player is set as the specific character.

As described above, when the nurture target character, the inheritance character, the support character (support card), and the specific character are registered, the preparation stage processing ends.

### Nurture Stage Processing

When the preparation stage processing ends, the nurture stage processing is started. Via the nurture stage processing, the nurture main game in which the nurture target character can be nurtured progresses. Hereinafter, in order to facilitate understanding, first, a basic flow of the nurture main game will be described.

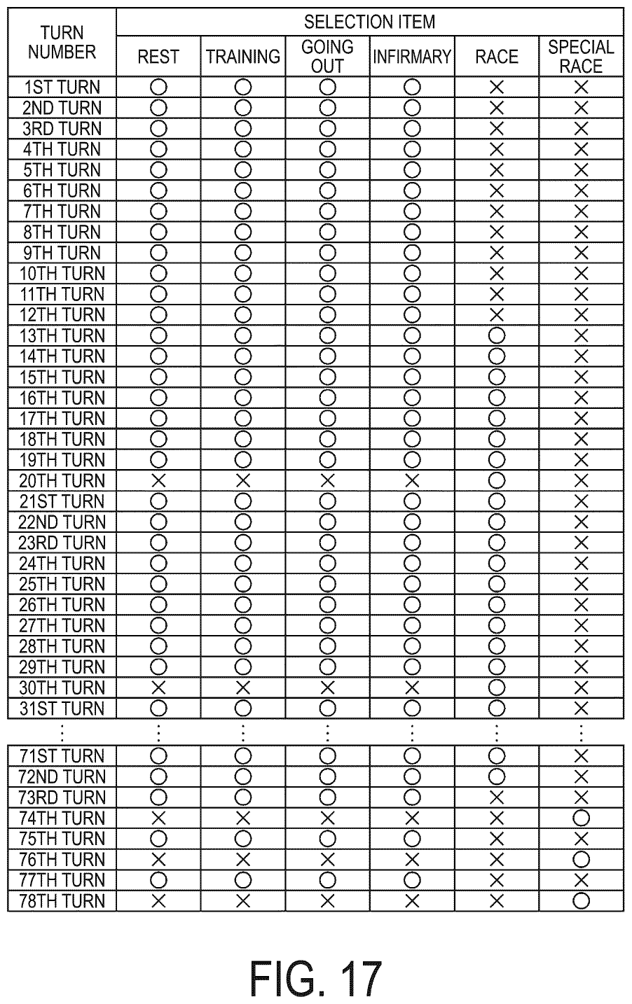

FIG. 17 is a diagram for describing selection items in each turn. Here, the selection items that can be selected are different for each turn depending on the type of the nurture target character. However, the selection items that can be selected may be the same in each turn regardless of the type of the nurture target character. As illustrated in FIG. 17, the nurture main game includes a first turn to a 78th turn. Various parameters are updated in accordance with the selection item selected by the player in each turn.

FIG. 18 is a diagram for describing the top screen 210. In the nurture stage processing, the top screen 210 illustrated in FIG. 18 is displayed on the display 26. In an upper portion of the top screen 210, an energy display portion 211 and a mood display portion 212 are displayed. The nurture target character is provided with an “energy” parameter. The “energy” parameter is mainly used for calculation of a failure rate which is a probability of failure in training which will be described below. The energy display portion 211 is displayed so that the current remaining amount of the “energy” of the nurture target character can be visually recognized with respect to the upper limit value of the “energy”.

The nurture target character is provided with a “mood” parameter. The mood display portion 212 displays the current “mood” of the nurture target character using a plurality of levels (five levels including very bad, bad, normal, good, and very good) so that the user can visually recognize the mood. With better “mood” parameter, race developments become more advantageous for the nurture target character and the increase value of ability parameters in training are increased.

As illustrated in FIG. 18, an image of the nurture target character, a stats display portion 213, and a skill point display portion 214 are displayed at a central portion of the top screen 210. In the stats display portion 213, the current stats of the nurture target character are indicated by a numerical value and an alphabetical letter indicating rank for each numerical value. Specifically, in the present embodiment, the numerical values and ranks of the ability parameters for speed, stamina, power, spirit, and wisdom are displayed. In the skill point display portion 214, the skill points possessed by the nurture target character is indicated by a numerical value.

As illustrated in FIG. 18, a rest operation portion 215a, a training operation portion 215b, a skill operation portion 215c, an infirmary operation portion 215d, a going out operation portion 215e, and a race operation portion 215f are displayed at a lower portion of the top screen 210. In addition, in each turn, the player can select any one of the items of the rest operation portion 215a, the training operation portion 215b, the infirmary operation portion 215d, the going out operation portion 215e, and the race operation portion 215f. However, a race-limited turn is set in advance for the nurture target character. In the race-limited turn, the rest operation portion 215a, the training operation portion 215b, the infirmary operation portion 215d, and the going out operation portion 215e are not selectable.

The player can select “Rest” as the selection item by operating the rest operation portion 215a. When “Rest” is selected, the energy of the nurture target character is recovered. In addition, the player can select training to be executed by the nurture target character by operating the training operation portion 215b.

The player can select “Infirmary” as the selection item by operating the infirmary operation portion 215d. When “Infirmary” is selected, the minus parameters of the nurture target character are cancelled. Although a detailed description is omitted, a minus parameter that is a disadvantage to progressing through the game may be set for the nurture target character.

In the nurture main game, an event of obtaining a minus parameter is provided. The nurture target character obtains a minus parameter by the occurrence of the event. In addition, even when the training fails, the nurture target character may obtain a minus parameter. When “Infirmary” is selected in a state where the nurture target character has obtained a minus parameter, the minus parameter can be canceled. However, even if “Infirmary” is selected, the minus parameter may not be canceled. In addition, energy may be recovered by selecting “Infirmary”. In a state where the nurture target character has not obtained a minus parameter, the infirmary operation portion 215d cannot be selected.

The player can select “Going out” as the selection item by operating the going out operation portion 215e. When “Going out” is selected, the mood of the nurture target character is raised. In addition, the player can select the race type to enter the nurture target character in by operating the race operation portion 215f.

When the nurture target character performs any of rest, training, infirmary, going out, and race entry, the current turn ends and the current turn shifts to the next turn.

As described above, a race-limited turn in which each item of the rest operation portion 215a, the training operation portion 215b, the infirmary operation portion 215d, and the going out operation portion 215e cannot be selected is set for each character. In the race-limited turn, the rest operation portion 215a, the training operation portion 215b, the infirmary operation portion 215d, and the going out operation portion 215e are displayed grayed out, and an operation by the player is not accepted.

Thus, in the race-limited turn, the player has to operate the race operation portion 215f to enter the nurture target character into a race. Although detailed description is omitted, as illustrated in FIG. 17, the 74th turn, the 76th turn, and the 78th turn are set to race-limited turns for all of the characters in common. In these three turns, the player needs to enter the nurture target character in a special race.

In addition, the skill operation portion 215c is set to be always selectable in all turns. Although details will be described later, even if skill obtainment is performed, the turn does not end.

In each turn, a fragment item is associated with each of the training items of “rest” and “training” and each of the selection items of “going out” and “race”. In the rest operation portion 215a, the going out operation portion 215e, and the race operation portion 215f, a suggestion icon 216 corresponding to a fragment item associated with each operation portion is displayed. As will be described in detail later, a plurality of types of fragment items are provided, and the suggestion icon 216 corresponding to the type of fragment item associated with the operation portion is displayed.

When a predetermined obtainment condition is satisfied, such as when a selection item associated with a fragment item is selected, the player or the nurture target character obtains the fragment item. Note that obtainment information on the fragment item, in other words, information indicating the fragment item obtained by the player is stored in association with the player information. However, hereinafter, for ease of understanding, a case where the nurture target character obtains a fragment item will be described. Here, the fragment item is associated with an advantageous effect for the nurture target character. This effect is different for each type of fragment item. When the nurture target character obtains a fragment item, an effect associated with the obtained fragment item is activated. Thus, it can be said that, in each turn, an effect is associated with each selection item.

A knowledge table check icon 217, an effect display region 218, and a special effect icon 219 are displayed in the upper left portion of the top screen 210. The knowledge table check icon 217 functions as an operation portion that receives a player operation. The player can check the fragment item or the like obtained by the nurture target character by operating the knowledge table check icon 217.

In the effect display region 218, an effect icon 218a is displayed. The effect icon 218a is provided for each type of effect, that is, for each type of fragment item. In the effect display region 218, the effect icon 218a corresponding to the currently active effect is displayed.

The special effect icon 219 indicates a special effect that is activated. Although details will be described later, when the nurture target character obtains eight fragment items, “Goddess' Wisdom” associated with a special effect is generated. The player can use the generated Goddess' Wisdom at a desired timing to activate the special effect. The special effect includes a time-limited effect with the number of turns set as an effective period. The time-limited effect is only active for the effective period. The special effect icon 219 indicates the special effect that is currently active and the number of turns remaining in the effective period.

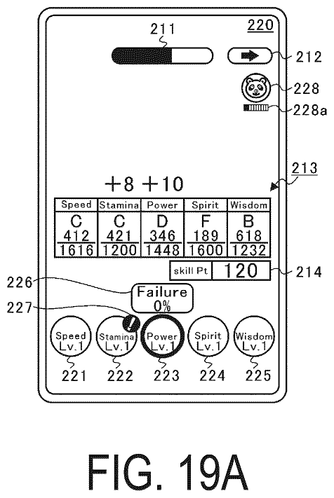

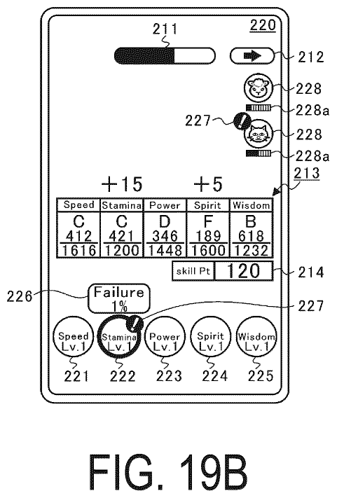

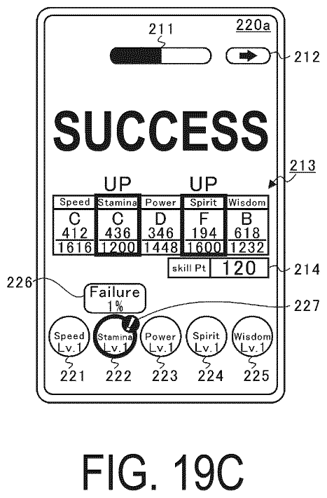

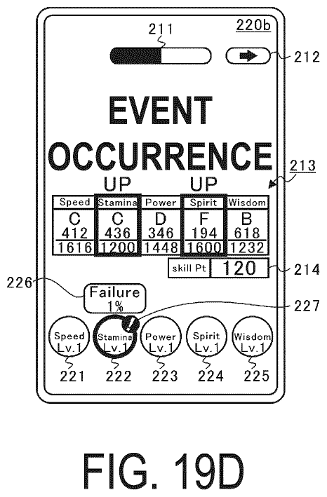

FIG. 19A is a first diagram for describing a training screen 220. FIG. 19B is a second diagram for describing the training screen 220. When the training operation portion 215b of the top screen 210 is operated, the training screen 220 is displayed on the display 26. Although not illustrated in FIGS. 19A and 19B, the knowledge table check icon 217, the effect display region 218, and the special effect icon 219 are displayed on the training screen 220 as on the top screen 210.

As illustrated in FIG. 19A, training items are displayed in a lower portion of the training screen 220. Here, a speed operation portion 221, a stamina operation portion 222, a power operation portion 223, a spirit operation portion 224, and a wisdom operation portion 225 are displayed.

When the player operates one of the operation portions 221 to 225, the training item corresponding to the operated operation portion 221 to 225 is put in a provisionally selected state. At this time, the operation portion 221 to 225 corresponding to the training item in the provisionally selected state is highlighted. In FIG. 19A, the power operation portion 223 is provisionally selected. In FIG. 19B, the stamina operation portion 222 is provisionally selected.

When the speed operation portion 221 in the provisionally selected state is operated again, speed training is executed. Similarly, when the stamina operation portion 222, the power operation portion 223, the spirit operation portion 224, or the wisdom operation portion 225 in the provisionally selected state is operated again, training of stamina, power, spirit, or wisdom is executed, respectively.

In addition, a training level for each training item is also displayed in each of the operation portions 221 to 225. The training level is a parameter that increases based on the number of successful trainings, and when the training level is higher, the increase value of the ability parameter when the training is performed is larger. The training level is initially set to level 1 and can increase up to level 5.

In addition, a failure rate display portion 226 is displayed at the operation portion 221 to 225 in the provisionally selected state. The failure rate displayed as a numerical value in the failure rate display portion 226 is set so as to increase in inverse proportion to the remaining energy displayed in the energy display portion 211.

Further, in the stats display portion 213, the increase value of the ability parameter when training corresponding to the operation portion 221 to 225 in the provisionally selected state is successful is displayed. In the example illustrated in FIG. 19A, the power operation portion 223 is provisionally selected, and “+8” is displayed in the stamina field of the stats display portion 213 and “+10” is displayed in the power field of the stats display portion 213. Also, in the example illustrated in FIG. 19B, the stamina operation portion 222 is provisionally selected, and “+15” is displayed in the stamina field of the stats display portion 213 and “+5” is displayed in the spirit field of the stats display portion 213.

In addition, when the training is successfully executed, a predetermined event may occur. In this case, an event notification display 227 is displayed at the operation portion 221 to 225 corresponding to the training item for which the predetermined event occurs. Note that the event notification display 227 may have different display modes depending on the type of the event.

In a turn in which training can be executed, a character may be placed in each training item. The characters placed in the training items are the above-described support characters, specific characters, and story characters set separately from these characters. In a turn in which training can be executed, for each character that can be placed in training, whether to place the character in a training item and the training item for placement are determined through a lottery.

As illustrated in FIG. 19B, in an upper right portion of the training screen 220, a placed character icon 228 corresponding to the character placed in training (hereinafter referred to as a placed character) for each of the provisionally selected operation portions 221 to 225 is displayed. When the training is successful, a predetermined event may occur that is associated with the placed character. In this case, the event notification display 227 is displayed on the corresponding placed character icon 228.

Also, when training associated with a placed character is successful, the parameter increase value of the nurture target character is higher than that when training not associated with any of the placed characters is successful. Hereinafter, training in which a character is placed will be referred to as joint training.

Further, a bond gauge 228a is displayed below the placed character icon 228. The bond gauge 228a visually displays the bond parameter associated with the placed character. When the placed character succeeds in the associated training, the bond parameter of the placed character increases. When the bond parameter values are higher, the increase value of the ability parameter of the nurture target character when the training is successful is larger.

Also, when a support character whose bond parameter is equal to or greater than a predetermined value is placed in a predetermined training item, a friendship training possible state is set for the training item. When the training item in which the friendship training possible state is set is selected and the training is successful, friendship training occurs. In other words, when the training in the friendship training possible state is successful, the normal joint training is promoted to the friendship training. In the friendship training, the increase value of the ability parameter of the nurture target character is larger than that in the normal joint training.

Note that any one of the five training items of speed, stamina, power, spirit, and wisdom may be associated with the support card (support character) as a favored training. Here, the setting conditions for the friendship training possible state are that the support character is placed in the favored training and that the bond parameter of the support character is equal to or greater than a predetermined value.

Thus, when a support character whose bond parameter is equal to or greater than a predetermined value is placed in the favored training of the support character, the friendship training possible state is set for this training item. Then, when the training item in which the friendship training possible state is set is selected and the training is successful, the ability parameter of the nurture target character greatly increases as compared with the normal joint training.

Note that the support card (support character) may include a support card (support character) not associated with the favored training. For a support card (support character) not associated with a favored training, the friendship training possible state may be set on the condition that the bond parameter of the support character is equal to or greater than a predetermined value regardless of the placed training item. Alternatively, for a support card (support character) not associated with a favored training, the friendship training possible state may not be set.

As described above, in the present embodiment, the setting conditions of the friendship training possible state include that the bond parameter of the support character is equal to or greater than a predetermined value and that a support character is placed in a pre-set training item.

As described above, in each turn, a fragment item is associated with a training item. Although not illustrated in FIGS. 19A and 19B, the suggestion icon 216 is displayed in each of the speed operation portion 221, the stamina operation portion 222, the power operation portion 223, the spirit operation portion 224, and the wisdom operation portion 225. Then, when the selected training is successful, the nurture target character obtains the fragment item associated with the selected training item. The fragment item will be described later.

FIG. 19C is a diagram for describing a training result notification screen 220a. When any one of the operation portions 221 to 225 in the provisionally selected state is operated again, the training corresponding to the operated operation portion 221 to 225 is executed. When the training is performed, the training result notification screen 220a is displayed on the display 26. On the training result notification screen 220a, an image notifying of the success or failure of the training is displayed.

Although not illustrated, in a case where normal joint training is executed, an image of the nurture target character executing training is displayed on the training result notification screen 220a. The image displayed at this time is provided for each training item. In addition, the image corresponding to each training item is provided with a success pattern displayed when the training is successful and a failure pattern displayed when the training is failed.

When the training in which the friendship training possible state is set is successful, a friendship-training-exclusive performance is executed. The friendship-training-exclusive performance includes a performance in which a support character is displayed on the training result notification screen 220a. The support character displayed at this time is a character satisfying the setting conditions of the friendship training possible state.

For example, it is assumed that the character A, which is a support character, is placed in the training item of speed. Also, in this example, the bond parameter of the character A is equal to or greater than a predetermined value and the favored training of the character A (support card) is speed. In this case, the speed training item is in a friendship training possible state. In this state, let's assume that the speed training item is selected and the speed training is successful. In this case, an image including the character A is displayed on the training result notification screen 220a.

In one turn, a plurality of support characters placed in the same training item may satisfy the setting condition of the friendship training possible state. For example, it is assumed that four support characters of the characters A, B, C, and D are placed in the training item of stamina. At this time, let's assume that the characters A, B, C, and D all satisfy the setting condition of the friendship training possible state. In this case, a friendship-training-exclusive performance in which the characters A, B, C, and D are displayed simultaneously or sequentially on the training result notification screen 220a is executed.

In the friendship-training-exclusive performance, the character satisfying the setting condition of the friendship training possible state and the nurture target character perform training together. Thus, it can be said that the friendship training possible state is set to the support character in addition to the training item.

Although not illustrated, an effect is superimposed and displayed on the placed character icon 228 corresponding to the placed character for which the friendship training possible state is set. Accordingly, the player can identify which placed character the friendship training occurs with. In addition, when the friendship training possible state is set to any of the training items, the effect is also superimposed and displayed on the training operation portion 215b of the top screen 210. Thus, also via the top screen 210, the player can recognize that the friendship training possible state is set.

Also, on the training result notification screen 220a, the ability parameters of the stats display portion 213 are updated and displayed. That is, the ability parameter of the nurture target character corresponding to the training item selected by the player is updated.

Here, the value of the ability parameter that increases when the training displayed in the stats display portion 213 in FIG. 19A or 19B is successful is added. In addition, the display of the energy display portion 211 is updated according to the performed training item. When speed, stamina, power, or spirit training is successful, the energy decreases. On the other hand, when wisdom training is successful, energy is recovered.

When the training is failed, a predetermined penalty is given. Specifically, the content of the penalty may include a decrease in energy, a decrease in a numerical value of an ability parameter, a decrease in mood, and the like. Note that, for example, the penalty given when the failure rate is high may be more disadvantageous than the penalty given when the failure rate is low (for example, the numerical value of the decrease in energy is large, the numerical value of the decrease in the ability parameter is large, or the level of the decreasing mood is large).

The content of the penalty may be determined in accordance with the training item. For example, the value of the ability parameter for speed may be decreased when the training of speed has failed, and the value of the ability parameter for power may be decreased when the training of power has failed. In addition, for one or more training items (for example, wisdom), even if training fails, it can be set that a penalty is not given.

FIG. 19D is a diagram for describing an event screen 220b. When the display of the training result notification screen 220a ends, the event screen 220b may be displayed on the display 26. Various events are performed via the event screen 220b. Note that a plurality of events may occur during one turn.

For example, when a first hint event or a second hint event occurs, a skill hint may be obtained. When skill hint is obtained, the player can obtain the skill by spending skill points. A plurality of types of skills are provided, and a predetermined ability may be activated for each skill. An activation condition and an effect are determined for each skill, and when an activation condition is satisfied, a predetermined effect is activated. A skill may be activated while a race is being executed as will be described below.

The events include, in addition to the first hint event and the second hint event for obtaining a skill hint, an event for recovering energy, an event for decreasing energy, a first ability event and a second ability event for increasing or decreasing an ability parameter, an event for increasing mood, an event for decreasing mood, and the like. Also, as will be described in detail below, examples of the event include an event that occurs in a predetermined turn and an event that occurs via a successful lottery. In addition, there are events that occur at the start of a turn and events that occur before the end of a turn. When all the events that have occurred end, the top screen 210 related to the next turn is displayed.

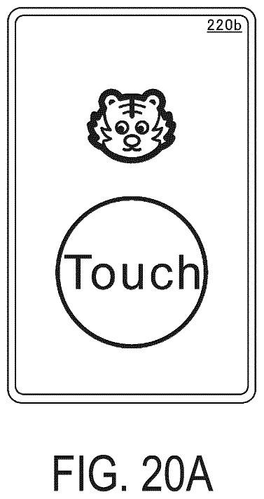

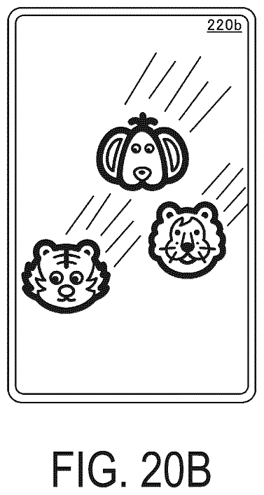

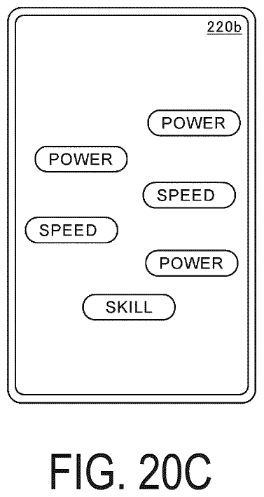

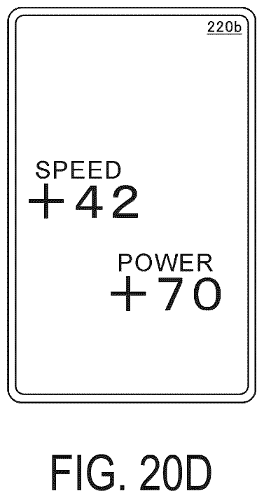

FIG. 20A is a first diagram for describing an inheritance event. FIG. 20B is a second diagram for describing the inheritance event. FIG. 20C is a third diagram for describing the inheritance event. FIG. 20D is a fourth diagram for describing the inheritance event. In the factor activation turn described above, an inheritance event occurs with the start of the turn. Note that this inheritance event is a scenario-shared event to be described later and always occurs in the same turn regardless of the scenario selected by the player. In the present embodiment, the first turn, the 31st turn, and the 55th turn are set as factor activation turns. The example described is of an inheritance event occurring on the 31st turn.

When the 31st turn is started, first, as illustrated in FIG. 20A, the nurture target character and an operation portion labelled with “Touch” are displayed on the event screen 220b. When the operation portion displayed on the event screen 220b is tapped, an animation image including the nurture target character and the two inheritance characters is displayed as illustrated in FIG. 20B. In addition, when the operation portion is tapped, a lottery for whether to activate is performed for all the factors possessed by a total of six nurtured characters of the first inheritance generation and the second inheritance generation.

Then, as illustrated in FIG. 20C, the factor which is successful through the lottery for whether to activate and is determined to be activated is displayed, and thereafter, as illustrated in FIG. 20D, the type of the ability parameter or the aptitude parameter which is increased by the activation of the factor and the increase value are displayed, and the parameter is updated. When the inheritance event ends, the top screen 210 illustrated in FIG. 18A is displayed, and the player can select any item. At this time, the stats display portion 213 is in a state in which the increase values for the ability parameter and the aptitude parameter displayed in the inheritance event are added.

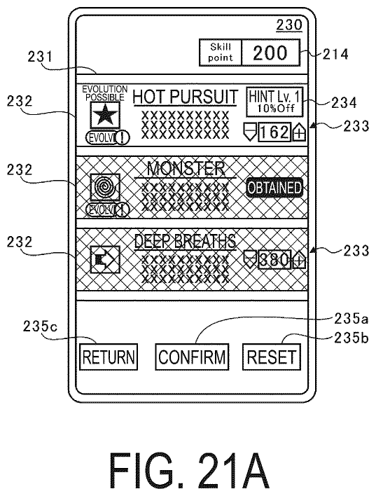

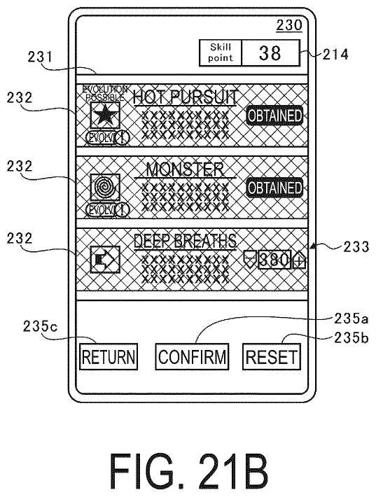

FIG. 21A is a first diagram for describing a skill screen 230. FIG. 21B is a second diagram for describing the skill screen 230. When the skill operation portion 215c of the top screen 210 is operated, the skill screen 230 illustrated in FIG. 21A is displayed on the display 26. A skill point display portion 214 is displayed on the skill screen 230. In the skill point display portion 214, the current skill points possessed by the nurture target character (player) is displayed as described above.

A skill display region 231 is provided below the skill point display portion 214. A plurality of skill display fields 232 are provided in the skill display region 231. In the skill display field 232, an obtained skill, a base skill set in advance for the nurture target character, a base skill possessed due to one of various events, and the like are displayed. Although three skill display fields 232 are displayed in the skill display region 231 in FIG. 21A, when a slide operation is input to the skill display region 231, another skill display field 232 is further displayed in the skill display region 231.

The skill name, the skill activation condition and effect when the skill is activated, and the like are displayed in the skill display region 231. On the right side of the skill display region 231, a required point display portion 233 is displayed. The required point display portion 233 displays the skill points necessary for obtaining the skill. Further, the required point display portion 233 is provided with an operation portion marked with “+” or “−”. The player can set the skill displayed in the skill display field 232 to the selected state by operating the operation portion marked with “+”. Also, the player can cancel the selected state of the skill displayed in the skill display field 232 by operating the operation portion marked with “−”.

When the first hint event or the second hint event occurs for a base skill, the skill points spent to obtain the base skill is discounted. Also, when the hint level of the character is strengthened before the start of the nurture game, the skill points for obtaining the base skill are discounted. Here, the skill points after the discount are displayed in the required point display portion 233 for the base skill for which a hint has been obtained. At this time, a discount rate display icon 234 indicating the discount rate is displayed in the skill display field 232.

On the skill screen 230, the skill display field 232 corresponding to an obtainable skill and the skill display field 232 corresponding to an unobtainable skill are identifiably displayed. For example, the skill display field 232 corresponding to the obtained skill and the skill display field 232 corresponding to the base skill that cannot be obtained due to a shortage of skill points are grayed out (indicated by cross-hatching in the diagram). In the skill display field 232 corresponding to the obtained skill, an icon indicating “obtained” is displayed instead of the required point display portion 233.

Below the skill display region 231, a confirmation operation portion 235a, a reset operation portion 235b, and a return operation portion 235c are provided. When the confirmation operation portion 235a is operated in a state where any of the skills is in a selected state, a confirmation screen (not illustrated) is displayed. When a predetermined operation for obtaining a skill is input on the confirmation screen, obtained information is associated with the skill in the selected state. That is, the base skill is updated to an obtained skill.

For example, it is assumed that a skill corresponding to the skill display field 232 displayed at the top row of the skill display region 231 is obtained in the state illustrated in FIG. 21A. In this case, in conjunction with the skill being obtained, the skill screen 230 is updated as illustrated in FIG. 21B. Here, the skill display field 232 displayed at the top row of the skill display region 231 is grayed out. In the skill point display portion 214, the remaining skill points after obtaining the skill are displayed.

When the reset operation portion 235b is operated, the selected states of all the skills are canceled. When the return operation portion 235c is operated, the skill screen 230 is closed and the top screen 210 is displayed.

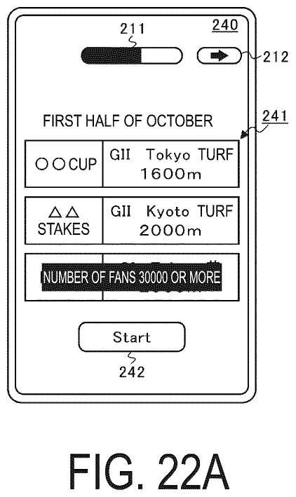

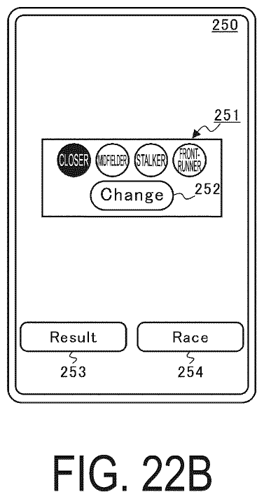

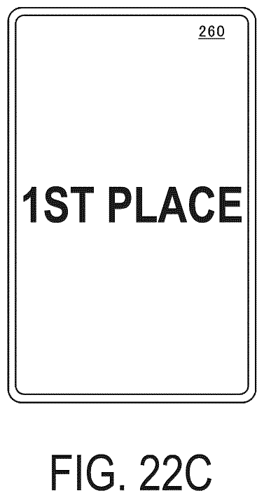

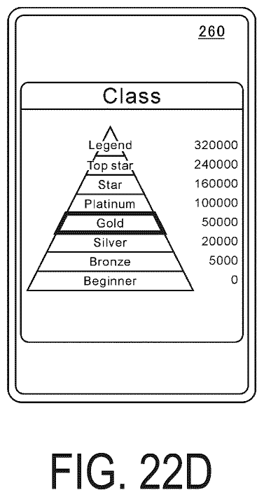

FIG. 22A is a first diagram for describing a race selection screen 240. When the race operation portion 215f of the top screen 210 is operated, the race selection screen 240 illustrated in FIG. 22A is displayed. Races have a game property in which the nurture target character races with non-player characters (hereinafter referred to as NPCs).

In the upper portion of the race selection screen 240, the energy display portion 211 and the mood display portion 212 are displayed. In addition, a race selection operation portion 241 for selecting a race event for the nurture target character to be entered in is displayed in a central portion of the race selection screen 240. In addition, a start operation portion 242 is displayed at a lower portion of the race selection screen 240. A race that can be selected via the race selection operation portion 241 of the race selection screen 240 is set in advance for each turn.

In addition, the race entry condition is set in advance for each race, and the player can only enter the nurture target character in a race with race entry conditions that are satisfied. As described above, a race may have the number of fans set as a race entry condition. For a race with a set number of fans that is not satisfied, as illustrated in FIG. 22A, the race selection operation portion 241 displays the race entry condition and notifies that the race cannot be selected. In the turn in which the target race of the clear goal is set, only the target race is displayed in a selectable manner on the race selection screen 240.

FIG. 22B is a diagram for describing a race start screen 250. When the start operation portion 242 is operated in a state where the race event of the race to enter is selected by the race selection operation portion 241, the race start screen 250 illustrated in FIG. 22B is displayed. A strategy display portion 251 is displayed at a central portion of the race start screen 250. In the strategy display portion 251, the currently selected strategy (closer, midfielder, stalker, front-runner) is highlighted. A change operation portion 252 is displayed in the strategy display portion 251. When the change operation portion 252 is operated, a strategy change screen (not illustrated) is displayed on the display 26. The player can change the strategy in the race to any strategy by an operation on the strategy change screen.

Further, at a lower portion of the race start screen 250, a result operation portion 253 and a race operation portion 254 are displayed. When the race operation portion 254 is operated, a race screen (not illustrated) is displayed on the display 26. On the race screen, a moving image of developments in the race (hereinafter also referred to as a race moving image) is displayed.

FIG. 22C is a first diagram for describing a race result screen 260. FIG. 22D is a second diagram for describing the race result screen 260. When playback of the race moving image described above ends and when the result operation portion 253 is operated, the race result screen 260 is displayed on the display 26. On the race result screen 260, as illustrated in FIG. 22C, the placing of the nurture target character in the race is displayed. Further, on the race result screen 260, as illustrated in FIG. 22D, the current class of the nurture target character is displayed.

In the present embodiment, the nurture target character is classified according to the number of fans obtained. A range of the number of fans is set for each class. Here, the nurture target character is classified into one of eight levels of classes according to the number of fans. On the race result screen 260, the cumulative number of fans obtained by adding the number of fans obtained in the current race to the number of fans obtained before is displayed. In addition, the current class corresponding to the cumulative number of fans is identifiably displayed.

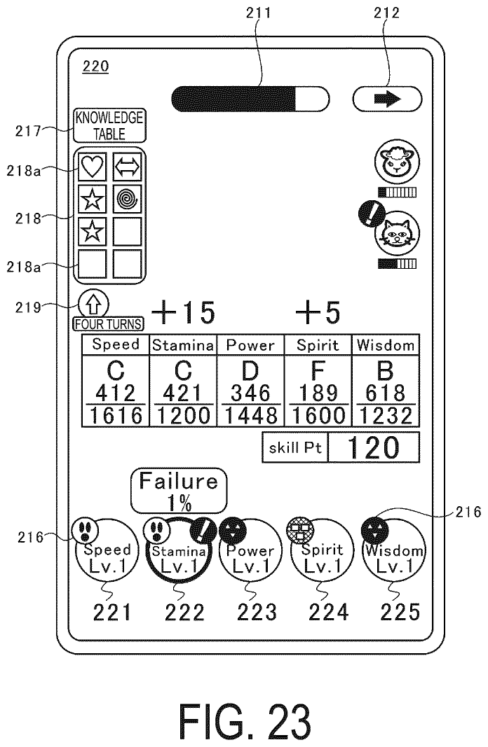

FIG. 23 is a third diagram for describing the training screen 220. As illustrated in FIG. 23, the suggestion icon 216 is displayed in the speed operation portion 221, the stamina operation portion 222, the power operation portion 223, the spirit operation portion 224, and the wisdom operation portion 225. The knowledge table check icon 217, the effect display region 218, and the special effect icon 219 are displayed in the upper left portion of the training screen 220. Three types of suggestion icons 216 are provided. The suggestion icon 216 is a display mode that enables a character to be identified.

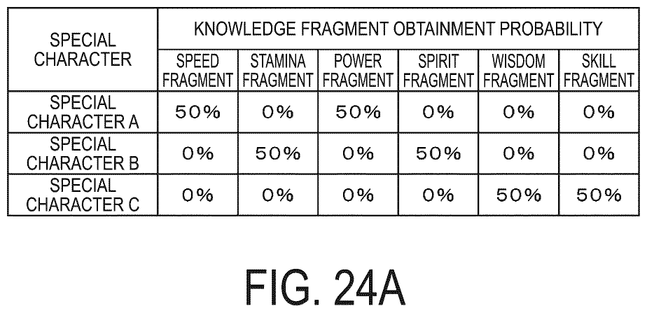

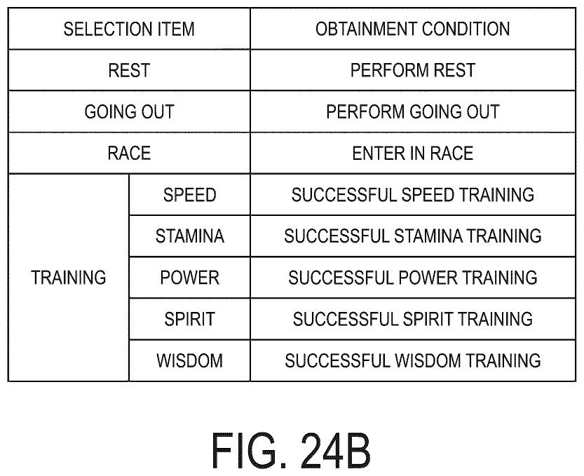

FIG. 24A is a diagram for describing the relationship between a special character and a fragment item. The nurture main game has a story component, and the nurture main game progresses in accordance with the story. Three special characters A, B, and C appear in the story. Thus, during the nurture main game, a performance in which the three special characters are displayed occurs in various scenes.

Six types of fragment items are provided. Here, a speed fragment, a stamina fragment, a power fragment, a spirit fragment, a wisdom fragment, and a skill fragment are provided. Any one of the three special characters is associated with the six fragment items. Specifically, the special character A is associated with the speed fragment and the power fragment. In addition, the special character B is associated with the stamina fragment and the spirit fragment. The special character C is associated with the wisdom fragment and the skill fragment.

FIG. 24B is a diagram for describing an obtainment condition of a fragment item. In each turn, one fragment item is always arranged, that is, associated with the total of eight selection items including rest, going out, race, and the five training items. For example, at the start of each turn, which of the three special characters is to be arranged is determined through a lottery for each of the eight selection items. Here, the selection probabilities of the special characters A, B, and C are equal to each other for all of the eight selection items. However, the selection probabilities of the special characters A, B, and C may be different depending on the selection item. On the top screen 210 and the training screen 220, the suggestion icon 216 corresponding to the special character determined through the lottery is superimposed and displayed on each operation portion.

Each of the three special characters is associated with a special character ID as a first attribute. Then, at the start of the turn, the special character ID to be arranged in each selection item is determined.

When the special character to be arranged is determined, an effect ID indicating the type of effect is determined as a second attribute. The effect ID is associated with information indicating the type of the fragment such as speed and stamina and information such as a parameter indicating the content of the effect. Thus, the effect ID may be information indicating a fragment item.

Here, any effect ID, that is, a fragment item, is determined based on the determined special character. For example, it is assumed that the special character A is determined as the special character to be arranged at the rest selection item. In this case, as illustrated in FIG. 24A, in the lottery based on the special character A, either the effect ID of the speed fragment or the effect ID of the power fragment is determined. Similarly, for example, it is assumed that the special character B is determined as the special character to be arranged at the stamina selection item. In this case, in the lottery based on the special character B, either the effect ID of the stamina fragment or the effect ID of the spirit fragment is determined. Also, for example, it is assumed that the special character C is determined as the special character to be arranged at the race selection item. In this case, in the lottery based on the special character C, either the effect ID of the wisdom fragment or the effect ID of the skill fragment is determined.

As described above, in the present embodiment, a special character is first determined for each selection item for which a fragment item is to be arranged. Then, any of the plurality of fragment items associated with the special character is associated with the selection item. The method of determining the fragment item associated with the selection item is not limited to this. For example, any one of the six types of fragment items may be determined through a lottery for each selection item. At this time, the selection probabilities for the six types of fragment items may be equal for all the selection items, or the selection probabilities may be different for each selection item. Then, the suggestion icon 216 of the special character associated with the determined fragment item may be displayed at each selection item operation portion.

The suggestion icons 216 displayed on the top screen 210 and the training screen 220 suggest the special characters arranged at the respective selection items. That is, the player can comprehend the type of the fragment item that may be obtained when each selection item is selected. However, the player does not know which fragment item can be obtained.

For example, it is assumed that the suggestion icon 216 corresponding to the special character A is displayed at the going out operation portion 215e. At this time, the player can comprehend that the speed fragment or the power fragment can be obtained by selecting going out. However, when the user selects going out, the user does not know which of the speed fragment and the power fragment will be obtained.

However, the suggestion icon 216 displayed at the selection item may be provided for each fragment item. That is, the player may know in advance the type of the fragment item associated with the selection item.

As illustrated in FIG. 24B, the obtainment condition of the fragment item is set in advance for each selection item. For the rest, going out, and race, selection of each selection item is set as an obtainment condition. On the other hand, for all of the five training items, success in the selected training is set as an obtainment condition. Thus, when the training is selected and executed but the training fails, the fragment item cannot be obtained.

However, the above-described obtainment conditions are merely examples. For example, when rest or going out is selected, a fragment item may be obtained only at a predetermined probability. Further, for example, when race is selected, a fragment item may be obtained by winning the race. Also, when training is selected, the fragment item may be obtained regardless of success and failure. Here, the fragment item is associated with the selection item of race, but the fragment item may be associated with each type of race.

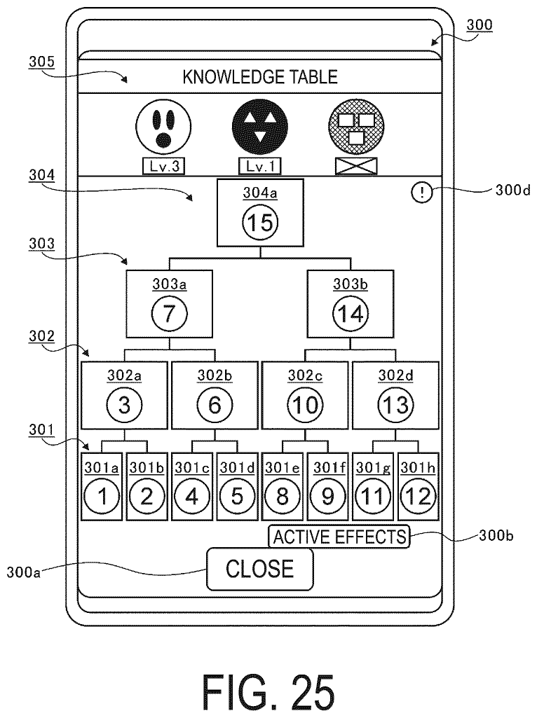

FIG. 25 is a first diagram for describing a knowledge table dialog 300. When the knowledge table check icon 217 is operated on the top screen 210 or the training screen 220, the knowledge table dialog 300 is displayed. Here, a game property of the present embodiment will be described using the knowledge table dialog 300. The knowledge table dialog 300 includes a fragment display region 301, a first crystal display region 302, a second crystal display region 303, and a Goddess' Wisdom display region 304.

The fragment display region 301 includes eight icon display portions 301a, 301b, 301c, 301d, 301e, 301f, 301g, and 301h. The eight display portions of the fragment display region 301 are displayed in alignment in the left-right direction. The first crystal display region 302 is provided above the fragment display region 301. The first crystal display region 302 includes four icon display portions 302a, 302b, 302c, and 302d. The four display portions of the first crystal display region 302 are displayed in alignment in the left-right direction.

The second crystal display region 303 is provided above the first crystal display region 302. The second crystal display region 303 includes two icon display portions 303a and 303b. The two display portions of the second crystal display region 303 are displayed in alignment in the left-right direction. The Goddess' Wisdom display region 304 is provided above the second crystal display region 303. The Goddess' Wisdom display region 304 includes one icon display portion 304a. Thus, a total of 15 display portions are provided in the knowledge table dialog 300.

When the nurture target character obtains a fragment item, an icon corresponding to the obtained fragment item is displayed on any of the display portions of the fragment display region 301. Here, each time a fragment item is obtained, icons are displayed in order from the icon display portion 301a to the icon display portion 301h in the fragment display region 301. The obtained fragment item is associated with information indicating the display position, that is, an ID for distinguishing between the icon display portions 301a to 301h in FIG. 25.

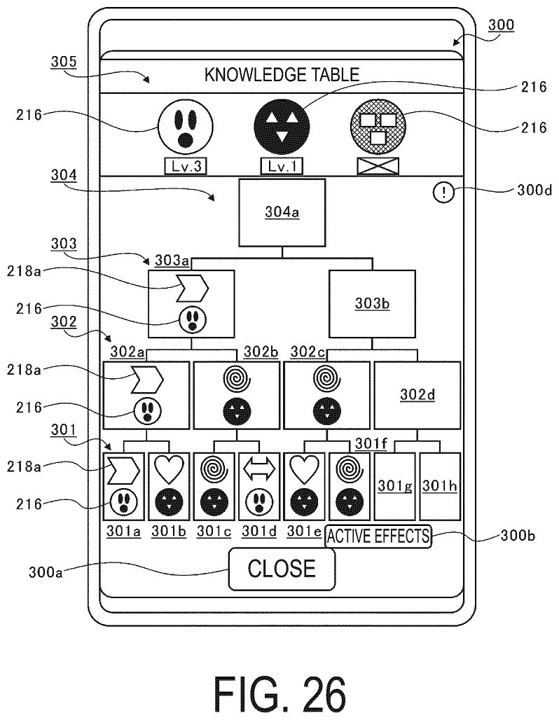

FIG. 26 is a second diagram for describing the knowledge table dialog 300. When the nurture target character obtains the first fragment item, the effect icon 218a and the suggestion icon 216 are displayed at the icon display portion 301a. In this example, to facilitate understanding, the suggestion icon 216 is displayed at each display portion. However, the display of the suggestion icon 216 is not essential.

As described above, six types of fragment items are provided, and each fragment item is associated with any one of the three special characters. In the knowledge table dialog 300, special characters associated with a fragment item are preferably identifiable. Thus, for example, when the suggestion icon 216 is not displayed, colors such as red, blue, and green may be associated with the three special characters as image colors. Then, the display portion where the effect icon 218a is displayed is displayed in the image color of the special character associated with the obtained fragment item. In this manner, the special character associated with the obtained fragment item can be identified.

While the effect icon 218a is displayed at the icon display portion 301a, the effect icon 218a, that is, the effect corresponding to the obtained fragment item, is activated. Thus, the first effect is activated when the nurture target character obtains the fragment item and the effect icon 218a is displayed at the icon display portion 301a.

Here, a fragment item obtained by the nurture target character is referred to as a knowledge fragment. That is, the nurture target character possesses the obtained fragment item as a knowledge fragment. It is assumed that the nurture target character newly obtains a fragment item in the next turn or later in a state of possessing the first knowledge fragment. In this case, the nurture target character is in a state of possessing two knowledge fragments, and the effect icon 218a and the suggestion icon 216 are displayed at the icon display portion 301b. Thus, in this state, the effect of the first knowledge fragment and the effect of the second knowledge fragment are activated.

While the nurture target character possesses the knowledge fragment, the effect of the knowledge fragment is activated. When the number of knowledge fragments possessed is an even number, one first crystal is generated from the two knowledge fragments possessed. Here, the first crystal is a fragment item arranged in the selection item.

For example, when the nurture target character possesses a second knowledge fragment, the first first crystal is generated. The nurture target character takes possession of the generated first crystal. The first crystal (fragment item) is associated with an effect, and the effect icon 218a and the suggestion icon 216 corresponding to the effect are displayed at the icon display portion 302a of the first crystal display region 302.

When the effect icon 218a is displayed at the display portion of the first crystal display region 302, the effect corresponding to the displayed effect icon 218a is activated. That is, when the second knowledge fragment is possessed, the effect associated with the second knowledge fragment and the effect associated with the first first crystal are simultaneously active.

In FIG. 25, the numbers 1 to 15 displayed in the respective display portions indicate the order in which the effect icons 218a and the like are displayed. As described above, when the first fragment item is obtained, the effect icon 218a is displayed at the icon display portion 301a. Thereafter, when the second fragment item is obtained, the effect icon 218a is displayed at the icon display portion 301b. At this time, the first crystal is generated based on the first obtained fragment item and the second obtained fragment item. The first crystal is generated as the successor of one of the two fragment items.

For example, it is assumed that the first obtained fragment item is a speed fragment and the second obtained fragment item is a stamina fragment. In this case, as the first crystal, a speed fragment and a stamina fragment are generated with a probability of 50%, respectively. In this manner, the first crystal is generated with the two knowledge fragments (as fragment items) as parents. Then, one type of the two types of parent knowledge fragments is inherited by the first crystal. In this manner, when the nurture target character possesses the first crystal, the effect associated with the possessed first crystal (as a fragment item) is active.

Further, as illustrated in FIG. 26, when the third fragment item is obtained, the effect icon 218a is displayed at the icon display portion 301c. Thereafter, when the fourth fragment item is obtained, the effect icon 218a is displayed at the icon display portion 301d. At this time, a second first crystal is generated based on the third and fourth fragment items in the same manner as described above. When the second first crystal is generated, the effect icon 218a is displayed at the icon display portion 302b of the first crystal display region 302.

When the number of first crystals possessed is an even number, one second crystal is generated from the two first crystals possessed. The second crystal is a fragment item. The second crystal (as a fragment item) is associated with an effect, and the effect icon 218a and the suggestion icon 216 corresponding to the effect are displayed at the icon display portion 303a of the second crystal display region 303.

The second crystal is generated with the two first crystals as parents. Then, one type of the two types of parent first crystals is inherited by the second crystal. As in the case of the knowledge fragment and the first crystal, a state in which a second crystal, from among the generated second crystals, has an activated effect is defined as the possession state. In other words, when the nurture target character possesses the second crystal, the effect associated with the possessed second crystal (as a fragment item) is active.

When the effect icon 218a is displayed at the display portion of the second crystal display region 303, the effect corresponding to the displayed effect icon 218a is activated. That is, when the fourth fragment item is obtained, the effect associated with the fourth knowledge fragment, the effect associated with the second first crystal, and the effect associated with the first second crystal are simultaneously active.

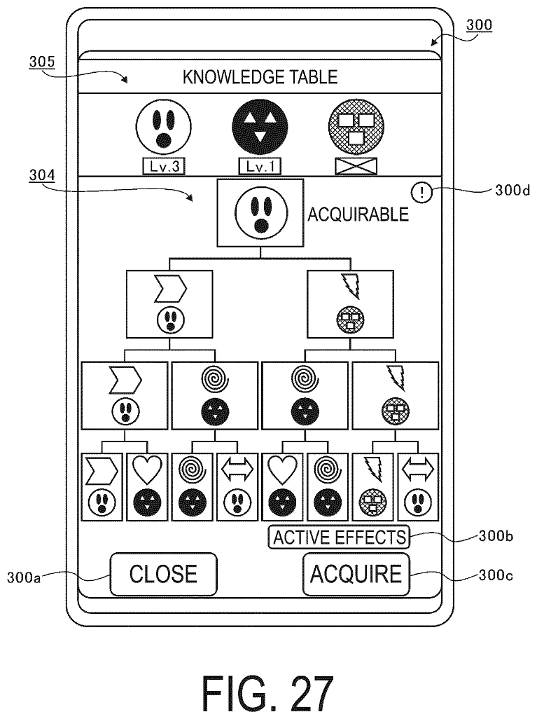

FIG. 27 is a third diagram for describing the knowledge table dialog 300. When the fifth to eighth fragment items are obtained, the first crystal and the second crystal are generated in the same manner as described above. When the eighth fragment item is obtained, the second second crystal is generated, and the effect icon 218a is displayed at the icon display portion 303b of the second crystal display region 303.

When the number of second crystals possessed is an even number, one Goddess' Wisdom is generated from the two second crystals possessed. To be specific, when the second second crystal is generated, one Goddess' Wisdom is generated. One of the three special characters is associated with the Goddess' Wisdom generated at this time. The suggestion icon 216 corresponding to the special character associated with the Goddess' Wisdom is displayed at the icon display portion 304a of the Goddess' Wisdom display region 304. That is, it can be said that three types of Goddess' Wisdom are provided for each special character.

Note that a special effect is associated with the Goddess' Wisdom, and the special effect is activated when a predetermined activation condition described later is satisfied. The player can activate the special effect at any timing. That is, even if the Goddess' Wisdom is generated, the special effect is not activated until the activation condition is satisfied. In the following, the state of the Goddess' Wisdom in which the special effect is not activated is referred to as the possession state.

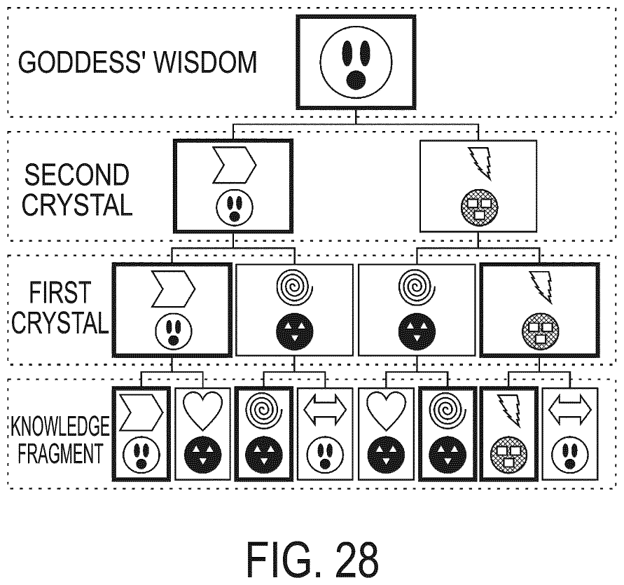

FIG. 28 is a diagram for describing a Goddess' Wisdom determination method. As described above, the first crystal is generated by succeeding one of the two knowledge fragments (fragment items) serving as parents. The second crystal is generated by succeeding one of the two first crystals (fragment items) serving as parents. Since the special character is associated with the fragment item, the special character is inherited by the first crystal and the second crystal. Then, the special character associated with one of the two second crystals is inherited by the Goddess' Wisdom. In other words, it can be said that the type of the Goddess' Wisdom is determined based on the special characters associated with the two second crystals.

Here, of the special characters associated with the two second crystals, the special character that is associated with the largest number of knowledge fragments is inherited by the Goddess' Wisdom. For example, it is assumed that, as illustrated in FIG. 28, three special characters A (white characters in the diagram), four special characters B (black characters in the diagram), and one special character C (cross-hatched character in the diagram) are associated with a knowledge fragment (as a fragment item). In this example, the special character B is associated with the largest number of knowledge fragments.

However, the special character B is not associated with the second crystal. Thus, the special character B is not inherited by the Goddess' Wisdom. In this example, of the special characters A and C associated with the second crystal, the special character A is associated with more knowledge fragments than the special character C. Thus, the Goddess' Wisdom is associated with the special character A.

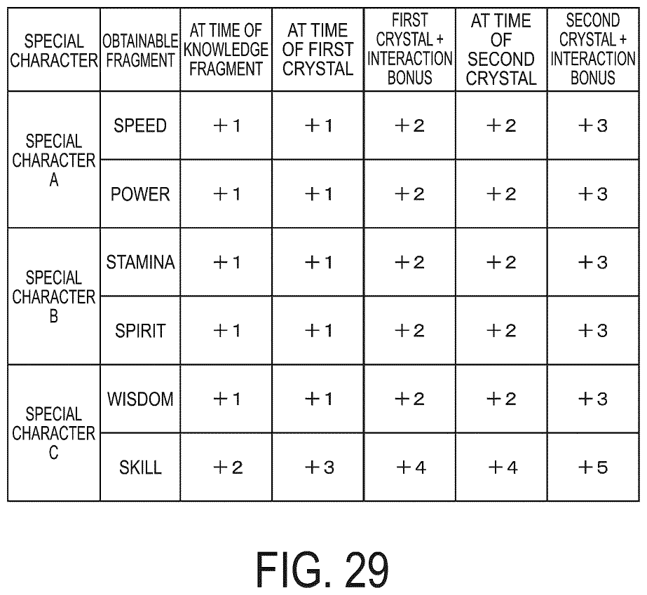

FIG. 29 is a diagram illustrating the effect of a fragment item. As described above, six types of fragment items are provided, namely, speed fragments, power fragments, stamina fragments, spirit fragments, wisdom fragments, and skill fragments. When the user possesses a fragment item such as a knowledge fragment, a first crystal, and a second crystal, the effect set to the possessed fragment item is activated. As illustrated in FIG. 29, in a case where the user possesses a speed fragment, the speed parameter is increased by “1” when the speed training is successful. Thus, for example, when three speed fragments are possessed, the speed parameter is increased by “3”.

Also, in a case where the user possesses a speed fragment as a first crystal, the speed parameter is increased by “1” when the speed training is successful. Here, the first crystal is generated by succeeding one of the two knowledge fragments (fragment items) serving as parents. At this time, when the special characters associated with the two knowledge fragments (fragment items) serving as parents are different, an interaction bonus is granted.

Specifically, it is assumed that the two knowledge fragments serving as parents are a speed fragment and a stamina fragment. The special character A is associated with the speed fragment, and the special character B is associated with the stamina fragment. Thus, in this case, the special characters associated with the two knowledge fragments that are parents of the first crystal are different from each other, and thus an interaction bonus is granted. When the player possesses a speed fragment as the first crystal and an interaction bonus is granted, the speed parameter is increased by “2” when the speed training is successful.

Also, in a case where the user possesses a speed fragment as a second crystal, the speed parameter is increased by “2” when the speed training is successful. The second crystal is generated by succeeding one of the two first crystals serving as parents. At this time, when the special characters associated with the two first crystals serving as parents are different, an interaction bonus is granted in a similar manner to as described above. When the player possesses a speed fragment as the second crystal and an interaction bonus is granted, the speed parameter is increased by “3” when the speed training is successful.

Further, for the power fragment, the stamina fragment, the spirit fragment, and the wisdom fragment, as with the speed fragment described above, the effect is set such that the parameter increases as illustrated in FIG. 29 when the training for power, stamina, spirit, and wisdom is successful. In addition, the skill fragment is set with the effect of the skill points obtained when the training is successful being increased as illustrated in FIG. 29 regardless of the training item.

Although the interaction bonus is provided here, the interaction bonus is not essential. In addition, here, the effect of the fragment item is greater for the second crystal compared to the knowledge fragment. However, conversely, the effect of the fragment item may be greater at the time of the knowledge fragment compared to at the time of the second crystal, or the effect may be the same in all states.

As illustrated in FIG. 27, the knowledge table dialog 300 is provided with a close operation portion 300a and a check effect operation portion 300b. When the close operation portion 300a is operated, the knowledge table dialog 300 is hidden. When the check effect operation portion 300b is operated, an active effect list dialog (not illustrated) is displayed. In the active effect list dialog, all the effects that are currently activated by possessing knowledge fragments, first crystals, and second crystals are displayed.

As illustrated in FIG. 27, in a state where the effect icon 218a or the suggestion icon 216 is displayed at all of the display portions, that is, in a state where the user possesses the Goddess' Wisdom, “Acquirable” is displayed at the Goddess' Wisdom display region 304. This indicates to the player that the Goddess' Wisdom is acquirable. In the state of possessing the Goddess' Wisdom, an acquiring operation portion 300c is provided at the knowledge table dialog 300. When the acquiring operation portion 300c is operated, a confirmation screen (not illustrated) is displayed. When a predetermined operation is input on the confirmation screen, the special effect of the Goddess' Wisdom is activated. Hereinafter, the input of the predetermined operation on the confirmation screen is referred to as acquiring the Goddess' Wisdom.

When the Goddess' Wisdom is acquired, the special effect is activated and all of the possessed fragment items (knowledgeable fragments, first crystals, and second crystals) are reset. This deactivates the active effects activated by possessing of the fragment items. That is, by acquiring the Goddess' Wisdom, the special effect is activated and the active effects are deactivated.

When all of the possessed knowledge fragments, first crystals, and second crystals are reset, the effect icon 218a and the suggestion icon 216 are all removed from the knowledge table dialog 300. The player can acquire the Goddess' Wisdom at any timing. Thus, the player can continue the possession state of the Goddess' Wisdom over a plurality of turns. However, in the possession state of the Goddess' Wisdom, the fragment items are not arranged in the selection items and a new fragment item cannot be obtained. The nurture target character can obtain fragment items again by acquiring the Goddess' Wisdom.

The special character is associated with an inheritance level as a parameter. When the Goddess' Wisdom is acquired, the inheritance level of the special character associated with the acquired Goddess' Wisdom rises. A special character display region 305 is provided in the upper portion of the knowledge table dialog 300. In the special character display region 305, the suggestion icon 216 indicating each special character and the current inheritance level of the special character are displayed.

The initial inheritance level of the special character is set to “0”. Then, each time the Goddess' Wisdom is acquired, the inheritance level is raised by “1”. However, an upper limit is set for the inheritance level of the special character. Here, “5” is the upper limit of the inheritance level.

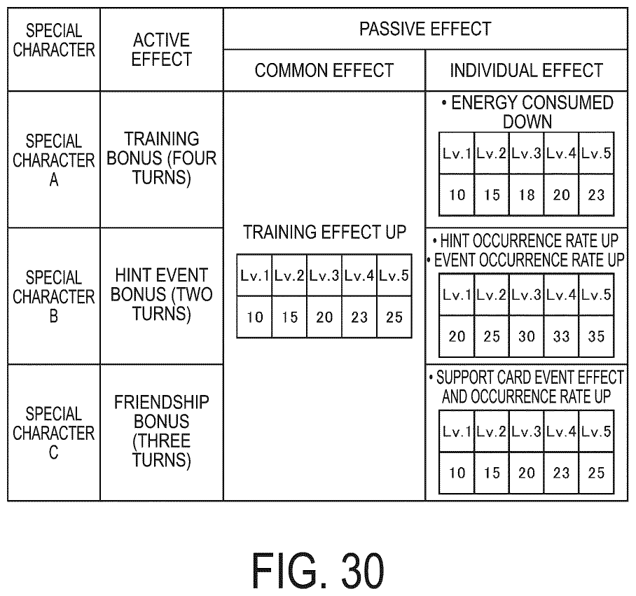

FIG. 30 is a diagram for describing special effects. Special effects are set for each type of the Goddess' Wisdom. In other words, a special effect is provided for each special character. That is, when the Goddess' Wisdom is acquired, the special effect corresponding to the special character associated with the acquired Goddess' Wisdom is activated. As illustrated in FIG. 30, the special effects include active effects and passive effects. The active effects are time-limited effects with a set effective period. The passive effects are effects that are permanently active until the nurture main game ends.

Here, a different active effect is set for each special character. Specifically, a training bonus is set as an active effect for the special character A. The training bonus is a bonus that sets the training level to the maximum (here, “5”). Here, four turns are set as the effective period of the training bonus.

In addition, a hint event bonus is set as an active effect for the special character B. The hint event bonus is a bonus that increases the probability of occurrence of a hint event. In addition, when the hint event bonus is activated, a predetermined parameter is increased when the hint event occurs. Here, two turns are set as the effective period of the hint event bonus.

Further, a friendship bonus is set as an active effect for the special character C. The friendship bonus is a bonus that enables friendship training to occur regardless of the favored training of the placed support character. In this case, three turns are set as the effective period of the friendship bonus.

The content of the active effects and the effective periods illustrated in FIG. 30 are merely examples. The active effect set for the special character, that is, the Goddess' Wisdom, may be common to all of the special characters. The active effects do not necessarily have to be time-limited effects.

Passive effects include common effects and individual effects. The common effects are effects that are active in common for all special characters. Here, as a common effect, an effect of increasing the increase value of an ability parameter when training is successful is provided. Specifically, the increase value of the ability parameter when training is successful is calculated based on a predetermined arithmetic formula. A correction value corresponding to the level of the special character is input to the arithmetic formula. When the input correction value is larger, the increase value of the ability parameter when the training is successful is larger.

Here, as illustrated in FIG. 30, the higher the level of the special character, the higher the correction value, that is, the higher the increase value of the ability parameter when the training is successful. For example, when the level of the special character A is “1” and the levels of the special characters B and C are “0”, the correction value is “10”. For example, when the levels of the special characters A, B, and C are all “5”, the correction value is “75”.

Note that in this example, the correction values corresponding to the three special characters are added. However, the correction values corresponding to the three special characters may be multiplied. Further, as a common effect, a predetermined correction value may be directly added to the increase value of the ability parameter when the training is successful, instead of the correction value being input into the arithmetic formula.

An individual effect is an effect set for each special character, similarly to an active effect. An individual effect of decreasing energy consumed is set to the special character A. Decreasing energy consumed is an effect of reducing the energy consumed during executing training. Here, a correction value corresponding to the level of the special character is input to the arithmetic formula for calculating the energy consumed. At this time, the larger the input correction value is, the smaller the consumption value of the energy parameter during executing training is.

The special character B is set with the individual effect of increasing the hint occurrence rate and the event occurrence rate. The hint occurrence rate increase and the event occurrence rate increase are effects of increasing the occurrence rates of the hint event and the predetermined event that may occur each turn. Here, a correction value corresponding to the level of the special character is input to the arithmetic formula for determining whether each event occurs. At this time, the larger the input correction value is, the higher the occurrence rate of each event is.

The special character C is set with the individual effects of increasing the effect and occurrence rate of a support card event. Increasing the effect and occurrence rate of a support card event is effects of increasing the occurrence rate of a support event that may occur each turn and increasing the effect granted upon occurrence. Here, a correction value corresponding to the level of the special character is input to the arithmetic formula for determining whether a support event occurs. At this time, the larger the input correction value is, the higher the occurrence rate of a support event is.

Note that the contents of the passive effects illustrated in FIG. 30 are merely examples. For example, as the passive effect set for the special character, that is, the Goddess' Wisdom, only the common effects may be provided, or only the individual effects may be provided. In addition, in this example, the active effects and the passive effects are provided as the special effects. However, only one of the active effects and the passive effects may be provided as special effects. Alternatively, the player may be able to select a special effect to be activated from among a plurality of special effects.

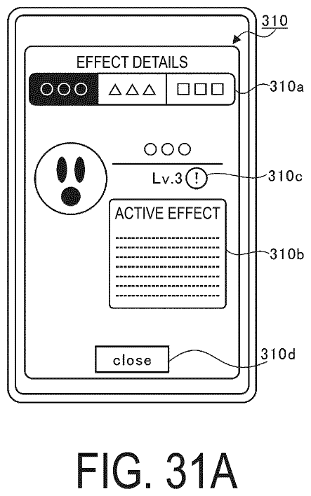

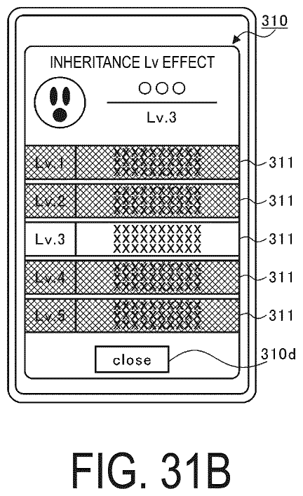

FIG. 31A is a first diagram for describing an effect details dialog 310. FIG. 31B is a second diagram for describing the effect details dialog 310. In the knowledge table dialog 300, when the special character display region 305 (see FIG. 27) is operated, the effect details dialog 310 is displayed. The effect details dialog 310 is provided with a switching tab 310a for switching the type of the special character. The switching tab 310a displays the names of the three special characters.

When a special character is selected in the switching tab 310a, a description of the active effects set for the selected special character is displayed in an effect description field 310b of the effect details dialog 310. In addition, an information icon 310c is provided in the effect details dialog 310. When the information icon 310c is operated, as illustrated in FIG. 31B, a level-based effect field 311 is displayed in the effect details dialog 310.

In the level-based effect field 311, descriptions of the passive effects corresponding to the respective inheritance levels from inheritance level 1 to inheritance level 5 are displayed. In the effect details dialog 310, the level-based effect field 311 corresponding to the inheritance level of the current special character are highlighted. Here, the level-based effect fields 311 corresponding to the inheritance level other than the inheritance level of the current special character are grayed out. The effect details dialog 310 is provided with a close operation portion 310d. When the close operation portion 310d is operated, the knowledge table dialog 300 is displayed on the display 26.

The effect details dialog 310 allows the player to easily comprehend the special effects from the Goddess' Wisdom. This improves the user-friendliness for the player. As illustrated in FIG. 27, a history icon 300d is provided in the knowledge table dialog 300. When the history icon 300d is operated, a history dialog 315 is displayed.

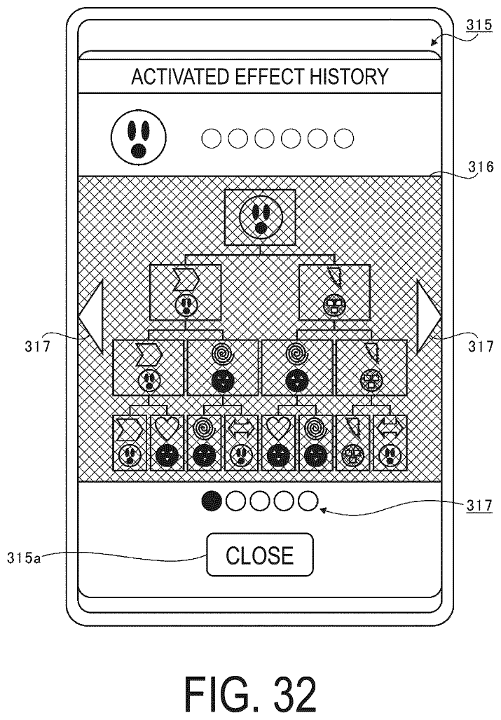

FIG. 32 is a diagram for describing the history dialog 315. The history dialog 315 displays a knowledge table corresponding to the Goddess' Wisdom acquired so far. For example, in the nurture main game, when the player has acquired the Goddess' Wisdom five times, this means that the knowledge table has been reset five times. The history dialog 315 displays a previous knowledge table 316 listing the process until the generation of the Goddess' Wisdom and the reset fragment items.

Here, as indicated by cross-hatching in the figure, the previous knowledge table 316 is grayed out. By displaying the previous knowledge table 316 in a grayed-out manner, the possibility that the player misrecognizes the previous knowledge table 316 as the current knowledge table is reduced. When there are a plurality of previous knowledge tables 316, switching operation portions 317 are provided on the left, right, and lower side of the previous knowledge table 316. The player can change the previous knowledge table 316 displayed in the history dialog 315 by operating the switching operation portions 317.

The Goddess' Wisdom generated in the previous knowledge table 316 currently displayed in the history dialog 315 is displayed in an identifiable manner above the previous knowledge table 316. A close operation portion 315a is provided below the history dialog 315. When the close operation portion 315a is operated, the history dialog 315 is closed and the knowledge table dialog 300 is displayed. In this manner, the history dialog 315 allows the player to check the effects that were activated previously, thereby improving the user-friendliness for the player.

As described above, according to the present embodiment, a fragment item associated with a selection item is obtained by a player selection. Then, the type of the Goddess' Wisdom, that is, the content of the special effect, is determined according to the obtained fragment item. The player can discretionarily select the timing of acquire the Goddess' Wisdom, that is, the timing of activating the special effect. This increases the strategic performance required of the player, increases interest in the game, and increases the motivation of the player to play the game.

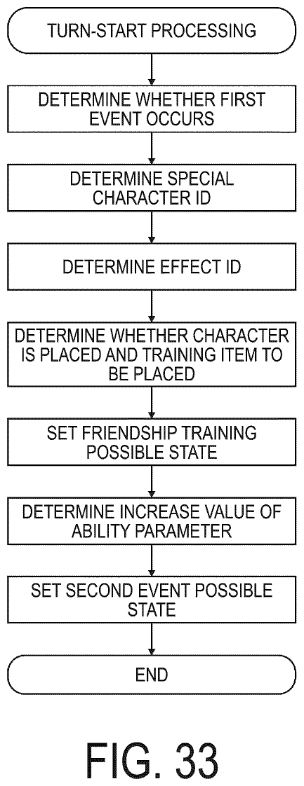

FIG. 33 is a diagram for describing a rough flow of turn-start processing. The nurture stage processing includes the turn-start processing executed at the start of each turn of the nurture game. Although the details of the turn-start processing will be described below, a rough flow of the turn-start processing will be described here.

During the nurture main game, processing of determining whether to cause various events to appear is executed in each turn. Events are roughly classified into three types: a scenario event, the above-described exclusive event provided for each nurture target character, and a support event. In each scenario, a scenario event, an exclusive event, and a support event that may appear in the nurture main game are predetermined.

A scenario event is an event set for each scenario of the nurture main game. In the present embodiment, a plurality of scenarios are provided, and the player can select a scenario. A scenario event appears for each scenario selected by the player. In other words, the scenario event that appears in the nurture main game is determined based on the scenario selected by the player.

The scenario event may include a scenario-specific event and a scenario-shared event. A scenario-specific event is an event associated with only one scenario. For example, a scenario-specific event associated with a first scenario appears only when the first scenario is selected and does not appear when another scenario is selected.

A scenario-shared event is an event that appears in common across a plurality of scenarios. Thus, the scenario-shared event appears in both cases when the first scenario is selected and when the second scenario is selected.

In this example, scenario-specific events and scenario-shared events are provided as scenario events. However, only one of the scenario-specific events and the scenario-shared events may be provided.

As described above, an exclusive event is an event set in advance for each character. In the nurture main game, an exclusive event for a character registered as a nurture target character by the player in the setting game, that is, the preparation stage processing, appears.

As described above, the support event is an event set in advance for each support card. In the nurture main game, a support event associated with the support card registered by the player in the setting game appears. The support event includes a first event that may occur at the start of a turn and a second event that may occur after training is performed. At the start of a turn, whether the first event occurs is determined based on a random number obtained at random and a first event table.

Whether the second event occurs is determined based on a randomly obtained random number and a second event table after the determination processing for each support character placed in the training is executed. Note that whether the second event occurs is determined for the placed support character only in a case where a support character is placed in training.

In the present embodiment, the first event may be selected by a support event associated with the support card selected through a lottery from among all of the support cards implemented into the game and is not limited to a support card registered in the deck by the player in the preparation stage processing. However, the selection probability of the support event associated with the support card registered in the deck is higher than the selection probability of the support card events associated with the support cards not registered in the deck.

As described above, whether a scenario event appears is determined based on the scenario. Also, whether an exclusive event and a support event appear is determined based on the nurture target character and the support card, respectively. These event types are classified by information that is referenced when whether an event appears is determined.

On the other hand, in the present embodiment, each event is classified into one of six event classifications according to the content brought about by the appearance of the event. Here, each event is classified into one of the event classifications including a first hint event, a second hint event, a first ability event, a second ability event, an aptitude event, and a story event.

As described above, the first hint event and the second hint event are events that make it possible to possess or obtain a skill. The first ability event and the second ability event are events for increasing or decreasing the ability parameter of the nurture target character. The aptitude event is an event for increasing or decreasing the aptitude parameter of the nurture target character. The story event is an event for displaying a story related to a character appearing in the nurture game. Note that story events may change an ability parameter or an aptitude parameter in addition to a story being displayed.

Here, the scenario event includes a first hint event, a second hint event, a first ability event, a second ability event, an aptitude event, and a story event. The exclusive event and the support event include a first hint event, a second hint event, a first ability event, and a second ability event. Note that the exclusive event may include a story event.

In the present embodiment, the turn-start processing includes processing of determining a scenario event and processing of determining an exclusive event. The processing of determining a scenario event and the processing of determining an exclusive event are not illustrated and described here. The turn-start processing includes “processing of determining whether a first event occurs”, “processing of determining a special character ID”, “processing of determining an effect ID”, “processing of determining whether a character is placed and the training item to be placed”, “processing of setting a friendship training possible state”, “processing of determining an increase value of an ability parameter”, and “processing of setting a second event possible state as illustrated in FIG. 33. Although various other processing is executed in the turn-start processing, the processing illustrated in FIG. 33 will be sequentially described here.

### Processing of Determining Whether First Event Occurs

In the processing of determining whether the first event occurs, the first event to be caused to occur is determined through a lottery from among the support events associated with all of the support cards provided by the administrator. At this time, the success probability of a support event associated a support card registered in the deck by the player in the preparation stage processing is set to a high value.

### Processing of Determining a Special Character ID

As described above, at the start of the turn, any one of the six types of fragment items is arranged in each of the total of eight selection items including rest, going out, race, and the five training items. Here, for each selection item, first, one of three types of special characters, that is, special character IDs, is determined through a lottery.

Here, in one turn, all of the three special characters are always arranged in at least one selection item. For example, after the special characters to be arranged in the eight selection items are determined, it is confirmed whether all of the three special characters are arranged in any one of the selection items. At this time, if all of the three special characters are not arranged, processing of forcibly changing any of the selection items to a special character that is not arranged may be executed. Alternatively, the lottery for the fragment item may be repeated for all of the eight selection items until all of the three special characters are arranged.

### Processing of Determining Effect ID

When the special character ID is determined, next, the effect ID is determined based on the special character ID. Here, one of the two types of effect IDs associated with the special character ID is determined through a lottery (see FIG. 24A). Thus, the fragment items specified by the special character ID and the effect ID are arranged for the eight selection items. Note that here, an effect ID that can be determined is predetermined for each special character ID. However, the effect ID may be determined independently of the special character ID.

### Processing of Determining Whether Character is Placed and Training Item to be Placed

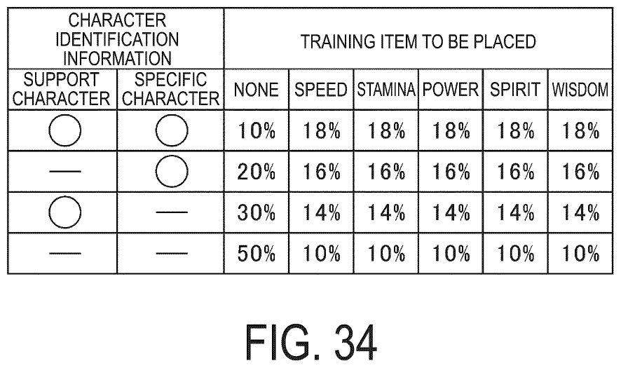

FIG. 34 is a diagram for describing the placing percentage for the training items. A placement determination table is stored in the player terminal 1 and the server 1000, and a training item in which a character is placed is determined based on the placement determination table. In the present embodiment, training items are determined for all support characters and story characters based on the character identification information.

Here, the placement determination table is provided for each piece of character identification information, and the placing percentage for each training item is different for each placement determination table. Specifically, according to the placement determination table for the support characters and the specific characters, the determination that the character is not placed in any training (“None” in the diagram) is set to 10%, and the determination that the character is placed in the training items of speed, stamina, power, spirit, and wisdom (“Speed”, “Stamina”, “Power”, “Spirit”, and “Wisdom” in the diagram) is set to 18%. The placement determination table for the support characters and the specific characters is used when the target character whose placement is to be determined is set as a support character and is set as a specific character.

Also, according to the placement determination table for the specific characters, the determination that the character is not placed in any training is set to 20%, and the determination that the character is placed in the training items of speed, stamina, power, spirit, and wisdom is set to 16%. The placement determination table for the specific characters is used when the target character is not set as a support character and is set as a specific character.

Also, according to the placement determination table for the support characters, the determination that the character is not placed in any training is set to 30%, and the determination that the character is placed in the training items of speed, stamina, power, spirit, and wisdom is set to 14%. The placement determination table for the support characters is used when the target character is set as a support character and is not set as a specific character.

Also, according to the placement determination table for other characters, the determination that the character is not placed in any training is set to 50%, and the determination that the character is placed in the training items of speed, stamina, power, spirit, and wisdom is set to 10%. The placement determination table for other characters is used when the target character is neither set as a support character nor a specific character. Note that the placement determination table for other characters may be used when the target character is a story character, for example.

Note that as described above, favored training is set for the support cards (support characters). When the target character is a support character, based on the placement determination table illustrated in FIG. 34, a change may be made so that the selection probability of the favored training set for the support card is increased. In addition, for example, an effect of increasing the placement probability for a predetermined training item may be associated with some or all of the support cards (support characters). For a support character associated with such an effect, changes are made to increase the placement probability in the predetermined training item.

Note that each training item is provided with an upper limit number for character placement. Here, “5” is set as the upper limit number for character placement for all of the training items. Thus, the number of placed characters placed in one training item is “5” at the maximum.

As described above, the training item to be associated with the character is determined for each character. At this time, the order of characters for determining a training item may be any order. Then, for example, in a case where placement of the upper limit number of placed characters has already been determined for a training item for which placement of a character has been determined, it may be determined that the character is not placed in any training item. Alternatively, the training item whose placement upper limit number has already been reached may be excluded from the lottery, and the placement probability of the other training items may be changed.

However, the placement upper limit number is not essential, and the placed character may be placed in the training item according to the lottery result. In addition, a method of determining a training item in which a character is placed is not particularly limited.

When the placed character is determined as described above, the placed character is associated with the training item. Then, the placement information in which the training item and the placed character are associated with each other is stored in the player terminal 1 and the server 1000.

### Processing of Setting Friendship Training Possible State

Referring back to FIG. 33, when the placement information is determined as described above, the friendship training possible state setting is performed. Specifically, a support character is extracted from the characters placed in the training item. Then, it is determined whether the setting condition for the friendship training possible state is satisfied for the extracted support character. As described above, here, the setting conditions for the friendship training possible state are that the training item in which the support character is placed is the favored training and that the bond parameter associated with the support character is equal to or greater than the predetermined value.

Then, the friendship training possible information is associated with the support character that satisfies the setting conditions for the friendship training possible state. Also, the friendship training possible information is associated with the training item in which the support character satisfying the setting conditions for the friendship training possible state is placed. Thus, the friendship training possible state is set.

### Processing of Determining Increase Value of Ability Parameter

In a turn in which training can be executed, an increase value of the ability parameter at the time of training success is determined for each training item.

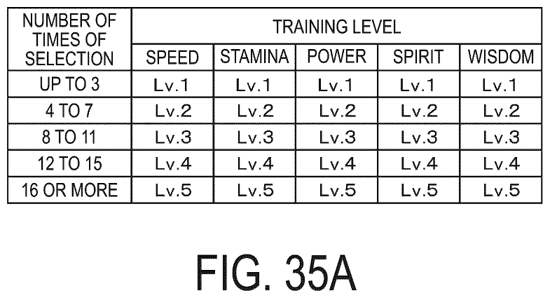

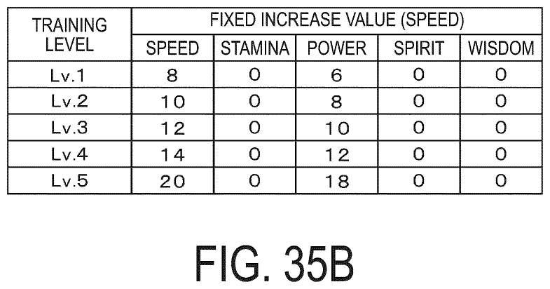

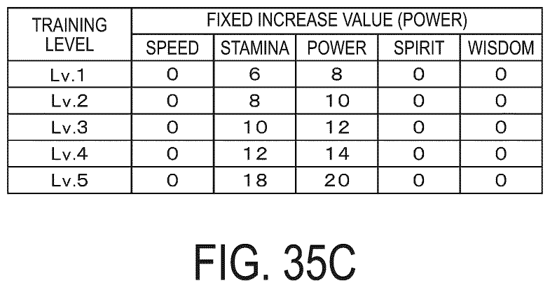

FIG. 35A is a diagram for describing a training level table. As illustrated in FIG. 35A, the training level is set to increase in accordance with the number of times each training is selected. Specifically, when the number of times each training is selected is 3 or less, each training level related to speed, stamina, power, spirit, and wisdom is set to “level 1”; when the number of times each training is selected is in a range from 4 to 7, each training level is set to “level 2”; when the number of times each training is selected is in a range from 8 to 11, each training level is set to “level 3”; when the number of times each training is selected is in a range from 12 to 15, each training level is set to “level 4”; and when the number of times each training is selected is 16 or more, each training level is set to “level 5”.

Here, a case where the training level increases in accordance with the number of times of selection of training has been described. However, the condition for increasing the training level is not limited thereto. For example, the training level may be increased or decreased by a lottery. Alternatively, the training level may be changed according to the turn number. Note that the training level is not essential.

In the present embodiment, when the training selected by the player has been performed and has been successful, the value of a predetermined ability parameter is increased by the performed training item.

Specifically, in the present embodiment, when speed training is performed and it is successful, the values of the ability parameters for speed and power are increased.

In addition, when stamina training is performed and the training is successful, the values of the ability parameters for stamina and spirit are increased.

In addition, when power training is performed and the training is successful, the values of the ability parameters for stamina and power are increased.

In addition, when spirit training is performed and the training is successful, the values of the ability parameters for speed, power, and spirit are increased.

In addition, when wisdom training is performed and the training is successful, the values of the ability parameters for speed and wisdom are increased.

In the present embodiment, the value of the ability parameter to be increased when the training is successful is calculated by adding a value obtained by adding a fixed increase value determined corresponding to the performed training item and training level to a bonus additional value to be described below to the fixed increase value.

FIG. 35B is a diagram for describing a fixed increase value (speed) table. FIG. 35C is a diagram for describing a fixed increase value (power) table. That is, FIG. 35B indicates the fixed increase value when the training item is speed. Also, FIG. 35C indicates the fixed increase value when the training item is power.

As illustrated in FIGS. 35B and 35C, the fixed increase value table stores fixed increase values determined corresponding to the performed training item and the training level. Further, in the present embodiment, as illustrated in FIGS. 35B and 35C, the ability parameter is set to increase more as the training level is higher.

Although description is omitted here, fixed increase value tables in a case where stamina, spirit, and wisdom are selected as the training item are also provided.

In the present embodiment, a large number of additional conditions for the ability parameters are provided. An example of the additional conditions includes that the specific character or the support character is placed in the training item. In this case, a predetermined additional value is added to the fixed increase value. Further, for example, a growth rate may be set in advance for each training item for each nurture target character. In this case, the fixed increase value is multiplied by the growth rate for each training item.

Here, the effects of the knowledge fragments, the first crystals, and the second crystals and the special effect of the Goddess' Wisdom are included in the additional condition.

As described above, when the additional condition is satisfied, the additional value is added to the fixed increase value or the fixed increase value is multiplied by a predetermined addition rate. Then, the calculated value is finally multiplied by the friendship bonus addition rate. The friendship bonus addition rate is used when a friendship bonus possible state is set for the training item. In addition, the friendship bonus addition rate is calculated for each placed character placed in the training item.

In this example, the friendship bonus addition rate is 20%, and three placed characters for which the friendship bonus possible state is set are placed in the same training item. In this case, the friendship bonus addition rate is 60%. In this manner, the increase value of the ability parameter increases by being multiplied by the friendship bonus addition rate.

### Processing of Setting Second Event Possible State

Referring back to FIG. 33, a state in which a second event can occur is set for a support character placed in any of the training items. A second event is selected through a lottery from among the support events (second events) associated with the support characters (support cards) placed in the respective training items.

In the present embodiment, processing is executed to determine whether to set a second event possible state for all of the support characters placed in the training items. When the player selects the training in which the support character for which the second event possible state is set is placed, the second event occurs after the training is performed.

Note that the second event possible state may be set for each of a plurality of support characters placed in one training item. In this case, when the training is executed, only one of the second events for which the possible state is set may be executed. In addition, all the second events for which the possible state is set may be executed.

As described above, in the nurture main game, ability parameters of the nurture target character can be increased as the player progresses through the turns. The ability parameters increase with the success of training or the occurrence of various events. In the nurture main game, when all the turns are finished, the nurture game ends. If the goal set for each character is not achieved during the nurture main game, the nurture game ends at this point.

Here, when the nurture game ends, the nurture target character nurtured in the nurture game is stored as a nurtured character. More strictly, the information relating to the nurtured character nurtured in the nurture game (hereinafter referred to as nurtured character information) is stored in association with the player ID. The nurtured character information is stored in both the player terminal 1 and the server 1000. The nurtured character information stored in association with the player ID includes an ability parameter, an aptitude parameter, an obtained skill, inheritance information, and the like.

When the nurture game ends, the evaluation score of the nurtured character is calculated. Here, the evaluation score is calculated based on the ability parameters, the aptitude parameters, the obtained skills, race results, team race results, and the like at the end of the nurture game. Note that the method of calculating the evaluation score, in other words, a calculation formula for calculating the evaluation score, is prepared in advance, and the evaluation score is calculated based on a predetermined calculation formula. The calculation method and the calculation formula for the evaluation score are not particularly limited. For example, the evaluation score may be calculated based only on a parameter that affects a race result when a nurtured character has run in a race in a team competition game or another game, such as an ability parameter, an aptitude parameter, an obtained skill, or the like at the end of the nurture game.

A nurture rank is set for the nurtured character, based on the evaluation score. The nurture rank is an indicator of the strength of the nurtured character, and a range of evaluation score is associated with each nurture rank. For example, a nurture rank of “A+” is given to a nurtured character having an evaluation score ranging from 13000 to 14499, and a nurture rank of “S” is given to a nurtured character having an evaluation score ranging from 14500 to 15499. In this manner, by giving the nurture rank based on the evaluation score, the approximate strength of the nurtured character is made easy to understand. The nurtured character information includes the evaluation score and the nurture rank.

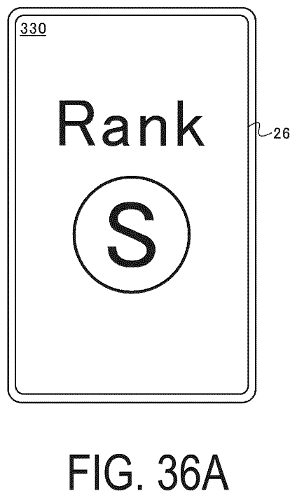

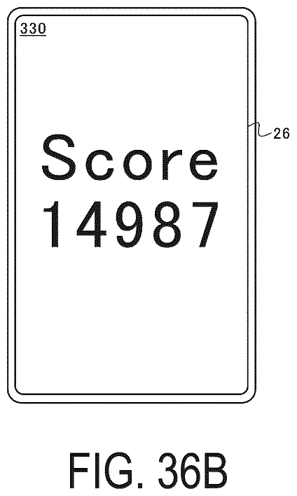

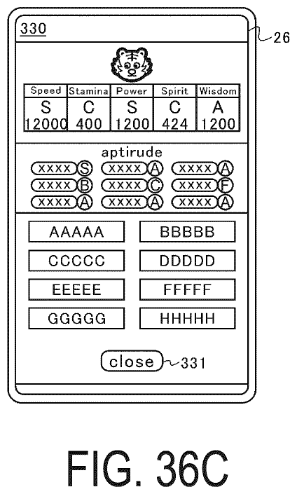

FIG. 36A is a first diagram for describing a nurture completion screen 330. FIG. 36B is a second diagram for describing the nurture completion screen 330. FIG. 36C is a third diagram for describing the nurture completion screen 330. When the nurture game ends, the nurture completion screen 330 is displayed on the display 26 as illustrated in FIG. 36A. On the nurture completion screen 330, the nurture rank of the nurtured character is first displayed, and thereafter, the evaluation score is displayed as illustrated in FIG. 36B.

When a predetermined amount of time elapses after the evaluation score is displayed, the ability parameter, the aptitude parameter, and the obtained skill of the nurtured character are displayed on the nurture completion screen 330 as illustrated in FIG. 36C. At this time, a close operation portion 331 is provided on the nurture completion screen 330. When the close operation portion 331 is tapped, the nurture completion screen 330 is hidden, and the home screen 100 is displayed on the display 26.

When the nurture game ends, a lottery for a factor to be obtained by the nurtured character is performed, and factor information is stored in association with the nurtured character. Although not illustrated, the player can display the factor information obtained by the nurtured character on the nurture completion screen 330. The lottery for a factor is executed according to preset conditions for each factor type. The factor obtaining probability and the like are set based on the result of the nurture game.

Next, the functional configuration of the player terminal 1 and the server 1000 for executing the above-described nurture game will be described.

### Functional Configuration of Player Terminal 1

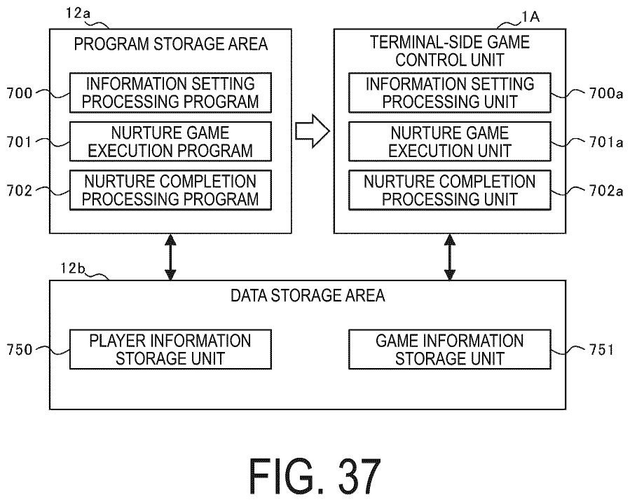

FIG. 37 is a diagram for describing a configuration of the memory 12 in the player terminal 1 and a function as a computer. The memory 12 is provided with a program storage area 12a and a data storage area 12b. When the game is started, the CPU 10 stores a terminal-side game control program (module) in the program storage area 12a.

The terminal-side game control program includes an information setting processing program 700, a nurture game execution program 701, and a nurture completion processing program 702. Note that the programs listed in FIG. 37 are examples, and many other programs are provided in the terminal-side game control program.

In the data storage area 12b, a player information storage unit 750 and a game information storage unit 751 are provided as storage units that store data. Note that the data storage area 12b is provided with a large number of other storage units. Here, information directly related to a game such as a nurture game (hereinafter referred to as game information) is stored in the game information storage unit 751. Note that various types of information during the progress of each game such as the nurture game are also temporarily stored in the game information storage unit 751. Thus, all information related to the nurtured character nurtured in the nurture game is stored in the game information storage unit 751. In addition, for example, all information other than the game information, such as information related to the player or another player, setting information on the player terminal 1, and the like, is set as player information. The player information is stored in the player information storage unit 750.

The CPU 10 operates each program stored in the program storage area 12a and updates the data in each storage unit of the data storage area 12b. Then, the CPU 10 causes the player terminal 1 (computer) to function as a terminal-side game control unit 1A by running each program stored in the program storage area 12a. The terminal-side game control unit 1A includes an information setting processing unit 700a, a nurture game execution unit 701a, and a nurture completion processing unit 702a.

To be specific, the CPU 10 runs the information setting processing program 700 to cause the computer to function as the information setting processing unit 700a. Similarly, the CPU 10 runs the nurture game execution program 701 and the nurture completion processing program 702 to cause the computer to function as the nurture game execution unit 701a and the nurture completion processing unit 702a.

When various types of information are set in the player terminal 1, the information setting processing unit 700a stores information related to the setting in the player information storage unit 750 as player information. When the information in the player information storage unit 750 is updated, the information setting processing unit 700a transmits the update information to the server 1000.

The nurture game execution unit 701a executes all processing related to the nurture game. To be specific, the nurture game execution unit 701a executes the preparation stage processing and the nurture stage processing.

The nurture completion processing unit 702a stores nurtured character information including the ability parameter, the aptitude parameter, the obtained skill, the inheritance information, the factor information, the type of the character used for nurturing, and the like of the nurtured character at the time of completion of the nurture game.

### Functional Configuration of Server 1000

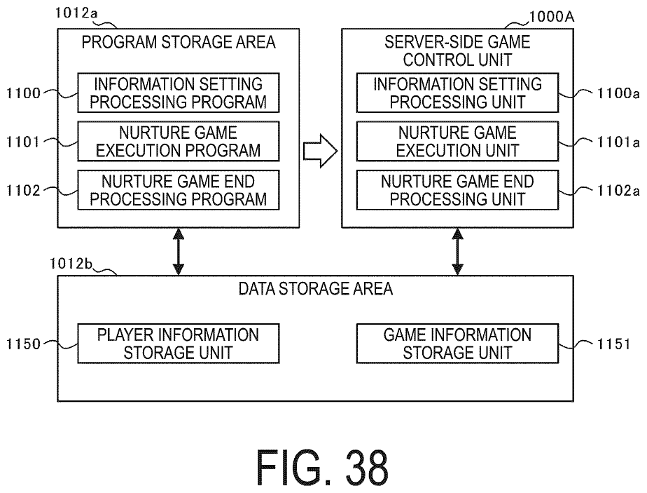

FIG. 38 is a diagram for describing the configuration of the memory 1012 in the server 1000 and the function as a computer. The memory 1012 is provided with a program storage area 1012a and a data storage area 1012b. When the game is started, the CPU 1010 stores a server-side game control program (module) in the program storage area 1012a.

The server-side game control program includes an information setting processing program 1100, a nurture game execution program 1101, and a nurture game end processing program 1102. Note that the programs listed in FIG. 38 are examples, and many other programs are provided in the server-side game control program.

In the data storage area 1012b, a player information storage unit 1150 and a game information storage unit 1151 are provided as storage units that store data. Note that the data storage area 1012b is provided with a large number of other storage units. Here, the game information of all the players is stored in the game information storage unit 1151 in association with the player ID. The player information of all the players is stored in the player information storage unit 1150 in association with the player ID.

The CPU 1010 operates each program stored in the program storage area 1012a and updates the data in each storage unit of the data storage area 1012b. Then, the CPU 1010 causes the server 1000 (computer) to function as a server-side game control unit 1000A by running each program stored in the program storage area 1012a. The server-side game control unit 1000A includes an information setting processing unit 1100a, a nurture game execution unit 1101a, and a nurture game end processing unit 1102a.

To be specific, the CPU 1010 runs the information setting processing program 1100 to cause the computer to function as the information setting processing unit 1100a. Similarly, the CPU 1010 runs the nurture game execution program 1101 and the nurture game end processing program 1102 to cause the computer to function as the nurture game execution unit 1101a and the nurture game end processing unit 1102a.

When various types of information are set in the player terminal 1, the information setting processing unit 1100a updates the player information in the player information storage unit 1150, based on the update information received from the player terminal 1. In addition, the information setting processing unit 1100a measures time and updates the game points of each player.

The nurture game execution unit 1101a executes all processing related to the nurture game.

When the nurture game ends, the nurture game end processing unit 1102a derives the evaluation score, nurture rank, and the like for the nurtured character. In addition, the nurture game end processing unit 1102a determines the factor to be obtained by the nurtured character through a lottery. The game information storage unit 1151 stores nurtured character information including the ability parameter, the aptitude parameter, the obtained skill, the inheritance information, the factor information, the type of the character used for nurturing, and the like of the nurtured character associated with the player ID.

Note that the information setting processing unit 700a in the player terminal 1 and the information setting processing unit 1100a in the server 1000 are the same in that both store player information, but are different from each other in the specific content of processing and the range of stored player information. In addition, the nurture game execution unit 701a in the player terminal 1 and the nurture game execution unit 1101a in the server 1000 are the same in that they execute processing related to the nurture game, but they have different roles, that is, different ranges of responsibility.

Processing performed by each functional unit in the player terminal 1 and the server 1000 will be described below with reference to a flowchart.

### Processing of Player Terminal 1 and Server 1000 Processing Related to Nurture Game

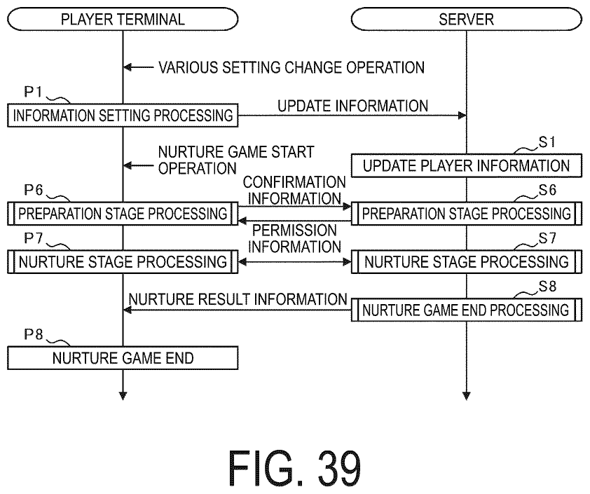

FIG. 39 is a sequence diagram for describing processing of the player terminal 1 and the server 1000 related to the nurture game. In the following description, the processing in the player terminal 1 is denoted by Pn (n is an arbitrary integer). Processing in the server 1000 is denoted by Sn (n is an arbitrary integer).

When the player performs various setting change operations on the player terminal 1, the information setting processing unit 700a of the player terminal 1 performs information setting processing of updating the player information storage unit 750, based on the operation input of the player (P1). In this information setting processing, the update information is transmitted to the server 1000. In the server 1000, when the update information is received, the information setting processing unit 1100a updates the player information of the player information storage unit 1150 (S1).

The player information updated in P1 and S1 includes, for example, profile information that can be set by the player. In addition, for example, when an operation of adding another player as a friend or an operation of removing a friend is input as a setting change operation, friend information that is information related to friends is updated. In P1 and S1, each of the information setting processing unit 700a and the information setting processing unit 1100a manages the game points spent to execute the nurture game. When the game points are less than the upper limit value, the information setting processing units 700a and 1100a measure time and give a predetermined value of game points to the player at predetermined time intervals.

When a nurture game start operation for starting the nurture game is input to the player terminal 1, the nurture game execution unit 701a executes the preparation stage processing (P6). Further, during the preparation stage processing, communication processing is executed between the player terminal 1 and the server 1000. In the server 1000, the nurture game execution unit 1101a executes the preparation stage processing, based on the information received from the player terminal 1 (S6).

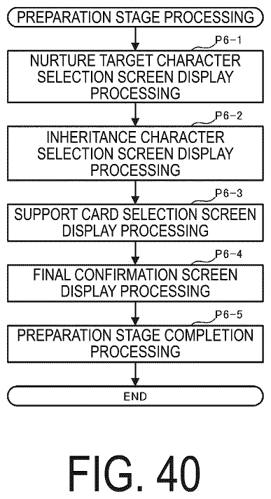

FIG. 40 is a flowchart for describing the preparation stage processing (P6) in the player terminal 1. The nurture game execution unit 701a of the player terminal 1 executes nurture target character selection screen display processing (P6-1). Here, the nurture game execution unit 701a displays the nurture target character selection screen 150 and temporarily registers, based on the operation input of the player, the nurture target character.

Specifically, the nurture game execution unit 701a switches the display screen of the display 26 when a display switching operation for switching the screen display is input by the player. When a press and hold operation of the character icon 151 on the nurture target character selection screen 150 is input, the character detail screen 160 is displayed by the nurture game execution unit 701a. When the strengthening operation portion 163b is operated on the character detail screen 160, the character strengthening screen 165 is displayed. When a selection operation (operation of the character icon 151) is input on the nurture target character selection screen 150, the nurture game execution unit 701a temporarily stores the character corresponding to the character icon 151 selected via input and switches the display screen.

When a confirmation operation (operation of the next operation portion 154) is input on the nurture target character selection screen 150, the nurture game execution unit 701a temporarily registers the temporarily stored character as the nurture target character. In addition, the nurture game execution unit 701a obtains, from the server 1000, information related to a representative character extracted in accordance with a predetermined extraction condition, such as a representative character of a friend, and displays the inheritance character selection screen 170.

Next, the nurture game execution unit 701a executes inheritance character selection screen display processing (P6-2). Here, the nurture game execution unit 701a switches the display screen of the display 26 when a display switching operation is input. When a selection operation (operation of the nurtured character icon 182) is input on the nurtured character list screen 180, the nurture game execution unit 701a temporarily stores the character corresponding to the nurtured character icon 182 operated for selection as the inheritance character and switches the display screen.

In addition, when a confirmation operation (operation of the next operation portion 154) is input on the inheritance character selection screen 170, the nurture game execution unit 701a displays the support card organization screen 190 on the display 26.

Next, the nurture game execution unit 701a executes support card selection screen display processing (P6-3). Here, when a selection operation (operation of the card icon 201 of the support card) is input, the nurture game execution unit 701a temporarily stores the support card corresponding to the card icon 201 operated for selection and switches the display screen.

When a display switching operation for switching the display of the screen is input while the support card organization screen 190 is being displayed, the nurture game execution unit 701a switches the display screen of the display 26. When a confirmation operation (operation of the start operation portion 193) is input, the nurture game execution unit 701a displays a final confirmation screen 205 on the display 26.

Next, the nurture game execution unit 701a executes final confirmation screen display processing (P6-4). Here, the nurture game execution unit 701a switches the display screen of the display 26 when a display switching operation for switching the screen display is input.

When a selection operation (operation of the select operation portion 206c) is input on the preset selection screen 205A, the nurture game execution unit 701a temporarily stores reservation selection information corresponding to the preset operated for selection and switches the display screen.

When a confirmation operation (operation of the start operation portion 205b) is input on the final confirmation screen 205, the nurture game execution unit 701a executes preparation stage completion processing (P6-5). Here, the nurture game execution unit 701a determines whether the game points are equal to or greater than a predetermined value (for example, 30) and, if the game points are equal to or greater than the predetermined value, transmits the confirmation information to the server 1000.

Note that the confirmation information includes information for identifying the nurture target character, the inheritance character, and the support card that are temporarily registered. When the confirmation information is received, the preparation stage processing (S6) is executed in the server 1000. Although details will be described later, in the server 1000, it is determined whether to permit execution of the nurture main game using the nurture target character, the inheritance character, and the support card which are temporarily registered.

When permission information is received from the server 1000 after the confirmation information is transmitted, the nurture game execution unit 701a registers the temporarily registered nurture target character. In addition, the nurture game execution unit 701a registers the nurtured character temporarily stored as the inheritance character and the temporarily stored support card in the deck.

Further, the nurture game execution unit 701a registers the character ID of the character set as the specific character, based on the specific character information. The nurture game execution unit 701a also sets initial character identification information. The nurture game execution unit 701a also registers the reservation selection information on the temporarily stored preset. Accordingly, the preparation stage completion processing ends, and the nurture main game starts.

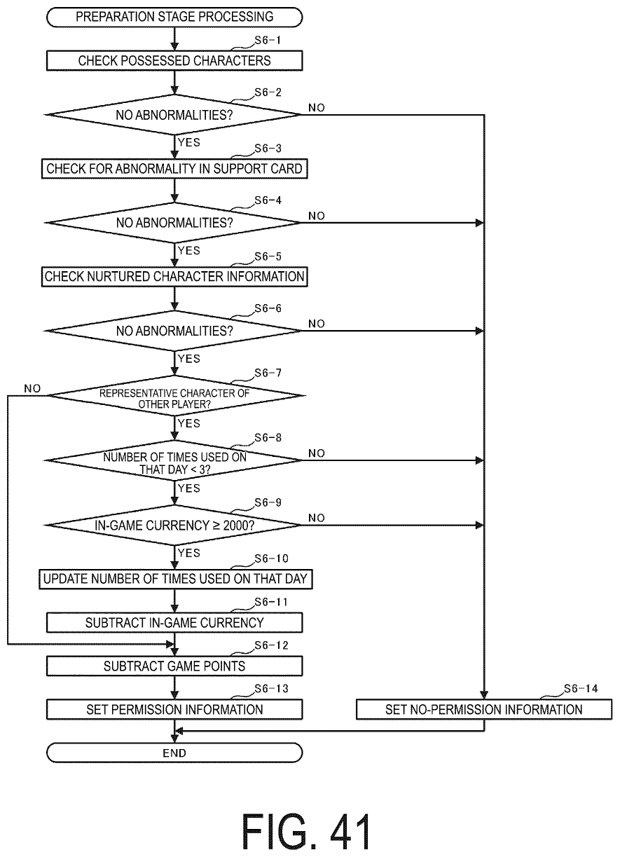

FIG. 41 is a flowchart for describing the preparation stage processing (S6) in the server 1000. When receiving the confirmation information, the nurture game execution unit 1101a confirms the possessed characters of the player stored in the player information storage unit 1150 (S6-1). If the nurture target character selected by the player is included in the possessed characters, the nurture game execution unit 1101a determines that there is no abnormality (S6-2).

If there is no abnormality in the nurture target character selected by the player (YES in S6-2), the nurture game execution unit 1101a checks whether there is an abnormality in the support card selected by the player (S6-3). In S6-3, it is determined that there is an abnormality when a support card not possessed by the player is selected, when the rental card selected by the player is not associated with the player ID of the player, when the support character overlaps with the nurture target character, or the like.

If there is no abnormality in the support card selected by the player (YES in S6-4), the nurture game execution unit 1101a checks the nurtured character information stored in the game information storage unit 1151 (S6-5). When the nurtured character selected by the player as the inheritance character is associated with the player ID of the player, that is, when the nurtured character nurtured by the player is selected as the inheritance character, the nurture game execution unit 1101a determines that there is no abnormality in the inheritance character (YES in S6-6).

When it is determined that there is no abnormality in the inheritance character, the nurture game execution unit 1101a determines whether a representative character of another player is included in the nurtured characters selected as the inheritance character by the player (S6-7). When a representative character of another player is included (YES in S6-7), the nurture game execution unit 1101a determines whether the number of uses on the day is less than three (S6-8).

When the number of uses on the day is less than three (YES in S6-8), the nurture game execution unit 1101a determines whether the predetermined in-game currency possessed by the player is 2000 or greater (S6-9). That is, in S6-8 and S6-9, it is determined whether the forming condition is satisfied. When the player possesses 2000 or greater in-game currency (YES in S6-9), the nurture game execution unit 1101a adds “1” to the number of times used on that day (S6-10). In addition, the nurture game execution unit 1101a subtracts 2000 from the amount of possessed predetermined in-game currency stored in the player information storage unit 1150 (S6-11).

Further, the nurture game execution unit 1101a subtracts a predetermined value (for example, 30) from the game points of the player (S6-12). Then, in a case where there is no abnormality in the nurture target character, the inheritance character, and the support card and the forming condition for using the representative character of another player is satisfied, the nurture game execution unit 1101a sets permission information (S6-13) and causes the player terminal 1 to receive the permission information. On the other hand, in a case where there is an abnormality in the nurture target character, the inheritance character, or the support card or the forming condition for using the representative character of another player is not satisfied, the nurture game execution unit 1101a sets no-permission information (S6-14) and causes the player terminal 1 to receive the no-permission information. When the no-permission information is received, the final confirmation screen 205 is displayed on the player terminal 1, and a predetermined error is notified.

Referring back to FIG. 39, when the preparation stage processing (P6, S6) ends, in the player terminal 1, the nurture game execution unit 701a executes the nurture stage processing (P7). Further, during the nurture stage processing, communication processing is executed between the player terminal 1 and the server 1000. In the server 1000, the nurture game execution unit 1101a executes the nurture stage processing, based on the information received from the player terminal 1 (S7).

Hereinafter, the nurture stage processing (P7) executed in the player terminal 1 and the nurture stage processing (S7) executed in the server 1000 will be described. However, here, in order to facilitate understanding, the processing in the player terminal 1 and the processing in the server 1000 will be described by appropriately changing the order.

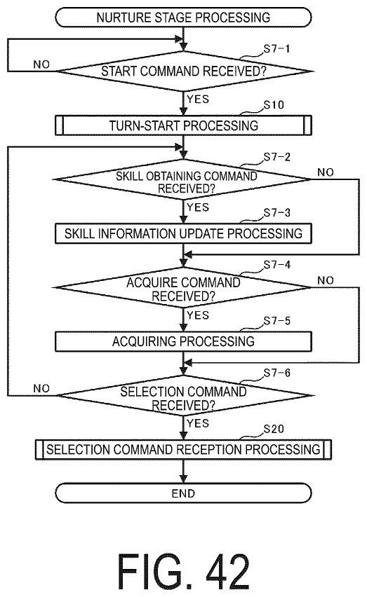

FIG. 42 is a flowchart for describing the nurture stage processing in the server 1000. The nurture game execution unit 1101a of the server 1000 waits for reception of a start command from the player terminal 1 (S7-1). When the start command is received (YES in S7-1), the nurture game execution unit 1101a executes the turn-start processing (S10). Note that the start command is transmitted from the player terminal 1 to the server 1000, for example, when processing or a performance related to the current turn is completed.

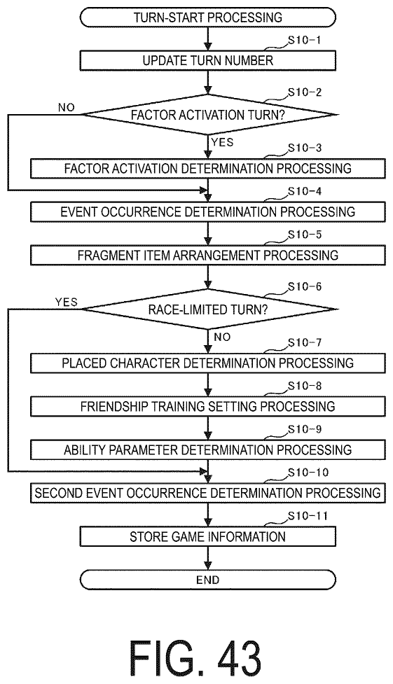

FIG. 43 is a flowchart for describing the turn-start processing in the server 1000. The nurture game execution unit 1101a of the server 1000 updates the current turn number (S10-1). If the current turn is a factor activation turn (YES in S10-2), the nurture game execution unit 1101a executes factor activation determination processing (S10-3). Here, whether to activate a factor is determined for each registered inheritance character.

Also, the nurture game execution unit 1101a executes event occurrence determination processing (S10-4). Here, the nurture game execution unit 1101a determines an event to be generated in the current turn for the scenario event, the exclusive event, the first event, or the like. Here, the event occurrence rate and the like are corrected based on the special effect of the Goddess' Wisdom that is currently activated.

The nurture game execution unit 1101a executes fragment item arrangement processing of arranging the fragment item in the selection item (S10-5). Here, in the case where the turn is a turn in which a fragment item can be arranged in a selection item and the number of knowledge fragments currently possessed is less than eight, the “processing of determining a special character ID” and the “processing of determining an effect ID” in FIG. 33 described above are executed. In this manner, the selection item is associated with the fragment item.

If the current turn is not a race-limited turn (NO in S10-6), the nurture game execution unit 1101a executes placed character determination processing (S10-7). Here, for each of the support character and specific character such as a story character, the nurture game execution unit 1101a determines whether to place and the training item to be placed in through a lottery based on the placement table (FIG. 34). At this time, when the training item to be placed is determined, the nurture game execution unit 1101a stores the character in association with the determined training item.

Next, the nurture game execution unit 1101a executes friendship training setting processing (S10-8). Here, the “Processing of setting the friendship training possible state” described using FIG. 33 is executed. That is, the nurture game execution unit 1101a extracts a support character placed in any one of the training items. Then, it is determined whether each setting condition for the friendship training possible state is satisfied for the extracted support character. The nurture game execution unit 1101a associates the friendship training occurrence information with the support character satisfying the setting condition of the friendship training possible state. Also, the friendship training possible information is associated with the training item in which the support character satisfying the setting conditions for the friendship training possible state is placed.

Here, when the friendship bonus is activated as the special effect, the friendship training possible information is associated regardless of the favored training of the support character arranged at the training item.

Next, the nurture game execution unit 1101a executes ability parameter determination processing (S10-9). Here, the “processing of determining the increase value of the ability parameter” described using FIG. 33 is executed. That is, the nurture game execution unit 1101a selects any one of the five training items as a processing target. The nurture game execution unit 1101a obtains the training level of the ability parameter that is the processing target and determines the fixed increase value.

In addition, the nurture game execution unit 1101a obtains the placement information on the placed character and determines the additional value. In addition, the nurture game execution unit 1101a determines whether other additional conditions such as the currently activated effects of the knowledge fragments, first crystals, and second crystals or the special effects of the Goddess' Wisdom are satisfied and determines the final increase value of the training item that is the processing target based on the satisfied additional condition. The determination of the final increase value for the ability parameter is executed for each training item.

Although a detailed description is omitted, in the ability parameter determination processing, an energy consumption amount or an energy recovery amount when each training item is executed is determined. The nurture game execution unit 1101a calculates a failure rate of training for each training item, based on the energy of the nurture target character. Here, the energy consumption amount, the energy recovery amount, and the training failure rate are corrected based on the currently activated effects of the knowledge fragments, the first crystals, and the second crystals or the special effect of the Goddess' Wisdom.

Next, the nurture game execution unit 1101a executes second event occurrence determination processing (S10-10). Here, the “Processing of setting the second event possible state” described using FIG. 33 is executed. In other words, the nurture game execution unit 1101a determines whether to execute a support event set in advance for the support card associated with the training item through a lottery. Here also, the support event occurrence rate and the like are corrected based on the special effect of the Goddess' Wisdom that is currently activated.

Then, the nurture game execution unit 1101a stores the information determined in the above processing as the game information received by the player terminal 1 (S10-11).

Referring back to FIG. 42, when an obtain skill command indicating obtainment of any base skill is received from the player terminal 1 after the turn-start processing has ended (YES in S7-2), skill information such as the skill obtainment information is updated by the nurture game execution unit 1101a (S7-3). Here, the obtainment information is associated with the obtained skill. Here, the nurture game execution unit 1101a subtracts the skill points required to obtain the skill from the currently possessed skill points. Here, the updated skill information is caused to be received by the player terminal 1 by the nurture game execution unit 1101a.

When an acquire command indicating acquirement of the Goddess' Wisdom is received from the player terminal 1 (YES in S7-4), the nurture game execution unit 1101a executes acquiring processing (S7-5). Here, the processing of updating the Goddess' Wisdom obtainment information, the processing of activating the special effects, the processing of setting the effective period (the number of turns) of the active effects of the special effects, the processing of resetting the possessed knowledge fragments, first crystals, second crystals, and the Goddess' Wisdom, the processing of resetting the knowledge table, and the processing of deactivating the active effect of the fragment item are executed. Further, the server 1000 waits until a selection command is received from the player terminal 1 (S7-4).

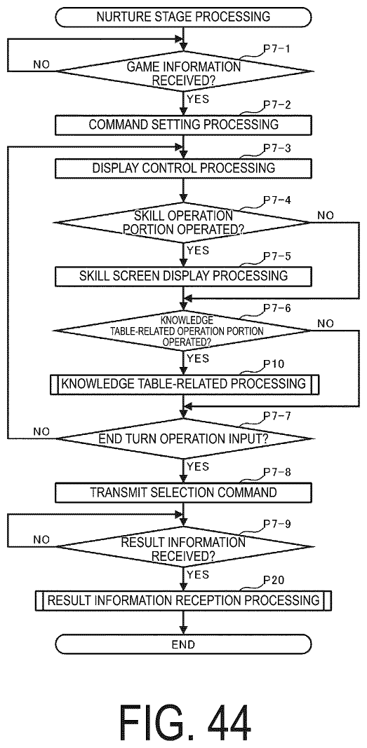

FIG. 44 is a flowchart for describing the nurture stage processing in the player terminal 1. The nurture game execution unit 701a of the player terminal 1 waits for reception of game information from the server 1000 (P7-1). Then, when the game information is received (YES in P7-1), the nurture game execution unit 701a executes command setting processing (P7-2). Here, processing of setting a command that can be selected by the player is executed based on the current turn number.

Further, the nurture game execution unit 701a executes display control processing of displaying a game screen, based on the received game information (P7-3). Here, the nurture game execution unit 701a displays the top screen 210, the training screen 220, and the like, based on the received game information. Specifically, the nurture game execution unit 701a displays the fragment items at the eight selection items on the top screen 210 and the training screen 220. Also, the nurture game execution unit 701a displays the placed character icon 228 for each training item on the training screen 220. The nurture game execution unit 701a performs display control of the stats display portion 213. Further, the nurture game execution unit 701a causes the operation portion corresponding to the training item set to the friendship training possible state and the training operation portion 215b of the top screen 210 to display an effect.

When the skill operation portion 215c is operated (YES in P7-4), the nurture game execution unit 701a executes skill screen display processing (P7-5) to display the skill screen 230. When the knowledge table-related operation portion associated with the knowledge table is operated (YES in P7-6), the nurture game execution unit 701a executes knowledge table-related processing (P10). The knowledge table-related operation portion includes, for example, the knowledge table check icon 217, the close operation portion 300a, the check effect operation portion 300b, the acquiring operation portion 300c, the history icon 300d, the special character display region 305, the information icon 310c, and the close operation portion 310d.

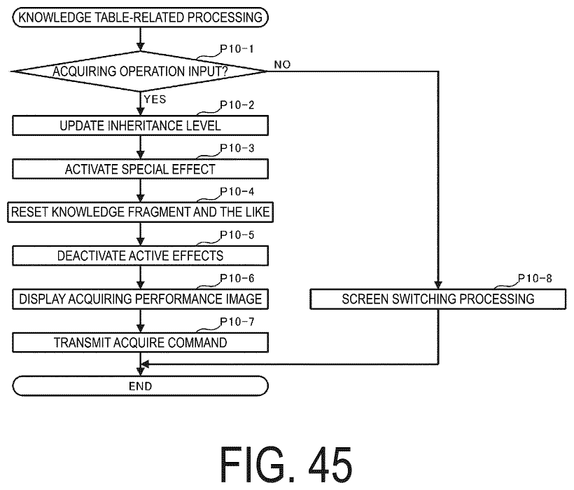

FIG. 45 is a flowchart for describing the knowledge table-related processing in the player terminal 1. When the acquiring operation to instruct acquirement of the Goddess' Wisdom is input (YES in P10-1), the nurture game execution unit 701a updates the inheritance level of the special character associated with the Goddess' Wisdom (P10-2). The nurture game execution unit 701a also activates the special effect. Here, the effective period (the number of turns) set for the active effect is set.

The nurture game execution unit 701a resets the knowledge fragments, the first crystals, the second crystals, and the Goddess' Wisdom (P10-4) and deactivates the active effects from the fragment items (P10-5). The nurture game execution unit 701a displays an acquiring performance image indicating acquiring of the Goddess' Wisdom (P10-6). The nurture game execution unit 701a transmits an acquire command to the server 1000 (P10-7). When an operation of the knowledge table-related operation portion other than the acquiring operation is input (NO in P10-1), the nurture game execution unit 701a switches the screen of the display 26.

Referring back to FIG. 44, the nurture game execution unit 701a switches the display screen of the display 26 based on the operation input by the player until the turn end operation is input (NO in P7-7). Here, the turn end operation is an operation of ending the current turn and includes an operation of the rest operation portion 215a, the infirmary operation portion 215d, the going out operation portion 215e, the speed operation portion 221, the stamina operation portion 222, the power operation portion 223, the spirit operation portion 224, and the wisdom operation portion 225; an operation of determining a race event of a race; and the like.

When the turn end operation is input (YES in P7-7), the nurture game execution unit 701a transmits a selection command corresponding to the turn end operation input by the player to the server 1000 (P7-8). Thereafter, the player terminal 1 waits until the result information is received from the server 1000 (NO in P7-9).

Referring back to FIG. 42, when a selection command is received from the player terminal 1 (YES in S7-6), the nurture game execution unit 1101a executes selection command reception processing (S20).

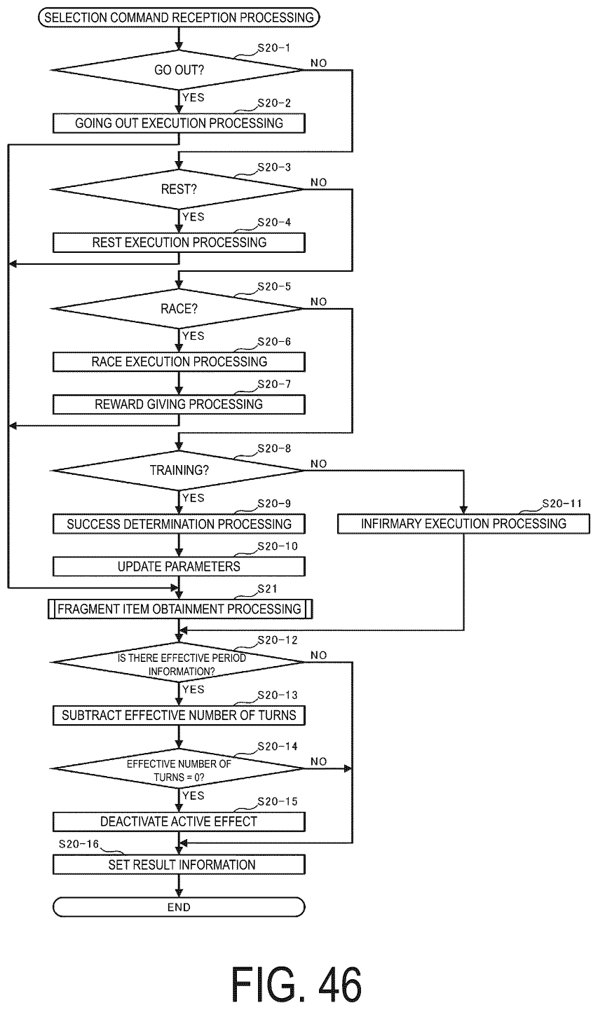

FIG. 46 is a flowchart for describing the selection command reception processing in the server 1000. When the selection command indicating an operation input of the going out operation portion 215e is received (YES in S20-1), the nurture game execution unit 1101a executes going out execution processing (S20-2). Here, a going out event is determined that increases the energy and mood parameters. Further, the parameters for the energy and mood are updated based on the determined going out event.

When the selection command indicating an operation input of the rest operation portion 215a is received (YES in S20-3), the nurture game execution unit 1101a executes rest execution processing (S20-4). Here, a rest event is determined that increases the energy parameter. Further, the parameter for the energy is updated based on the determined rest event.

When the selection command indicating an operation input to start a race is received (YES in S20-5), the nurture game execution unit 1101a executes race execution processing (S20-6). Here, a race simulation is executed based on the parameters of the nurture target character and the NPCs that run in the race. Further, the nurture game execution unit 1101a executes reward giving processing of giving a reward to the player (S20-7). Here, a reward is determined based on the result of the simulation, that is, the placing, the race development, and the like of the nurture target character, and the determined reward is given to the player.

When the selection command indicating execution of any training is received (YES in S20-8), the nurture game execution unit 1101a executes success determination processing (S20-9). Here, the success or failure of the training is determined based on the failure rate calculated in advance. Then, the nurture game execution unit 1101a updates various parameters, based on the determination result of S20-9 (S20-10). Here, the ability parameters and the like are updated as determined in S10-9 at the start of the training. In this case, the value of the bond parameter of the placed character is updated.

When the selection command indicating an operation input of the infirmary operation portion 215d is received (NO in S20-8), the nurture game execution unit 1101a executes infirmary execution processing (S20-11). Here, for example, the minus parameters of the nurture target character are cancelled.

When the going out execution processing (S20-2), the rest execution processing (S20-4), the race execution processing (S20-6), and the training success determination processing (S20-9) are executed, the nurture game execution unit 1101a executes the fragment item obtainment processing (S21).

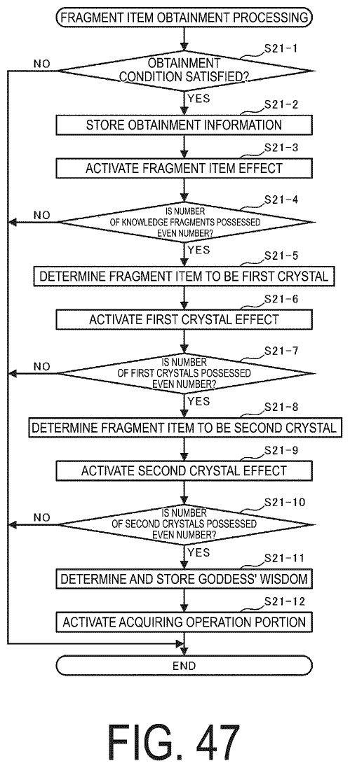

FIG. 47 is a flowchart for describing the fragment item obtainment processing in the server 1000. When the obtainment condition is satisfied (YES in S21-1), the nurture game execution unit 1101a stores obtainment information on the fragment item (S21-2). The obtainment information includes information (ID) indicating the display positions where the suggestion icon 216 and the effect icon 218a are displayed in the knowledge table dialog 300. Here, obtained fragment items are stored as knowledge fragments. In addition, here, as the obtainment conditions, the execution of the going out execution processing (S20-2), the rest execution processing (S20-4), and the race execution processing (S20-6) and the success of the training are set.

The nurture game execution unit 1101a activates the effect of the obtained fragment item (S21-3). Then, when the number of possessed knowledge fragments is an even number (YES in S21-4), the nurture game execution unit 1101a determines a fragment item to be a first crystal (S21-5). Here, the first crystal is determined based on two knowledge fragments serving as parents. Then, the nurture game execution unit 1101a activates the effect of the first crystal (S21-6).

When the number of possessed first crystals is an even number (YES in S21-7), the nurture game execution unit 1101a determines a fragment item to be a second crystal (S21-8). Here, the second crystal is determined based on two first crystals serving as parents. Then, the nurture game execution unit 1101a activates the effect of the second crystal (S21-9).

When the number of possessed second crystals is an even number (YES in S21-10), the nurture game execution unit 1101a determines and stores the Goddess' Wisdom (S21-11). Here, the Goddess' Wisdom is determined based on two second crystals serving as parents. Then, the nurture game execution unit 1101a activates the acquiring operation portion 300c (S21-12).

Referring back to FIG. 46, when there is effective period information indicating the effective period of the special effect (YES in S20-12), the nurture game execution unit 1101a counts down the number of turns of the effective period (effective number of turns) (S20-13). When the effective number of turns is 0 (YES in S20-14), the nurture game execution unit 1101a deactivates the active effect which is the special effect (S20-15).

Then, the nurture game execution unit 1101a sets result information including: the results of the going out execution processing, the rest execution processing, the race execution processing, the reward giving processing, the infirmary execution processing, and the success determination processing; and various updated information and causes the player terminal 1 to receive the result information (S20-16).

Referring back to FIG. 44, when the player terminal 1 receives the result information from the server 1000 (YES in P7-9), the nurture game execution unit 701a executes result information reception processing (P20).

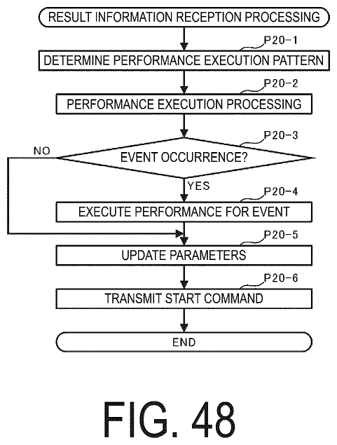

FIG. 48 is a flowchart for describing the result information reception processing in the player terminal 1. The nurture game execution unit 701a determines, based on the received result information, the performance execution pattern (P20-1). Then, the nurture game execution unit 701a executes a performance in the execution pattern determined in P20-1 (P20-2). Here, when the training in which the friendship training possible state is set is successful, a friendship-training-exclusive performance is executed.

Specifically, in P20-1, the nurture game execution unit 701a specifies a character associated with the successful training item and associated with the friendship training possible information. Then, the nurture game execution unit 701a determines the execution pattern of the friendship-training-exclusive performance corresponding to the specified character and the executed training item. In the friendship-training-exclusive performance determined at this time, the character associated with the friendship training possible information is displayed.

When the second event occurs (YES in P20-3), the nurture game execution unit 701a executes a performance for the occurring event (P20-4). Also, the nurture game execution unit 701a updates the parameters, based on the received result information (P20-5). When all the performances to be executed in the current turn are finished, the nurture game execution unit 701a transmits a start command to the server 1000 (P20-6). In this manner, the current turn is ended in the player terminal 1. Then, when the server 1000 receives the start command, thereafter, processing related to the next turn is executed by processing similar to that described above.

Referring back to FIG. 39, in the server 1000, when the nurture stage processing described above ends (S7), the nurture game end processing unit 1102a executes the nurture game end processing (S8).

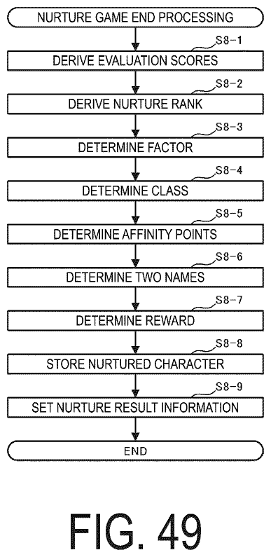

FIG. 49 is a flowchart for describing the nurture game end processing in the server 1000. The nurture game end processing unit 1102a derives evaluation scores, based on various parameters of the nurture target character (S8-1). Further, the nurture game end processing unit 1102a derives a nurture rank, based on the derived evaluation scores (S8-2).

In addition, the nurture game end processing unit 1102a determines the factor to be obtained by the nurtured character (S8-3). Further, the nurture game end processing unit 1102a determines a class, based on the number of fans obtained (S8-4). Further, the nurture game end processing unit 1102a determines affinity points, based on a predetermined parameter such as the nurture rank, the number of fans, or the like (S8-5). Although a detailed description is omitted, the affinity points are points given not to the nurtured character but to a character serving as a source of the nurtured character.

A plurality of story screens are provided for each character, and an unlock condition is set for some of the story screens. There is a story screen in which affinity points are set as an unlock condition, and when the affinity points are equal to or greater than a threshold, the player can view the story screen.

Further, the nurture game end processing unit 1102a determines two names (S8-6). Here, the condition achieved in the nurture main game is confirmed, and two names to be obtained by the nurtured character are determined. Further, the nurture game end processing unit 1102a determines a reward to be given to the player (S8-7). The nurture game end processing unit 1102a stores nurtured character information including the evaluation scores, the nurture rank, the ability parameters, the aptitude parameters, the obtained skills, the inheritance information, the factor information, the class, the two names, and the like in association with the player ID of the player in the game information storage unit 1151 (S8-8). In addition, the nurture game end processing unit 1102a sets nurture result information and causes the player terminal 1 to receive the nurture result information (S8-9).

Referring back to FIG. 39, when the player terminal 1 receives the nurture result information, the nurture completion processing unit 702a executes the nurture game end processing (P8). Here, the nurture completion processing unit 702a stores the received nurture result information in the game information storage unit 751. The nurture completion processing unit 702a displays the nurture completion screen 330 (see FIGS. 36A, 36B, and 36C) on the display 26 based on the nurture result information.

The above-described nurture game is realized via the above-described processing. Also, the nurtured character information related to the nurtured character nurtured (created) via the nurture game is stored in association with a player ID. The processing in the player terminal 1 and the server 1000 described above are merely examples. Further, each item of processing described above may be executed only by the player terminal 1 or only by the server 1000.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present disclosure.

The game properties and the processing in the player terminal 1 and the server 1000 described in the above embodiment are merely examples. In the embodiment described above, the command that can be selected by the player each turn and that ends the turn is merely an example. For example, in the embodiment described above, only a part of the command for ending the turn may be provided.

In the embodiment described above, the number of fragment items that the player can obtain by selecting selection items, that is, the number of knowledge fragments, is eight. Then, if eight knowledge fragments are obtained, the Goddess' Wisdom, that is, the special effect, is determined. That is, when the number of obtained fragment items reaches the specified number (eight), the player can select the acquiring operation portion 300c. In other words, when the number of obtained fragment items reaches the upper limit, the player can activate the special effect.

However, the acquiring operation portion 300c may be selectable when the number of obtained fragment items reaches a predetermined number less than the specified number (upper limit). In this case, the Goddess' Wisdom may be generated based on the fragment item possessed when the acquiring operation portion 300c is operated.

In the embodiment described above, the Goddess' Wisdom is generated based on eight knowledge fragments. However, for example, the Goddess' Wisdom may be generated based on some of the eight knowledge fragments, such as an odd-numbered or even-numbered knowledge fragment in the order of obtainment.

In the embodiment described above, the first crystal is determined based on two knowledge fragments. At this time, the special character associated with the first knowledge fragment and the special character associated with the second knowledge fragment are inherited by the first crystal with a probability of 50%.

However, for example, a priority order may be set for the knowledge fragments, and the special character associated with the knowledge fragment having a high priority order may be inherited by the first crystal. For example, it is assumed that odd-numbered knowledge fragments are set to be higher in the priority order than even-numbered knowledge fragments. In this case, the special character associated with the obtained odd-numbered knowledge fragment may always be inherited by the first crystal. Similarly, the second crystal is generated based on two first crystals, and at this time, the special character associated with the first or third first crystal may always be inherited by the second crystal.

In the embodiment described above, the effect is associated with the fragment item, and the effect is activated based on the obtainment of the fragment item. Also, the effect is deactivated based on acquiring the Goddess' Wisdom. However, the effect associated with the fragment item is not essential. The effect associated with the fragment item may be permanently activated until the nurture game has ended. Further, while the special effect is activated by acquiring the Goddess' Wisdom, the effect of the fragment item may continue to be activated. In this case, the effective period of the effect of the fragment item ends at the same time as the effective period of the special effect.

In the embodiment described above, the first crystal is determined based on two knowledge fragments, and the second crystal is determined based on two first crystals. The Goddess' Wisdom, that is, the special effect, is then determined based on two second crystals. However, the first crystal and the second crystal are not essential. For example, in the embodiment described above, after four first crystals are determined based on two knowledge fragments, the Goddess' Wisdom may be determined based on the four first crystals. Alternatively, the Goddess' Wisdom may be determined based on the eight knowledge fragments without determining the first crystal and the second crystal.

In the embodiment described above, any one of the special effects associated with the three types of special characters provided in advance is determined. However, the special effect may be determined through a lottery or the like each time. For example, in a case where, as the special effect, the ability parameter increases, an increase value or a correction value of the ability parameter may be randomly determined.

In the embodiment described above, the inheritance level is managed for each special character, and the higher the inheritance level, the greater the benefit of the special effect. However, the inheritance level is not essential, and the same special effect may be always activated regardless of the number of times the Goddess' Wisdom has been acquired.

In the embodiment described above, when the acquiring operation portion 300c is enabled in the knowledge table dialog 300, the suggestion icon 216 corresponding to the special character, that is, the special effect, is always displayed in the Goddess' Wisdom display region 304. That is, the image corresponding to the special effect is displayed in association with the acquiring operation portion 300c. However, in order to make the special effect to be activated clearer, for example, the suggestion icon 216 may be superimposed and displayed on the acquiring operation portion 300c. In any case, it is desirable that the image corresponding to the special effect is displayed in association with the acquiring operation portion 300c. However, the display of the image corresponding to the special effect is not essential.

In the embodiment described above, the fragment items associated with the selection items are determined through a lottery. However, the fragment item associated with each selection item may be determined in advance. In this case, the same fragment item is arranged in each selection item in all of the turns. Alternatively, the fragment item associated with each selection item may be determined in advance for each turn.

In the embodiment described above, information indicating the display positions where the suggestion icon 216 and the effect icon 218a are displayed in the knowledge table dialog 300 is stored based on the obtainment order of the fragment items. However, the information indicating the display positions where the suggestion icon 216 and the effect icon 218a are displayed may be selectable by the player. That is, when a fragment item is obtained, the player may be able to select the display position where the suggestion icon 216 and the effect icon 218a are displayed.

In any case, the information processing program causes a computer (in the embodiment, the player terminal 1 and/or the server 1000) to execute the following processing.

### Processing Executed by Computer

Processing of, in a game including a plurality of turns, allowing the player to select, for each of the plurality of turns, any of a plurality of commands for ending the turn (in this embodiment, for example, P7-2). Processing of storing obtainment information of predetermined game content (in this embodiment, for example, a fragment item) based on a command being selected by the player (in this embodiment, for example, S21-2). Processing of ending the turn based on the selection of the command (in this embodiment, for example, P20). Processing of determining a special effect which is activated when a special command (in this embodiment, for example, the acquiring operation portion 300c) is selected by the player, based on a predetermined number (in this embodiment, for example, 8) of obtained predetermined game content (in this embodiment, for example, S21-11). Processing of activating the determined special effect when the special command is selected (in this embodiment, for example, P10-3 and S7-5).

The special effect may include a time-limited effect with a number of turns set as the effective period, and the time-limited effect may be active during the effective period.

In addition, processing (in this embodiment, for example, S21-3) of activating a first effect (in this embodiment, for example, the effect of a fragment item) associated with the obtained predetermined game content based on the obtainment of the predetermined game content and processing (in this embodiment, for example, P10-5) of deactivating the first effect based on the selection of a special command may be executed.

In addition, when the number of obtained pieces of predetermined game content reaches a specified number, processing (in this embodiment, for example, S21-12) of allowing the player to select a special command may be executed.

In addition, processing (in this embodiment, for example, S21-8) of determining a second effect (in this embodiment, for example, the effect associated with a second crystal) based on a plurality of (in this embodiment, for example, 4) predetermined game content of which the number is less than a predetermined number may be executed.

Then, processing of determining the special effect may determine the special effect based on a plurality of (in this embodiment, for example, 2) second effects.

In addition, processing of determining the special effect may determine any one of a plurality of types of special effects provided in advance.

In addition, processing (in this embodiment, for example, P10-2) of managing information (in this embodiment, for example, inheritance level) associated with the number of times the special effect has been activated for each type of special effect may be executed. Then, the greater the number of times the special effect has been activated, the greater the benefit of the special effect provided during the game may be.

Further, processing (in this embodiment, for example, P10-8) of displaying an image corresponding to a special effect in association with a special command selectable by the player may be executed.

Hereinafter, other examples of the description after the “nurture stage processing” will be described. Elements corresponding to those of in the embodiment described above will be denoted by the same reference numerals.

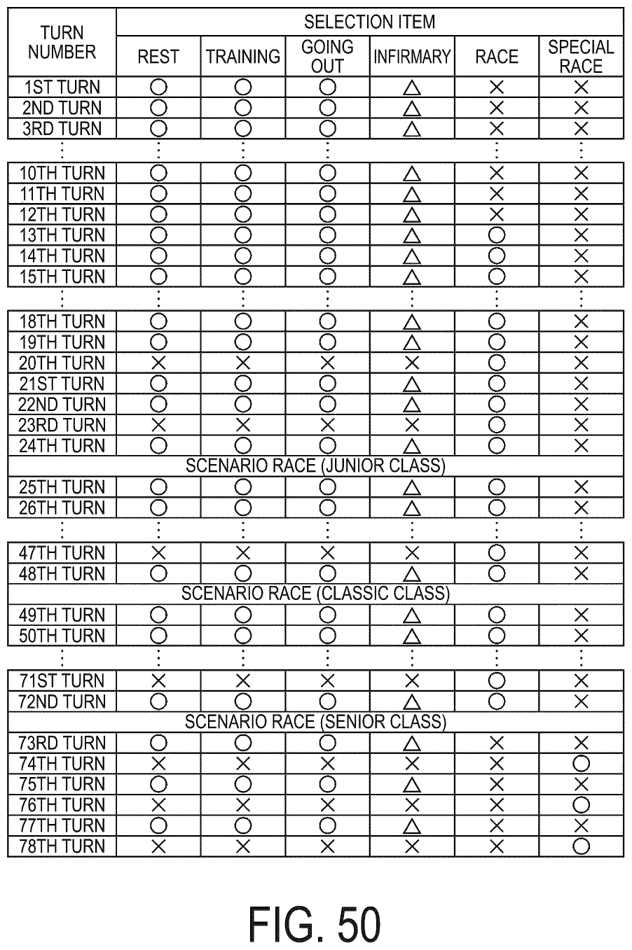

FIG. 50 is a diagram for describing selection items in each turn. Here, the selection items that can be selected are different for each turn depending on the type of the nurture target character. However, the selection items that can be selected may be the same in each turn regardless of the type of the nurture target character. As illustrated in FIG. 50, the nurture main game includes a first turn to a 78th turn. Various parameters are updated in accordance with the selection item selected by the player in each turn.

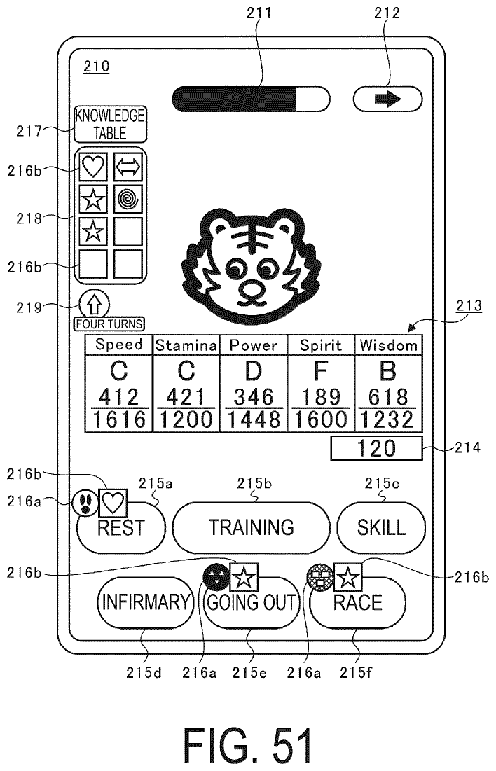

FIG. 51 is a diagram for describing the top screen 210. In the nurture stage processing, the top screen 210 illustrated in FIG. 51 is displayed on the display 26. In an upper portion of the top screen 210, an energy display portion 211 and a mood display portion 212 are displayed. The nurture target character is provided with an “energy” parameter. The “energy” parameter is mainly used for calculation of a failure rate which is a probability of failure in training which will be described below. The energy display portion 211 is displayed so that the current remaining amount of the “energy” of the nurture target character can be visually recognized with respect to the upper limit value of the “energy”.

The nurture target character is provided with a “mood” parameter. The mood display portion 212 displays the current “mood” of the nurture target character using a plurality of levels (five levels including very bad, bad, normal, good, and very good) so that the user can visually recognize the mood. With better “mood” parameter, race developments become more advantageous for the nurture target character and the increase value of ability parameters in training are increased.

As illustrated in FIG. 51, an image of the nurture target character, a stats display portion 213, and a skill point display portion 214 are displayed at a central portion of the top screen 210. In the stats display portion 213, the current stats of the nurture target character are indicated by a numerical value and an alphabetical letter indicating rank for each numerical value. Specifically, in the present embodiment, the numerical values and ranks of the ability parameters for speed, stamina, power, spirit, and wisdom are displayed. In the skill point display portion 214, the skill points possessed by the nurture target character is indicated by a numerical value.

As illustrated in FIG. 51, the rest operation portion 215a, the training operation portion 215b, the skill operation portion 215c, the infirmary operation portion 215d, the going out operation portion 215e, and the race operation portion 215f are displayed at a lower portion of the top screen 210. In addition, in each turn, the player can select any one of the items of the rest operation portion 215a, the training operation portion 215b, the infirmary operation portion 215d, the going out operation portion 215e, and the race operation portion 215f. However, a race-limited turn is set in advance for the nurture target character. In the race-limited turn, the rest operation portion 215a, the training operation portion 215b, the infirmary operation portion 215d, and the going out operation portion 215e are not selectable.

The player can select “Rest” as the selection item by operating the rest operation portion 215a. When “Rest” is selected, the energy of the nurture target character is recovered. In addition, the player can select training to be executed by the nurture target character by operating the training operation portion 215b.

The player can select “Infirmary” as the selection item by operating the infirmary operation portion 215d. When “Infirmary” is selected, the minus parameters of the nurture target character are cancelled. Although a detailed description is omitted, a minus parameter that is a disadvantage to progressing through the game may be set for the nurture target character.

In the nurture main game, an event of obtaining a minus parameter is provided. The nurture target character obtains a minus parameter by the occurrence of the event. In addition, even when the training fails, the nurture target character may obtain a minus parameter. When “Infirmary” is selected in a state where the nurture target character has obtained a minus parameter, the minus parameter can be canceled. However, even if “Infirmary” is selected, the minus parameter may not be canceled. In addition, energy may be recovered by selecting “Infirmary”. In a state where the nurture target character has not obtained a minus parameter, the infirmary operation portion 215d cannot be selected.

The player can select “Going out” as the selection item by operating the going out operation portion 215e. When “Going out” is selected, the mood of the nurture target character is raised. In addition, the player can select the race type to enter the nurture target character in by operating the race operation portion 215f.

When the nurture target character performs any one of rest, training, infirmary, going out, and race entry, the current turn ends and the current turn shifts to the next turn.

As described above, a race-limited turn in which each item of the rest operation portion 215a, the training operation portion 215b, the infirmary operation portion 215d, and the going out operation portion 215e cannot be selected is set for each character. In the race-limited turn, the rest operation portion 215a, the training operation portion 215b, the infirmary operation portion 215d, and the going out operation portion 215e are displayed grayed out, and an operation by the player is not accepted. Thus, in the race-limited turn, the player has to operate the race operation portion 215f to enter the nurture target character into a race.

FIG. 50 illustrates an example of selection items that can be selected by a predetermined nurture target character in each turn. In FIG. 50, (indicates that selection is possible, and x indicates that selection is impossible. Further, A indicates a case where whether selection is possible or not depends on the parameter of the nurture target character at the start of each turn.

In this example, from the 1st turn to the 12th turn, “race” is not selectable, and selection items other than “race” are selectable. In addition, from the 13th turn to the 72nd turn, a plurality of turns set as race-limited turns, such as the 20th turn, the 23rd turn, and the 47th turn, are provided.

A target race and a target in the target race are set in advance for each character. Here, as a target, a placing is set in each target race. Here, the turn in which the target race is held is a race-limited turn. Thus, in the race-limited turn, the player has to enter the nurture target character into the target race. In a case where the target set for the target race is not satisfied, the nurture main game ends.

Also, the 74th turn, the 76th turn, and the 78th turn are set as race-limited turns, and all of the characters have this in common. In these three turns, the player needs to enter the nurture target character in a special race.

Note that the skill operation portion 215c is set to be always selectable in all turns. Even if the player operates the skill operation portion 215c to obtain a skill, the turn is not ended.

In the present embodiment, a scenario race is held after the end of the 24th turn, the 48th turn, and the 72nd turn. In the scenario race, the nurture target character competes with other characters for placings, and the basic competition form is the same as that of the normal race that can be selected in each turn or the special race described above.

In each turn, game content is associated with each of the training items of “rest” and “training” and each of the selection items of “going out” and “race”. As illustrated in FIG. 51, in the rest operation portion 215a, the going out operation portion 215e, and the race operation portion 215f, a first icon 216a and a second icon 216b corresponding to the game content associated with each operation portion are displayed. As will be described in detail later, a plurality of types of game content are provided, and the first icon 216a and the second icon 216b corresponding to the game content associated with the operation portion is displayed.

When a predetermined obtainment condition is satisfied, such as when a selection item associated with game content is selected, the nurture target character obtains the game content. The game content is associated with an effect that is advantageous to the nurture target character. The effect is different for each type of game content. When the nurture target character obtains the game content, the effect associated with the obtained game content is activated. Thus, it can be said that, in each turn, the effect is associated with each selection item.

The knowledge table check icon 217, the effect display region 218, and the special effect icon 219 are displayed in the upper left portion of the top screen 210. The knowledge table check icon 217 functions as an operation portion that receives a player operation. The player can check the game content or the like possessed by the nurture target character by operating the knowledge table check icon 217.

In the effect display region 218, the second icon 216b is displayed. The second icon 216b is provided for each type of effect, that is, each type of game content. In the effect display region 218, the second icon 216b corresponding to the currently activated effect is displayed.

The special effect icon 219 indicates a special effect that is activated. Although details will be described later, when the nurture target character obtains eight pieces of game content, “Goddess' Wisdom” associated with a special effect is generated. The player can use the generated Goddess' Wisdom at a desired timing to activate the special effect. The special effect includes a time-limited effect with the number of turns set as an effective period. The time-limited effect is only active for the effective period. The special effect icon 219 indicates the special effect that is currently active and the number of turns remaining in the effective period.

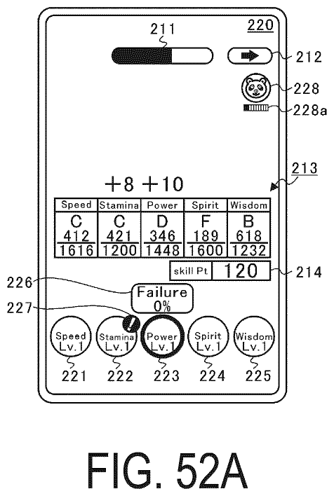

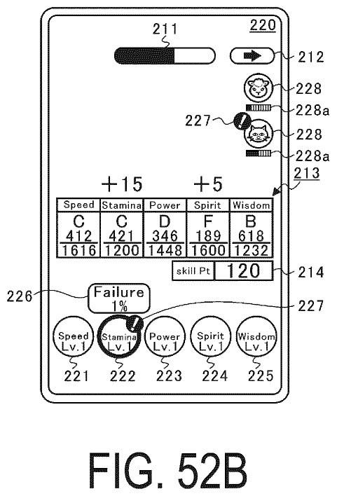

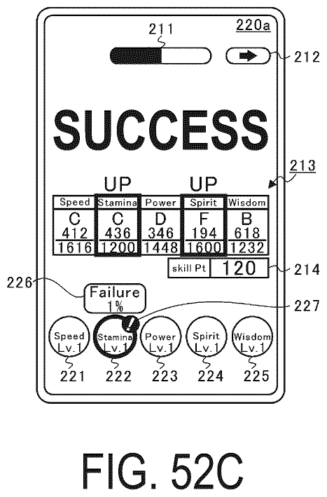

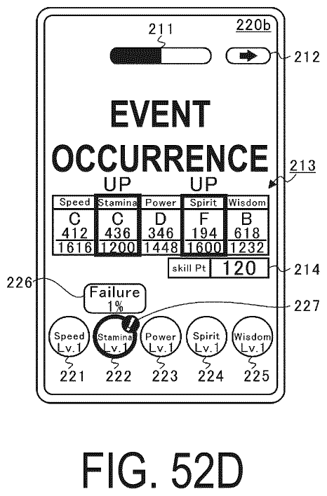

FIG. 52A is a first diagram for describing the training screen 220. FIG. 52B is a second diagram for describing the training screen 220. When the training operation portion 215b of the top screen 210 is operated, the training screen 220 is displayed on the display 26. Although not illustrated in FIGS. 52A and 52B, the knowledge table check icon 217, the first icon 216a, the second icon 216b, the effect display region 218, and the special effect icon 219 are displayed on the training screen 220 as on the top screen 210.

As illustrated in FIG. 52A, training items are displayed in a lower portion of the training screen 220. Here, a speed operation portion 221, a stamina operation portion 222, a power operation portion 223, a spirit operation portion 224, and a wisdom operation portion 225 are displayed.

When the player operates one of the operation portions 221 to 225, the training item corresponding to the operated operation portion 221 to 225 is put in a provisionally selected state. At this time, the operation portion 221 to 225 corresponding to the training item in the provisionally selected state is highlighted. In FIG. 52A, the power operation portion 223 is provisionally selected. In FIG. 52B, the stamina operation portion 222 is provisionally selected.

When the speed operation portion 221 in the provisionally selected state is operated again, speed training is executed. Similarly, when the stamina operation portion 222, the power operation portion 223, the spirit operation portion 224, or the wisdom operation portion 225 in the provisionally selected state is operated again, training of stamina, power, spirit, or wisdom is executed, respectively.

In addition, a training level for each training item is also displayed in each of the operation portions 221 to 225. Although details will be described later, the training level is a parameter that increases based on the training points, and when the training levels are higher, the increase value of the ability parameter when the training is performed is larger. The training level is initially set to level 1 and can increase up to level 5.

In addition, a failure rate display portion 226 is displayed at the operation portion 221 to 225 in the provisionally selected state. The failure rate displayed as a numerical value in the failure rate display portion 226 is set so as to increase in inverse proportion to the remaining energy displayed in the energy display portion 211.

Further, in the stats display portion 213, the increase value of the ability parameter when training corresponding to the operation portion 221 to 225 in the provisionally selected state is successful is displayed. In the example illustrated in FIG. 52A, the power operation portion 223 is provisionally selected, and “+8” is displayed in the stamina field of the stats display portion 213 and “+10” is displayed in the power field of the stats display portion 213. Also, in the example illustrated in FIG. 52B, the stamina operation portion 222 is provisionally selected, and “+15” is displayed in the stamina field of the stats display portion 213 and “+5” is displayed in the spirit field of the stats display portion 213.

In addition, when the training is successfully executed, a predetermined event may occur. In this case, an event notification display 227 is displayed at the operation portion 221 to 225 corresponding to the training item for which the predetermined event occurs. Note that the event notification display 227 may have different display modes depending on the type of the event.

In a turn in which training can be executed, a character may be placed in each training item. The characters placed in the training items are the above-described support characters, specific characters, and story characters set separately from these characters. In a turn in which training can be executed, for each character that can be placed in training, whether to place the character in a training item and the training item for placement are determined through a lottery.

As illustrated in FIG. 52B, in an upper right portion of the training screen 220, a placed character icon 228 corresponding to the character placed in training (hereinafter referred to as a placed character) for each of the provisionally selected operation portions 221 to 225 is displayed. When the training is successful, a predetermined event may occur that is associated with the placed character. In this case, the event notification display 227 is displayed on the corresponding placed character icon 228.

Also, when training associated with a placed character is successful, the parameter increase value of the nurture target character is higher than that when training not associated with any of the placed characters is successful. Hereinafter, training in which a character is placed will be referred to as joint training.

Further, a bond gauge 228a is displayed below the placed character icon 228. The bond gauge 228a visually displays the bond parameter associated with the placed character. When the placed character succeeds in the associated training, the bond parameter of the placed character increases. When the bond parameter values are higher, the increase value of the ability parameter of the nurture target character when the training is successful is larger.

Also, when a support character whose bond parameter is equal to or greater than a predetermined value is placed in a predetermined training item, a friendship training possible state is set for the training item. When the training item in which the friendship training possible state is set is selected and the training is successful, friendship training occurs. In other words, when the training in the friendship training possible state is successful, the normal joint training is promoted to the friendship training. In the friendship training, the increase value of the ability parameter of the nurture target character is larger than that in the normal joint training.

Note that any one of the five training items of speed, stamina, power, spirit, and wisdom may be associated with the support card (support character) as a favored training. Here, the setting conditions for the friendship training possible state are that the support character is placed in the favored training and that the bond parameter of the support character is equal to or greater than a predetermined value.

Thus, when a support character whose bond parameter is equal to or greater than a predetermined value is placed in the favored training of the support character, the friendship training possible state is set for this training item. Then, when the training item in which the friendship training possible state is set is selected and the training is successful, the ability parameter of the nurture target character greatly increases as compared with the normal joint training.

Note that the support card (support character) may include a support card (support character) not associated with the favored training. For a support card (support character) not associated with a favored training, the friendship training possible state may be set on the condition that the bond parameter of the support character is equal to or greater than a predetermined value regardless of the placed training item. Alternatively, for a support card (support character) not associated with a favored training, the friendship training possible state may not be set.

As described above, in the present embodiment, the setting conditions of the friendship training possible state include that the bond parameter of the support character is equal to or greater than a predetermined value and that a support character is placed in a pre-set training item.

As described above, in each turn, game content is associated with a training item. Although not illustrated in FIGS. 52A and 52B, the first icon 216a and the second icon 216b are displayed in each of the speed operation portion 221, the stamina operation portion 222, the power operation portion 223, the spirit operation portion 224, and the wisdom operation portion 225. Then, when the selected training is successful, the player or the nurture target character obtains the game content associated with the selected training item. Note that obtainment information of the game content, in other words, information indicating the game content obtained by the player is stored in association with the player information. However, hereinafter, for ease of understanding, a case where the nurture target character obtains game content will be described. The game content will be described later.

FIG. 52C is a diagram for describing the training result notification screen 220a. When any one of the operation portions 221 to 225 in the provisionally selected state is operated again, the training corresponding to the operated operation portion 221 to 225 is executed. When the training is performed, the training result notification screen 220a is displayed on the display 26. On the training result notification screen 220a, an image notifying of the success or failure of the training is displayed.

Although not illustrated, in a case where normal joint training is executed, an image of the nurture target character executing training is displayed on the training result notification screen 220a. The image displayed at this time is provided for each training item. In addition, the image corresponding to each training item is provided with a success pattern displayed when the training is successful and a failure pattern displayed when the training is failed.

When the training in which the friendship training possible state is set is successful, a friendship-training-exclusive performance is executed. The friendship-training-exclusive performance includes a performance in which a support character is displayed on the training result notification screen 220a. The support character displayed at this time is a character satisfying the setting conditions of the friendship training possible state.

For example, it is assumed that the character A, which is a support character, is placed in the training item of speed. Also, in this example, the bond parameter of the character A is equal to or greater than a predetermined value and the favored training of the character A (support card) is speed. In this case, the speed training item is in a friendship training possible state. In this state, let's assume that the speed training item is selected and the speed training is successful. In this case, an image including the character A is displayed on the training result notification screen 220a.

In one turn, a plurality of support characters placed in the same training item may satisfy the setting condition of the friendship training possible state. For example, it is assumed that four support characters of the characters A, B, C, and D are placed in the training item of stamina. At this time, let's assume that the characters A, B, C, and D all satisfy the setting condition of the friendship training possible state. In this case, a friendship-training-exclusive performance in which the characters A, B, C, and D are displayed simultaneously or sequentially on the training result notification screen 220a is executed.

In the friendship-training-exclusive performance, the character satisfying the setting condition of the friendship training possible state and the nurture target character perform training together. Thus, it can be said that the friendship training possible state is set to the support character in addition to the training item.

Although not illustrated, an effect is superimposed and displayed on the placed character icon 228 corresponding to the placed character for which the friendship training possible state is set. Accordingly, the player can identify which placed character the friendship training occurs with. In addition, when the friendship training possible state is set to any one of the training items, the effect is also superimposed and displayed on the training operation portion 215b of the top screen 210. Thus, also via the top screen 210, the player can recognize that the friendship training possible state is set.

Also, on the training result notification screen 220a, the ability parameters of the stats display portion 213 are updated and displayed. That is, the ability parameter of the nurture target character corresponding to the training item selected by the player is updated.

Here, the value of the ability parameter that increases when the training displayed in the stats display portion 213 in FIG. 52A or 52B is successful is added. In addition, the display of the energy display portion 211 is updated according to the performed training item. When speed, stamina, power, or spirit training is successful, the energy decreases. On the other hand, when wisdom training is successful, energy is recovered.

When the training is failed, a predetermined penalty is given. Specifically, the content of the penalty may include a decrease in energy, a decrease in a numerical value of an ability parameter, a decrease in mood, and the like. Note that, for example, the penalty given when the failure rate is high may be more disadvantageous than the penalty given when the failure rate is low (for example, the numerical value of the decrease in energy is large, the numerical value of the decrease in the ability parameter is large, or the level of the decreasing mood is large).

The content of the penalty may be determined in accordance with the training item. For example, the value of the ability parameter for speed may be decreased when the training of speed has failed, and the value of the ability parameter for power may be decreased when the training of power has failed. In addition, for one or more training items (for example, wisdom), even if training fails, it can be set that a penalty is not given.

FIG. 52D is a diagram for describing the event screen 220b. When the display of the training result notification screen 220a ends, the event screen 220b may be displayed on the display 26. Various events are performed via the event screen 220b. Note that a plurality of events may occur during one turn.

For example, when a first hint event or a second hint event occurs, a skill hint may be obtained. When skill hint is obtained, the player can obtain the skill by spending skill points. A plurality of types of skills are provided, and a predetermined ability may be activated for each skill. An activation condition and an effect are determined for each skill, and when an activation condition is satisfied, a predetermined effect is activated. A skill may be activated while a race is being executed as will be described below.

The events include, in addition to the first hint event and the second hint event for obtaining a skill hint, an event for recovering energy, an event for decreasing energy, a first ability event and a second ability event for increasing or decreasing an ability parameter, an event for increasing mood, an event for decreasing mood, and the like. Also, as will be described in detail below, examples of the event include an event that occurs in a predetermined turn and an event that occurs via a successful lottery. In addition, there are events that occur at the start of a turn and events that occur before the end of a turn. When all the events that have occurred end, the top screen 210 related to the next turn is displayed.

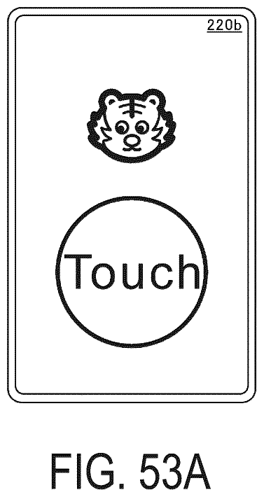

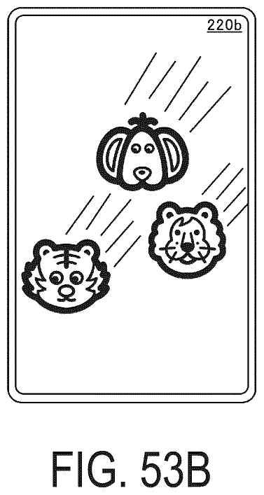

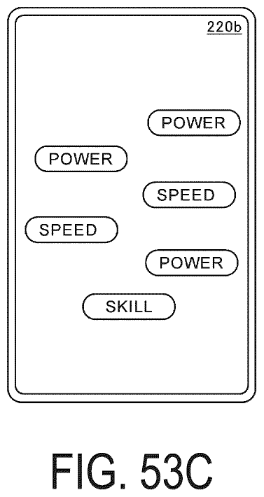

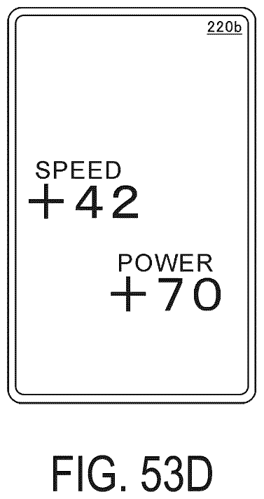

FIG. 53A is a first diagram for describing an inheritance event. FIG. 53B is a second diagram for describing the inheritance event. FIG. 53C is a third diagram for describing the inheritance event. FIG. 53D is a fourth diagram for describing the inheritance event. In the factor activation turn described above, an inheritance event occurs with the start of the turn. Note that this inheritance event is a scenario-shared event to be described later and always occurs in the same turn regardless of the scenario selected by the player. In the present embodiment, the first turn, the 31st turn, and the 55th turn are set as factor activation turns. The example described is of an inheritance event occurring on the 31st turn.

When the 31st turn is started, first, as illustrated in FIG. 53A, the nurture target character and an operation portion labelled with “Touch” are displayed on the event screen 220b. When the operation portion displayed on the event screen 220b is tapped, an animation image including the nurture target character and the two inheritance characters is displayed as illustrated in FIG. 53B. In addition, when the operation portion is tapped, a lottery for whether to activate is performed for all the factors possessed by a total of six nurtured characters of the first inheritance generation and the second inheritance generation.

Then, as illustrated in FIG. 53C, the factor which is successful by the lottery for whether to activate and is determined to be activated is displayed, and thereafter, as illustrated in FIG. 53D, the type of the ability parameter or the aptitude parameter which is increased by the activation of the factor and the increase value are displayed, and the parameter is updated. When the inheritance event ends, the top screen 210 illustrated in FIG. 51A is displayed, and the player can select any item. At this time, the stats display portion 213 is in a state in which the increase values for the ability parameter and the aptitude parameter displayed in the inheritance event are added.

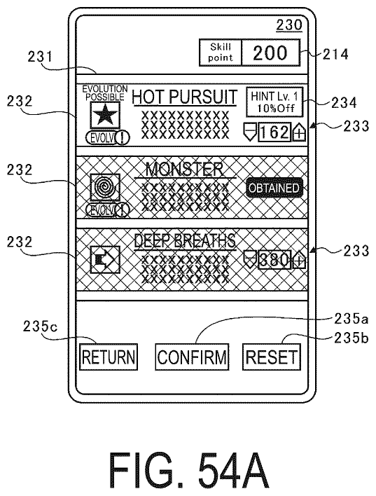

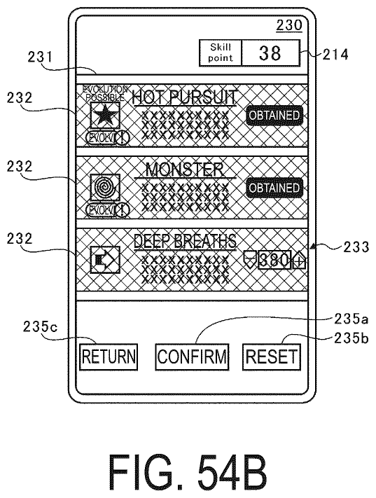

FIG. 54A is a first diagram for describing the skill screen 230. FIG. 54B is a second diagram for describing the skill screen 230. When the skill operation portion 215c of the top screen 210 is operated, the skill screen 230 illustrated in FIG. 54A is displayed on the display 26. A skill point display portion 214 is displayed on the skill screen 230. In the skill point display portion 214, the current skill points possessed by the nurture target character (player) is displayed as described above.

A skill display region 231 is provided below the skill point display portion 214. A plurality of skill display fields 232 are provided in the skill display region 231. In the skill display field 232, an obtained skill, a base skill set in advance for the nurture target character, a base skill possessed due to one of various events, and the like are displayed. Although three skill display fields 232 are displayed in the skill display region 231 in FIG. 54A, when a slide operation is input to the skill display region 231, another skill display field 232 is further displayed in the skill display region 231.

The skill name, the skill activation condition and effect when the skill is activated, and the like are displayed in the skill display region 231. On the right side of the skill display region 231, a required point display portion 233 is displayed. The required point display portion 233 displays the skill points necessary for obtaining the skill. Further, the required point display portion 233 is provided with an operation portion marked with “+” or “−”. The player can set the skill displayed in the skill display field 232 to the selected state by operating the operation portion marked with “+”. Also, the player can cancel the selected state of the skill displayed in the skill display field 232 by operating the operation portion marked with “−”.

When the first hint event or the second hint event occurs for a base skill, the skill points spent to obtain the base skill is discounted. Also, when the hint level of the character is strengthened before the start of the nurture game, the skill points for obtaining the base skill are discounted. Here, the skill points after the discount are displayed in the required point display portion 233 for the base skill for which a hint has been obtained. At this time, a discount rate display icon 234 indicating the discount rate is displayed in the skill display field 232.

On the skill screen 230, the skill display field 232 corresponding to an obtainable skill and the skill display field 232 corresponding to an unobtainable skill are identifiably displayed. For example, the skill display field 232 corresponding to the obtained skill and the skill display field 232 corresponding to the base skill that cannot be obtained due to a shortage of skill points are grayed out (indicated by cross-hatching in the diagram). In the skill display field 232 corresponding to the obtained skill, an icon indicating “obtained” is displayed instead of the required point display portion 233.

Below the skill display region 231, a confirmation operation portion 235a, a reset operation portion 235b, and a return operation portion 235c are provided. When the confirmation operation portion 235a is operated in a state where any one of the skills is in a selected state, a confirmation screen (not illustrated) is displayed. When a predetermined operation for obtaining a skill is input on the confirmation screen, obtained information is associated with the skill in the selected state. That is, the base skill is updated to an obtained skill.

For example, it is assumed that a skill corresponding to the skill display field 232 displayed at the top row of the skill display region 231 is obtained in the state illustrated in FIG. 54A. In this case, in conjunction with the skill being obtained, the skill screen 230 is updated as illustrated in FIG. 54B. Here, the skill display field 232 displayed at the top row of the skill display region 231 is grayed out. In the skill point display portion 214, the remaining skill points after obtaining the skill are displayed.

When the reset operation portion 235b is operated, the selected states of all the skills are canceled. When the return operation portion 235c is operated, the skill screen 230 is closed and the top screen 210 is displayed.

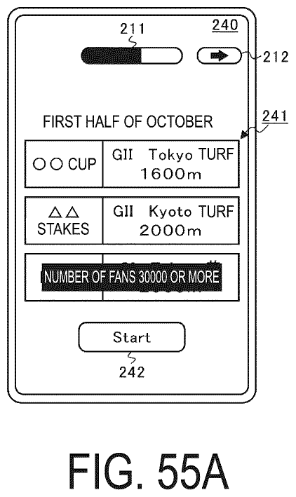

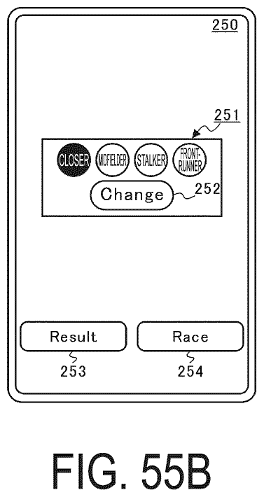

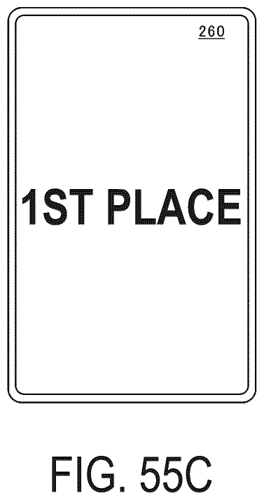

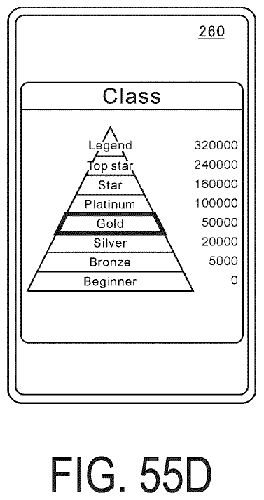

FIG. 55A is a first diagram for describing the race selection screen 240. When the race operation portion 215f of the top screen 210 is operated, the race selection screen 240 illustrated in FIG. 55A is displayed. Races have a game property in which the nurture target character races with non-player characters (hereinafter referred to as NPCs).

In the upper portion of the race selection screen 240, the energy display portion 211 and the mood display portion 212 are displayed. In addition, a race selection operation portion 241 for selecting a race event for the nurture target character to be entered in is displayed in a central portion of the race selection screen 240. In addition, a start operation portion 242 is displayed at a lower portion of the race selection screen 240. A race that can be selected via the race selection operation portion 241 of the race selection screen 240 is set in advance for each turn.

In addition, the race entry condition is set in advance for each race, and the player can only enter the nurture target character in a race with race entry conditions that are satisfied. As described above, a race may have the number of fans set as a race entry condition. For a race with a set number of fans that is not satisfied, as illustrated in FIG. 55A, the race selection operation portion 241 displays the race entry condition and notifies that the race cannot be selected. In the turn in which the target race of the clear goal is set, only the target race is displayed in a selectable manner on the race selection screen 240.

FIG. 55B is a diagram for describing the race start screen 250. When the start operation portion 242 is operated in a state where the race event of the race to enter is selected by the race selection operation portion 241, the race start screen 250 illustrated in FIG. 55B is displayed. A strategy display portion 251 is displayed at a central portion of the race start screen 250. In the strategy display portion 251, the currently selected strategy (closer, midfielder, stalker, front-runner) is highlighted. A change operation portion 252 is displayed in the strategy display portion 251. When the change operation portion 252 is operated, a strategy change screen (not illustrated) is displayed on the display 26. The player can change the strategy in the race to any strategy by an operation on the strategy change screen.

Further, at a lower portion of the race start screen 250, a result operation portion 253 and a race operation portion 254 are displayed. When the race operation portion 254 is operated, a race screen (not illustrated) is displayed on the display 26. On the race screen, a moving image of developments in the race (hereinafter also referred to as a race moving image) is displayed.

FIG. 55C is a first diagram for describing the race result screen 260. FIG. 55D is a second diagram for describing the race result screen 260. When playback of the race moving image described above ends and when the result operation portion 253 is operated, the race result screen 260 is displayed on the display 26. On the race result screen 260, as illustrated in FIG. 55C, the placing of the nurture target character in the race is displayed. Further, on the race result screen 260, as illustrated in FIG. 55D, the current class of the nurture target character is displayed.

In the present embodiment, the nurture target character is classified according to the number of fans obtained. A range of the number of fans is set for each class. Here, the nurture target character is classified into one of eight levels of classes according to the number of fans. On the race result screen 260, the cumulative number of fans obtained by adding the number of fans obtained in the current race to the number of fans obtained before is displayed. In addition, the current class corresponding to the cumulative number of fans is identifiably displayed.

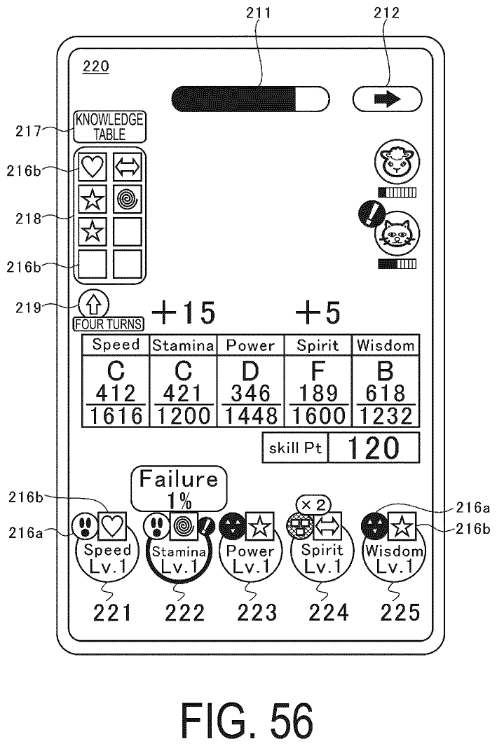

FIG. 56 is a third diagram for describing the training screen 220. As illustrated in FIG. 56, the first icon 216a and the second icon 216b are displayed in each of the speed operation portion 221, the stamina operation portion 222, the power operation portion 223, the spirit operation portion 224, and the wisdom operation portion 225. The knowledge table check icon 217, the effect display region 218, and the special effect icon 219 are displayed in the upper left portion of the training screen 220. Three types of the first icons 216a are provided, and six types of the second icons 216b are provided.

As described above, in the present embodiment, at the start of the turn, the game content is associated with each of the total of eight selection items of “rest”, “going out”, “race”, and the five training items. The game content is configured by a combination of a type of special character and a type of effect. Here, three types of special characters and a large number of effects roughly classified into six types are provided.

The special character itself or the effect itself associated with each selection item may be regarded as game content. Further, different special character IDs are set for the three types of special characters. In addition, any one type of the six types and a predetermined parameter are set for each effect. Then, a different effect ID is set for each combination of the type and the parameter. Since the special character ID or the effect ID is associated with the selection item, the special character ID or the effect ID itself may be regarded as game content.

In a turn in which training can be performed, the first icon 216a and the second icon 216b are always displayed in each of the speed operation portion 221, the stamina operation portion 222, the power operation portion 223, the spirit operation portion 224, and the wisdom operation portion 225. Basically, one piece of game content is arranged and associated with each training item. However, when a predetermined condition is satisfied, two pieces of game content may be associated with one training item. At this time, the two pieces of game content associated with the one training item are the same. That is, when the predetermined condition is satisfied, the number of pieces of game content associated with one training item is doubled.

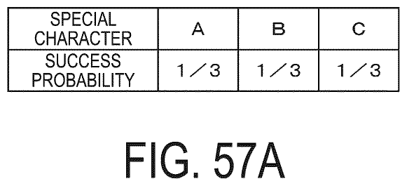

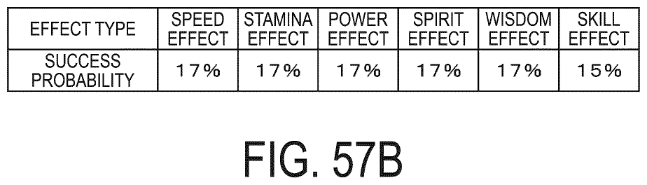

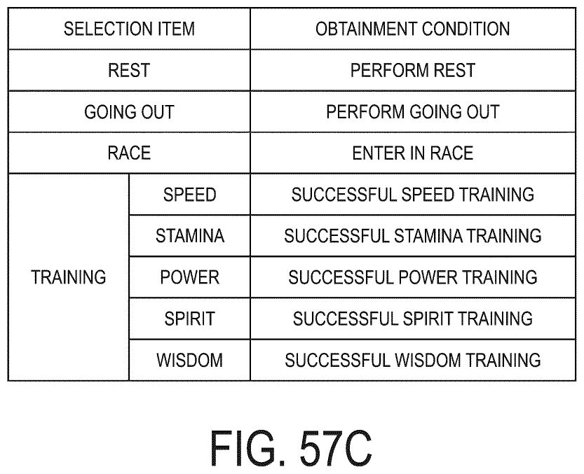

FIG. 57A is a diagram for describing the relationship between a special character and game content. The nurture main game has a story component, and the nurture main game progresses in accordance with the story. Three special characters A, B, and C appear in the story. Thus, during the nurture main game, a performance in which the three special characters are displayed occurs in various scenes. Images corresponding to the special characters A, B, and C are displayed at the three types of the first icons 216a, respectively.

As described above, each of the three special characters is associated with a special character ID that is a first attribute. Then, at the start of the turn, the type of the special character to be arranged at each selection item, that is, the special character ID, is determined. Here, as illustrated in FIG. 57A, the success probabilities of the special characters A, B, and C are all set to ⅓. Then, when the special character to be arranged at the selection item is determined, the type of the effect, which is the second attribute, that is, the effect ID, is determined.

FIG. 57B is a diagram for describing the relationship between an effect and game content. In the present embodiment, as effects arranged at the respective selection items, a speed effect, a stamina effect, a power effect, a spirit effect, a wisdom effect, and a skill effect are provided. As will be described in detail later, when game content is obtained, the game content is in a possession state. While the game content is possessed, the effect of the game content is activated.

At this time, if the speed effect is activated, the value of the speed ability parameter that increases when training is successful is increased. Similarly, when the stamina effect, the power effect, the spirit effect, and the wisdom effect are activated, the values of the stamina, power, spirit, and wisdom ability parameters that increase when training is successful are increased. In addition, when the effect of the skill is activated, the value of the skill point obtained when the training is successful is increased.

As described above, the type of the effect and the information indicating the content of the effect such as the parameter are set in the effect ID. For example, for an effect ID of 0001, a speed effect is set as the type of effect, and the increase value “+1” for the speed ability parameter is set as the parameter. Also, for an effect ID of 0002, a speed effect is set as the type of effect, and the increase value “+2” for the speed ability parameter is set as the parameter. Further, for an effect ID of 0011, a stamina effect is set as the type of effect, and the increase value “+1” for the stamina ability parameter is set as the parameter.

Thus, although there are six types of effects, there are more effect IDs than the types of effects. However, the second icons 216b are provided at the same number as the types of the effects, and the types of the effects can be identified by the second icons 216b.

At the start of the turn, the type of the effect to be arranged at each selection item, that is, the effect ID, is determined. Here, as illustrated in FIG. 57B, the success probabilities of the speed effect, the stamina effect, the power effect, the spirit effect, and the wisdom effect are all set to 17%, and the success probability of the skill effect is set to 15%.

In this manner, at the start of the turn, as the game content, the type of special character and the type of effect are associated with each selection item. Then, on the top screen 210 or the training screen 220, the first icon 216a corresponding to the special character and the second icon 216b corresponding to the effect are superimposed and displayed on each operation portion. Thus, the player may comprehend in advance the game content that may be obtained by selecting each selection item via the first icon 216a and the second icon 216b.

Here, as an example of a method of determining the game content, a case where the type of the special character and the type of the effect are separately determined has been described. However, the method of determining the game content is not limited thereto. For example, a game content ID may be provided for each combination pattern of special character and effect. In this case, the game content ID may be determined through a lottery for each selection item.

FIG. 57C is a diagram for describing an obtainment condition for game content. As illustrated in FIG. 57C, the obtainment condition for the game content is set in advance for each selection item. For the rest, going out, and race, selection of each selection item is set as an obtainment condition. In other words, for the rest, going out, and race, the obtainment condition is set to be that these selection items are selected and the turn is ended.

On the other hand, for all of the five training items, success in the selected training is set as an obtainment condition. Thus, when the training is selected and executed but the training fails, the game content cannot be obtained.

However, the above-described obtainment conditions are merely examples. For example, when rest or going out is selected, the game content may be obtained only at a predetermined probability. Further, for example, when race is selected, the game content may be obtained by winning the race. Also, when training is selected, the game content may be obtained regardless of success and failure. Here, the game content is associated with the selection item of race, but the game content may be associated with each type of race.

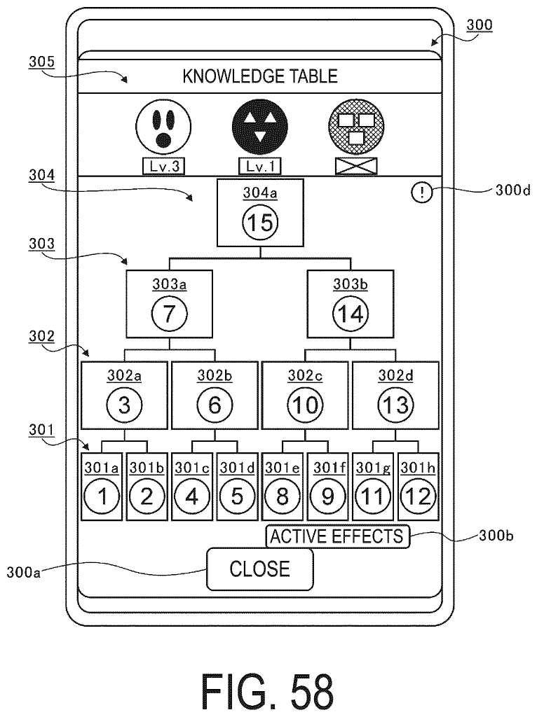

FIG. 58 is a first diagram for describing the knowledge table dialog 300. When the knowledge table check icon 217 is operated on the top screen 210 or the training screen 220, the knowledge table dialog 300 is displayed. Here, a game property of the present embodiment will be described using the knowledge table dialog 300. The knowledge table dialog 300 includes the fragment display region 301, the first crystal display region 302, the second crystal display region 303, and the Goddess' Wisdom display region 304.

The fragment display region 301 includes the eight icon display portions 301a, 301b, 301c, 301d, 301e, 301f, 301g, and 301h. The eight display portions of the fragment display region 301 are displayed in alignment in the left-right direction. The first crystal display region 302 is provided above the fragment display region 301. The first crystal display region 302 includes the four icon display portions 302a, 302b, 302c, and 302d. The four display portions of the first crystal display region 302 are displayed in alignment in the left-right direction.

The second crystal display region 303 is provided above the first crystal display region 302. The second crystal display region 303 includes the two icon display portions 303a and 303b. The two display portions of the second crystal display region 303 are displayed in alignment in the left-right direction. The Goddess' Wisdom display region 304 is provided above the second crystal display region 303. The Goddess' Wisdom display region 304 includes the one icon display portion 304a. Thus, a total of 15 display portions are provided in the knowledge table dialog 300.

When the nurture target character obtains the game content, the first icon 216a and the second icon 216b corresponding to the obtained game content are displayed on any of the display portions of the fragment display region 301. Here, each time game content is obtained, the first icon 216a and the second icon 216b are displayed in order from the icon display portion 301a to the icon display portion 301h (left to right) in the fragment display region 301.

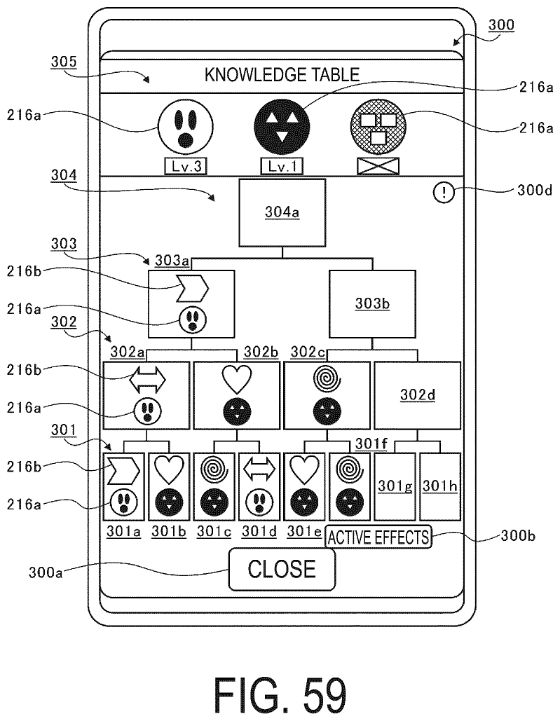

FIG. 59 is a second diagram for describing the knowledge table dialog 300. When the nurture target character obtains the first game content, the first icon 216a and the second icon 216b are displayed at the icon display portion 301a. In this example, to facilitate understanding, the first icon 216a is displayed at each display portion, but displaying the first icon 216a is not essential.

However, in the knowledge table dialog 300, special characters associated with game content are preferably identifiable. Thus, for example, when the first icon 216a is not displayed, colors such as red, blue, and green may be associated with the three special characters as image colors. Then, the display portion where the second icon 216b is displayed is displayed in the image color of the special character associated with the obtained game content. In this manner, the special character associated with the obtained game content can be identified.

While the first icon 216a and the second icon 216b are displayed at the icon display portion 301a, an effect corresponding to the obtained game content is activated. Accordingly, when the nurture target character obtains the game content and the first icon 216a and the second icon 216b are displayed at the icon display portion 301a, the first effect is activated.

Here, game content that is arranged at the selection item and obtained by the nurture target character is referred to as a knowledge fragment. That is, the nurture target character possesses the game content obtained by the selection of the command as a knowledge fragment. It is assumed that the nurture target character newly obtains game content in the next turn or later in a state of possessing the first knowledge fragment. In this case, the nurture target character is in a state of possessing two knowledge fragments, and the first icon 216a and the second icon 216b are displayed at the icon display portion 301b. Thus, in this state, the effect of the first knowledge fragment and the effect of the second knowledge fragment are activated.

While the nurture target character possesses the knowledge fragment, the effect of the knowledge fragment is activated. When the number of knowledge fragments possessed is an even number, one piece of game content is newly generated, triggered by possession of the knowledge fragment. The game content generated at this time is configured by a special character ID and an effect ID, similarly to the knowledge fragment. Here, the game content generated with possession of the knowledge fragment as a trigger is referred to as a first crystal.

For example, when the nurture target character possesses a second knowledge fragment, the first first crystal is generated. The nurture target character takes possession of the generated first crystal. The first crystal (game content) is associated with a special character and an effect, and the first icon 216a and the second icon 216b are displayed at the icon display portion 302a of the first crystal display region 302.

When the second icon 216b is displayed at the display portion of the first crystal display region 302, the effect corresponding to the displayed second icon 216b is activated. That is, when the second knowledge fragment is possessed, the effect associated with the second knowledge fragment and the effect associated with the first first crystal are simultaneously active.

In FIG. 58, the numbers 1 to 15 displayed in the respective display portions indicate the order in which the second icons 216b and the like are displayed. As described above, when the first game content is obtained, the first icon 216a and the second icon 216b are displayed at the icon display portion 301a. Thereafter, when the second game content is obtained, the first icon 216a and the second icon 216b are displayed at the icon display portion 301b. At this time, the first crystal is generated, triggered by the obtainment of the second game content.

Further, as illustrated in FIG. 59, when the third game content is obtained, the second icon 216b is displayed at the icon display portion 301c. Thereafter, when the fourth game content is obtained, the second icon 216b is displayed at the icon display portion 301d. At this time, a second first crystal is generated based on obtainment of the fourth game content in the same manner as described above. When the second first crystal is generated, the second icon 216b is displayed at the icon display portion 302b of the first crystal display region 302.

When the number of first crystals possessed is an even number, one piece of game content is newly generated. Here, the game content generated with possession of an even-numbered first crystal as a trigger is referred to as a second crystal. The second crystal is associated with a special character and an effect in a similar manner to the first crystal. Thus, the first icon 216a and the second icon 216b corresponding to the special character and the effect are displayed at the icon display portion 303a of the second crystal display region 303.

As in the case of the knowledge fragment and the first crystal, a state in which a second crystal, from among the generated second crystals, has an activated effect is defined as the possession state. In other words, when the nurture target character possesses the second crystal, the effect associated with the possessed second crystal is active.

When the second icon 216b is displayed at the display portion of the second crystal display region 303, the effect corresponding to the displayed second icon 216b is activated. That is, when the fourth knowledge fragment is obtained, the effect associated with the fourth knowledge fragment, the effect associated with the second first crystal, and the effect associated with the first second crystal are simultaneously active.

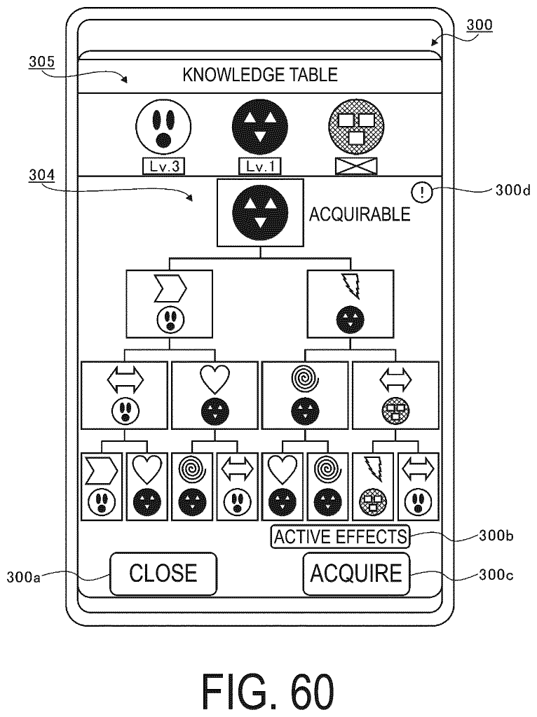

FIG. 60 is a third diagram for describing the knowledge table dialog 300. When the fifth to eighth game content (knowledge fragments) are obtained via selection of a command, the first crystal and the second crystal are generated in the same manner as described above. When the eighth knowledge fragment is possessed, the second second crystal is generated, and the second icon 216b is displayed at the icon display portion 303b of the second crystal display region 303.

When the number of second crystals possessed is an even number, one piece of game content is generated from the two second crystals possessed. Here, the game content generated based on the two second crystals is referred to as the Goddess' Wisdom. One of the three special characters is associated with the Goddess' Wisdom. The first icon 216a corresponding to the special character associated with the Goddess' Wisdom is displayed at the icon display portion 304a of the Goddess' Wisdom display region 304. That is, it can be said that three types of Goddess' Wisdom are provided for each special character.

Note that a special effect is associated with the Goddess' Wisdom, and the special effect is activated when a predetermined activation condition described later is satisfied. The player can activate the special effect at any timing. That is, even if the Goddess' Wisdom is generated, the special effect is not activated until the activation condition is satisfied. In the following, the state of the Goddess' Wisdom in which the special effect is not activated is referred to as the possession state.

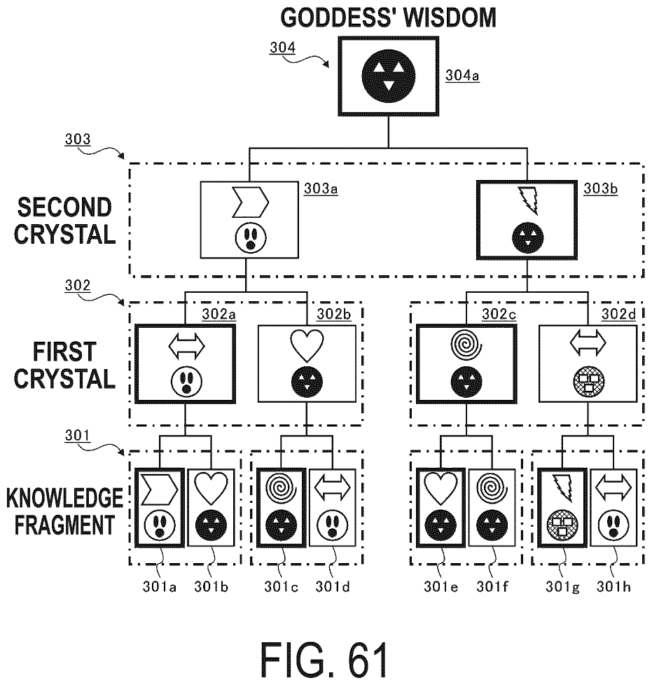

FIG. 61 is a diagram for describing a method of determining the game content. The display portions constituting the knowledge table dialog 300 are divided into a plurality of groups as indicated by the dot-dash lines in FIG. 61. Specifically, in the fragment display region 301, a display portion in which the first icon 216a and the second icon 216b are displayed in an odd-numbered order and, next to this, a display portion in which the first icon 216a and the second icon 216b are displayed form one group. Thus, the eight display portions of the fragment display region 301 are classified into four groups.

Similarly, the first crystal display region 302 is divided into two groups as indicated by the dot-dash lines in the diagram. In addition, one group including the icon display portions 303a and 303b is formed in the second crystal display region 303. That is, two display portions are always classified into each group. When the game content is obtained, the first icon 216a and the second icon 216b corresponding to the obtained game content are displayed at the display portion. Thus, the obtained game content is classified into any one of the groups. Then, two pieces of game content always belong to each group.

Here, the first crystal is generated with one knowledge fragment of the two knowledge fragments belonging to one group as a parent. Specifically, when the game content is stored as a knowledge fragment, the special character ID and the effect ID are stored as described above. At this time, priority information is associated with both of these IDs. Here, the priority information may include information based on the order in which the game content is stored as a knowledge fragment, or information based on a storage area where the game content is stored.

For example, a maximum of eight knowledge fragments can be possessed at the same time. Thus, as the information based on the order in which the game content is stored as a knowledge fragment, information capable of identifying any one of the first to eighth pieces of game content is associated with the game content. Further, for example, eight storage areas, a first storage area to an eighth storage area corresponding to the icon display portion 301a to the icon display portion 301h, are provided. Information indicating the addresses of these storage areas may be associated with the game content as information based on the storage area where the game content is stored.

Then, based on the priority information, any one of the plurality of pieces of game content is determined as priority game content. Here, game content associated with information indicating that the order of storage is an odd number or information indicating that the number of the storage area where the game content is stored is an odd number as the priority information is determined as the priority game content.

Thus, in the fragment display region 301, the game content corresponding to the display portion located relatively on the left side among the two display portions belonging to one group is set as the priority game content. In other words, the game content having an odd number in the stored order is determined as the priority game content. In addition, the game content stored in the odd-numbered storage area is determined as the priority game content.

The first crystal is generated and inherits the parameter of the knowledge fragment determined as the priority game content among the two knowledge fragments (game content). Here, the parameter inherited from the knowledge fragment to the first crystal is the type of the special character, that is, the special character ID. Thus, as is clear from FIG. 61, the same first icon 216a is displayed at the icon display portion 302a and the icon display portion 301a. Similarly, the same first icon 216a is displayed at the icon display portion 302b and the icon display portion 301c, the icon display portion 302c and the icon display portion 301e, and the icon display portion 302d and the icon display portion 301g.

On the other hand, of the first crystals, the type of the effect is determined through a lottery. Here, the type of the effect is determined for the first crystal with the probability indicated in FIG. 57B, which is the same as when the game content to be arranged in each selection item is determined. However, the success probability of each type of effect may be different between the knowledge fragments and the first crystals.

The parameters inherited from the knowledge fragment to the first crystal may be both the special character ID and the effect ID. Further, for example, the parameter inherited from the knowledge fragment to the first crystal may be only the effect ID.

In addition, the second crystal is generated and inherits the parameter of the first crystal determined as the priority game content among the two first crystals (game content). Here, similarly to the knowledge fragment, the first crystal having an odd-numbered storage order among the first crystals is determined as the priority game content. Then, the special character ID associated with the first crystal determined as the priority game content is inherited by the second crystal. Thus, as illustrated in FIG. 61, the same first icon 216a as in the icon display portions 302a and 302c is displayed in the icon display portions 303a and 303b.

Note that of the second crystals, the type of the effect is determined through a lottery. Here, the type of effect is determined for the second crystal with the probability indicated in FIG. 57B, in a similar manner to the first crystal. However, the success probability of the type of effect of the second crystal may be different between the knowledge fragments and the first crystals.

For example, the special character ID of the knowledge fragment determined as the priority game content may be inherited by the first crystal, and the effect ID of the first crystal determined as the priority game content may be inherited by the second crystal. Alternatively, both the special character ID and the effect ID of the first crystal determined as the priority game content may be inherited by the second crystal.

That is, in the present embodiment, the parameter inherited from the knowledge fragment to the first crystal is the same as the parameter inherited from the first crystal to the second crystal. However, some or all of the parameters inherited from the knowledge fragment to the first crystal may be different from the parameters inherited from the first crystal to the second crystal.

Then, the special character associated with one of the two second crystals is inherited by the Goddess' Wisdom. In other words, the type of the Goddess' Wisdom is determined based on the special characters associated with the two second crystals.

Here, of the special characters associated with the two second crystals, the special character that is associated with the largest number of knowledge fragments is inherited by the Goddess' Wisdom. Take, for example, the example illustrated in FIG. 61 in which three special characters A (white characters in the diagram), four special characters B (black characters in the diagram), and one special character C (cross-hatched character in the diagram) are associated with a knowledge fragment (as game content). In this example, the special character B is associated with the largest number of knowledge fragments.

However, the special character B is not associated with the second crystal. Thus, the special character B is not inherited by the Goddess' Wisdom. In this example, of the special characters A and C associated with the second crystal, the special character A is associated with more knowledge fragments than the special character C. Thus, the Goddess' Wisdom is associated with the special character A.

In this manner, in the present embodiment, a plurality of the first crystals and second crystals are generated by executing processing of generating the first crystals and second crystals (second game content) from a plurality of the knowledge fragments (first game content) a plurality of times. Then, a special character (third parameter) associated with the Goddess' Wisdom is determined based on the special character (first parameter) associated with the knowledge fragment corresponding to each of the plurality of first crystals and second crystals.

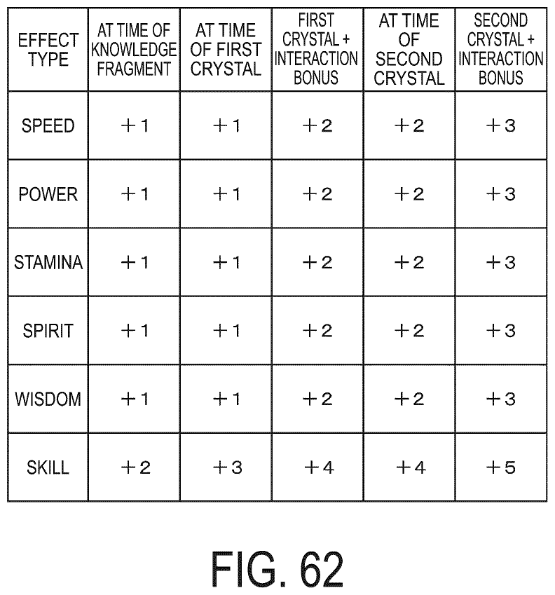

FIG. 62 is a diagram for describing the effect of the game content. As described above, the effects associated with the game content include six types of effects, that is, a speed effect, a power effect, a stamina effect, a spirit effect, a wisdom effect, and a skill effect. Then, when the game content is possessed as the knowledge fragment, the first crystal, and the second crystal, the effect associated with the possessed game content is activated. As illustrated in FIG. 62, in a case where a knowledge fragment or first crystal associated with the speed effect is possessed, the speed parameter is increased by “1” when the speed training is successful. Thus, for example, when three knowledge fragments or first crystals associated with the speed effect are possessed, t the speed parameter is increased by “3”.

Here, the parameter of the knowledge fragment determined as the priority game content among the two knowledge fragments (game content) belonging to the same group is inherited by the first crystal. At this time, when the special characters associated with the two knowledge fragments (game content) belonging to the same group are different, an interaction bonus is granted.

Specifically, it is assumed that special characters associated with two knowledge fragments belonging to the same group correspond to the special character A and the special character B. In this manner, in a case where the special characters associated with the two knowledge fragments that are parents of the first crystal are different from each other, an interaction bonus is granted. When the player possesses the first crystal associated with the speed effect and an interaction bonus is granted, the speed parameter is increased by “2” when the speed training is successful.

Also, in a case where the second crystal associated with the speed effect is possessed, the speed parameter is increased by “2” when the speed training is successful. In addition, the special character of the first crystal determined as the priority game content among the two first crystals belonging to the same group is inherited by the second crystal. At this time, when the special characters associated with the two first crystals belonging to the same group are different, an interaction bonus is granted in a similar manner to as described above. When the player possesses the second crystal associated with the speed effect and an interaction bonus is granted, the speed parameter is increased by “3” when the speed training is successful.

Further, for the power effect, the stamina effect, the spirit effect, and the wisdom effect, as with the speed effect described above, the effect is set such that the parameter increases as illustrated in FIG. 62 when the training for power, stamina, spirit, and wisdom is successful. In addition, the skill effect is set with the effect of the skill points obtained when the training is successful being increased as illustrated in FIG. 62 regardless of the training item.

Although the interaction bonus is provided here, the interaction bonus is not essential. In addition, here, the effect of the game content is greater for the second crystal compared to the knowledge fragment. However, conversely, the effect of the game content may be greater at the time of the knowledge fragment compared to at the time of the second crystal, or the effect may be the same in all states.

As illustrated in FIG. 60, the knowledge table dialog 300 is provided with the close operation portion 300a and the check effect operation portion 300b. When the close operation portion 300a is operated, the knowledge table dialog 300 is hidden. When the check effect operation portion 300b is operated, an active effect list dialog (not illustrated) is displayed. In the active effect list dialog, all the effects that are currently activated by possessing knowledge fragments, first crystals, and second crystals are displayed.

As illustrated in FIG. 60, in a state where the first icon 216a or the second icon 216b are displayed at all of the display portions, that is, in a state where the user possesses the Goddess' Wisdom, “Acquirable” is displayed at the Goddess' Wisdom display region 304. This indicates to the player that the Goddess' Wisdom is acquirable. In the state of possessing the Goddess' Wisdom, the acquiring operation portion 300c is provided at the knowledge table dialog 300. When the acquiring operation portion 300c is operated, a confirmation screen (not illustrated) is displayed. When a predetermined operation is input on the confirmation screen, the special effect of the Goddess' Wisdom is activated. Hereinafter, the input of the predetermined operation on the confirmation screen is referred to as acquiring the Goddess' Wisdom.

When the Goddess' Wisdom is acquired, the special effect is activated. In the present embodiment, even after the special effect is activated by acquiring the Goddess' Wisdom, the effects of all of the possessed game content (the knowledge fragments, the first crystals, and the second crystals) are retained. Thus, after acquiring the Goddess' Wisdom, the effect of the training from the effects becomes extremely large.

Note that the player can acquire the Goddess' Wisdom at any timing. Thus, the player can continue the possession state of the Goddess' Wisdom over a plurality of turns. However, in the possession state of the Goddess' Wisdom, the game content is not arranged in the selection items and new game content cannot be obtained.

Here, the special character is associated with an inheritance level as a parameter. When the Goddess' Wisdom is acquired, the inheritance level of the special character associated with the acquired Goddess' Wisdom rises. The special character display region 305 is provided in the upper portion of the knowledge table dialog 300. In the special character display region 305, the first icon 216a indicating each special character and the current inheritance level of the special character are displayed.

The initial inheritance level of the special character is set to “0”. Then, each time the Goddess' Wisdom is acquired, the inheritance level is raised by “1”. However, an upper limit is set for the inheritance level of the special character. Here, “5” is the upper limit of the inheritance level.

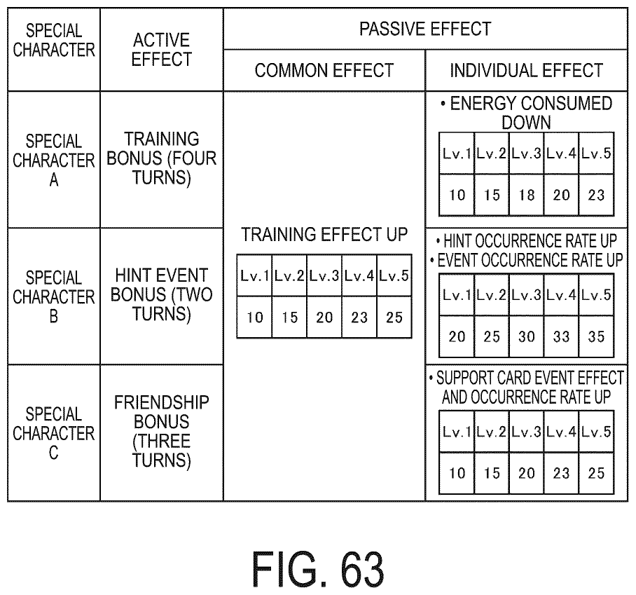

FIG. 63 is a diagram for describing special effects. Special effects are set for each type of the Goddess' Wisdom. In other words, a special effect is provided for each special character. That is, when the Goddess' Wisdom is acquired, the special effect corresponding to the special character associated with the acquired Goddess' Wisdom is activated. As illustrated in FIG. 63, the special effects include active effects and passive effects. The active effects are time-limited effects with a set effective period. The passive effects are effects that are permanently active until the nurture main game ends.

Here, a different active effect is set for each special character. Specifically, a training bonus is set as an active effect for the special character A. The training bonus is a bonus that sets the training level to the maximum (here, “5”). Here, four turns are set as the effective period of the training bonus.

In addition, a hint event bonus is set as an active effect for the special character B. The hint event bonus is a bonus that increases the probability of occurrence of a hint event. In addition, when the hint event bonus is activated, a predetermined parameter is increased when the hint event occurs. Here, two turns are set as the effective period of the hint event bonus.

Further, a friendship bonus is set as an active effect for the special character C. The friendship bonus is a bonus that enables friendship training to occur regardless of the favored training of the placed support character. In this case, three turns are set as the effective period of the friendship bonus.

The content of the active effects and the effective periods illustrated in FIG. 63 are merely examples. The active effect set for the special character, that is, the Goddess' Wisdom, may be common to all of the special characters. The active effects do not necessarily have to be time-limited effects.

Passive effects include common effects and individual effects. The common effects are effects that are active in common for all special characters. Here, as a common effect, an effect of increasing the increase value of an ability parameter when training is successful is provided. Specifically, the increase value of the ability parameter when training is successful is calculated based on a predetermined arithmetic formula. A correction value corresponding to the level of the special character is input to the arithmetic formula. When the input correction value is larger, the increase value of the ability parameter when the training is successful is larger.

Here, as illustrated in FIG. 63, the higher the level of the special character, the higher the correction value, that is, the higher the increase value of the ability parameter when the training is successful. For example, when the level of the special character A is “1” and the levels of the special characters B and C are “0”, the correction value is “10”. For example, when the levels of the special characters A, B, and C are all “5”, the correction value is “75”.

Note that in this example, the correction values corresponding to the three special characters are added. However, the correction values corresponding to the three special characters may be multiplied. Further, as a common effect, a predetermined correction value may be directly added to the increase value of the ability parameter when the training is successful, instead of the correction value being input into the arithmetic formula.

An individual effect is an effect set for each special character, similarly to an active effect. An individual effect of decreasing energy consumed is set to the special character A. Decreasing energy consumed is an effect of reducing the energy consumed during executing training. Here, a correction value corresponding to the level of the special character is input to the arithmetic formula for calculating the energy consumed. At this time, the larger the input correction value is, the smaller the consumption value of the energy parameter during executing training is.

The special character B is set with the individual effect of increasing the hint occurrence rate and the event occurrence rate. The hint occurrence rate increase and the event occurrence rate increase are effects of increasing the occurrence rates of the hint event and the predetermined event that may occur each turn. Here, a correction value corresponding to the level of the special character is input to the arithmetic formula for determining whether each event occurs. At this time, the larger the input correction value is, the higher the occurrence rate of each event is.

The special character C is set with the individual effects of increasing the effect and occurrence rate of a support card event. Increasing the effect and occurrence rate of a support card event is effects of increasing the occurrence rate of a support event that may occur each turn and increasing the effect granted upon occurrence. Here, a correction value corresponding to the level of the special character is input to the arithmetic formula for determining whether a support event occurs. At this time, the larger the input correction value is, the higher the occurrence rate of a support event is.

Note that the contents of the passive effects illustrated in FIG. 63 are merely examples. For example, as the passive effect set for the special character, that is, the Goddess' Wisdom, only the common effects may be provided, or only the individual effects may be provided. In addition, in this example, the active effects and the passive effects are provided as the special effects. However, only one of the active effects and the passive effects may be provided as special effects. Alternatively, the player may be able to select a special effect to be activated from among a plurality of special effects.

As described above, when the Goddess' Wisdom is acquired, the active effect is active only during the predetermined effective period, but the passive effect is active until the nurture game has ended. Then, at the same time as the effective period ends and the active effect is deactivated, all the knowledge fragments, the first crystals, and the second crystals possessed are reset. That is, the possession state of the knowledge fragments, the first crystals, and the second crystals is removed when the effective period of the active effect of the Goddess' Wisdom expires. Thus, the effects of the knowledge fragments, the first crystals, and the second crystals are deactivated by the effective period of the active effect of the Goddess' Wisdom expiring.

When all of the possessed knowledge fragments, first crystals, and second crystals are reset, the first icon 216a and the second icon 216b are all removed from the knowledge table dialog 300. When the active effect of the Goddess' Wisdom is deactivated due to the expiration of the effective period, the nurture target character can obtain game content again.

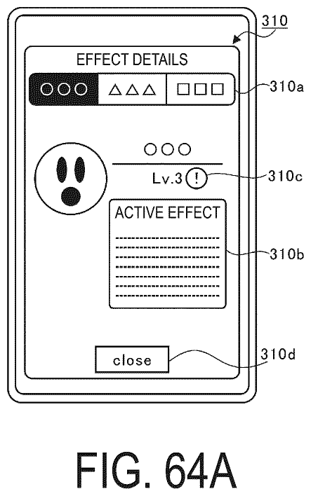

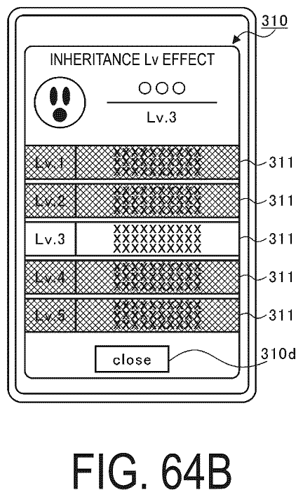

FIG. 64A is a first diagram for describing the effect details dialog 310. FIG. 64B is a second diagram for describing the effect details dialog 310. In the knowledge table dialog 300, when the special character display region 305 (see FIG. 60) is operated, the effect details dialog 310 is displayed. The effect details dialog 310 is provided with the switching tab 310a for switching the type of the special character. The switching tab 310a displays the names of the three special characters.

When a special character is selected in the switching tab 310a, a description of the active effects set for the selected special character is displayed in the effect description field 310b of the effect details dialog 310. In addition, the information icon 310c is provided in the effect details dialog 310. When the information icon 310c is operated, as illustrated in FIG. 64B, the level-based effect field 311 is displayed in the effect details dialog 310.

In the level-based effect field 311, descriptions of the passive effects corresponding to the respective inheritance levels from inheritance level 1 to inheritance level 5 are displayed. In the effect details dialog 310, the level-based effect field 311 corresponding to the inheritance level of the current special character are highlighted. Here, the level-based effect fields 311 corresponding to the inheritance level other than the inheritance level of the current special character are grayed out. The effect details dialog 310 is provided with the close operation portion 310d. When the close operation portion 310d is operated, the knowledge table dialog 300 is displayed on the display 26.

The effect details dialog 310 allows the player to easily comprehend the special effects from the Goddess' Wisdom. This improves the user-friendliness for the player. As illustrated in FIG. 60, the history icon 300d is provided in the knowledge table dialog 300. When the history icon 300d is operated, the history dialog 315 is displayed.

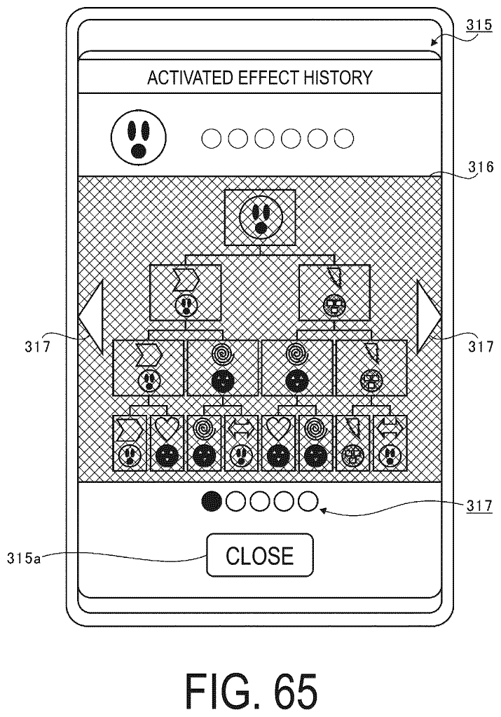

FIG. 65 is a diagram for describing the history dialog 315. The history dialog 315 displays a knowledge table corresponding to the Goddess' Wisdom acquired so far. For example, in the nurture main game, when the player has acquired the Goddess' Wisdom five times, this means that the knowledge table has been reset five times. The history dialog 315 displays the previous knowledge table 316 listing the process until the generation of the Goddess' Wisdom and the reset game content.

Here, as indicated by cross-hatching in the figure, the previous knowledge table 316 is grayed out. By displaying the previous knowledge table 316 in a grayed-out manner, the possibility that the player misrecognizes the previous knowledge table 316 as the current knowledge table is reduced. When there are a plurality of previous knowledge tables 316, the switching operation portions 317 are provided on the left, right, and lower side of the previous knowledge table 316. The player can change the previous knowledge table 316 displayed in the history dialog 315 by operating the switching operation portions 317.

The Goddess' Wisdom generated in the previous knowledge table 316 currently displayed in the history dialog 315 is displayed in an identifiable manner above the previous knowledge table 316. The close operation portion 315a is provided below the history dialog 315. When the close operation portion 315a is operated, the history dialog 315 is closed and the knowledge table dialog 300 is displayed. In this manner, the history dialog 315 allows the player to check the effects that were activated previously, thereby improving the user-friendliness for the player.

As described above, according to the present embodiment, game content associated with a selection item is obtained by a player selection. Then, the type of the Goddess' Wisdom, that is, the content of the special effect, is determined according to the obtained game content. The player can discretionarily select the timing of when to acquire the Goddess' Wisdom, that is, the timing of activating the special effect.

According to the present embodiment, the special character ID associated with the knowledge fragment whose stored order is an odd number is inherited by the first crystal. The special character ID associated with the first crystal whose stored order is an odd number is inherited by the second crystal. Thus, for example, the special character ID associated with the knowledge fragment stored first is inherited by both the first crystal and the second crystal. On the other hand, for example, the special character ID associated with the knowledge fragment stored second is not inherited by the first crystal.

In this manner, whether the special character associated with the obtained game content is inherited by the first crystal or the second crystal may be different depending on the storage order of the game content, that is, the obtainment timing of the game content. In addition, the player may confirm whether the game content to be obtained next is the priority game content via the knowledge table dialog 300.

Thus, the player can strategically determine the type of Goddess' wisdom that can be finally possessed. In other words, the player can strategically determine the type of special effect to be activated by acquiring the Goddess' wisdom. This increases the strategic performance required of the player, increases interest in the game, and increases the motivation of the player to play the game.

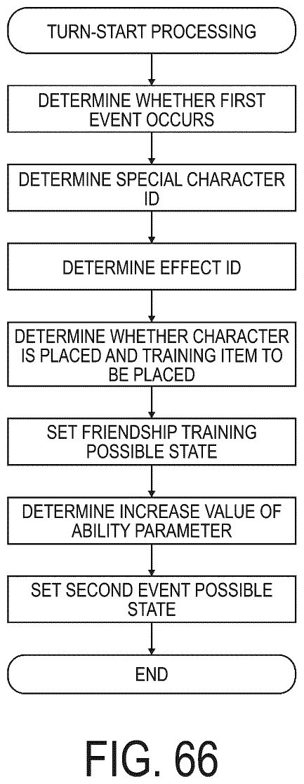

FIG. 66 is a diagram for describing a rough flow of turn-start processing. The nurture stage processing includes the turn-start processing executed at the start of each turn of the nurture game. Although the details of the turn-start processing will be described below, a rough flow of the turn-start processing will be described here.

During the nurture main game, processing of determining whether to cause various events to appear is executed in each turn. Events are roughly classified into three types: a scenario event, the above-described exclusive event provided for each nurture target character, and a support event. In each scenario, a scenario event, an exclusive event, and a support event that may appear in the nurture main game are predetermined.

A scenario event is an event set for each scenario of the nurture main game. In the present embodiment, a plurality of scenarios are provided, and the player can select a scenario. A scenario event appears for each scenario selected by the player. In other words, the scenario event that appears in the nurture main game is determined based on the scenario selected by the player.

The scenario event may include a scenario-specific event and a scenario-shared event. A scenario-specific event is an event associated with only one scenario. For example, a scenario-specific event associated with a first scenario appears only when the first scenario is selected and does not appear when another scenario is selected.

A scenario-shared event is an event that appears in common across a plurality of scenarios. Thus, the scenario-shared event appears in both cases when the first scenario is selected and when the second scenario is selected.

In this example, scenario-specific events and scenario-shared events are provided as scenario events. However, only one of the scenario-specific events and the scenario-shared events may be provided.

As described above, an exclusive event is an event set in advance for each character. In the nurture main game, an exclusive event for a character registered as a nurture target character by the player in the setting game, that is, the preparation stage processing, appears.

As described above, the support event is an event set in advance for each support card. In the nurture main game, a support event associated with the support card registered by the player in the setting game appears. The support event includes a first event that may occur at the start of a turn and a second event that may occur after training is performed. At the start of a turn, whether the first event occurs is determined based on a random number obtained at random and a first event table.

Whether the second event occurs is determined based on a randomly obtained random number and a second event table after the determination processing for each support character placed in the training is executed. Note that whether the second event occurs is determined for the placed support character only in a case where a support character is placed in training.

In the present embodiment, the first event may be selected by a support event associated with the support card selected through a lottery from among all of the support cards implemented into the game and is not limited to a support card registered in the deck by the player in the preparation stage processing. However, the selection probability of the support event associated with the support card registered in the deck is higher than the selection probability of the support card events associated with the support cards not registered in the deck.

As described above, whether a scenario event appears is determined based on the scenario. Also, whether an exclusive event and a support event appear is determined based on the nurture target character and the support card, respectively. These event types are classified by information that is referenced when whether an event appears is determined.

On the other hand, in the present embodiment, each event is classified into one of six event classifications according to the content brought about by the appearance of the event. Here, each event is classified into one of the event classifications including a first hint event, a second hint event, a first ability event, a second ability event, an aptitude event, and a story event.

As described above, the first hint event and the second hint event are events that make it possible to possess or obtain a skill. The first ability event and the second ability event are events for increasing or decreasing the ability parameter of the nurture target character. The aptitude event is an event for increasing or decreasing the aptitude parameter of the nurture target character. The story event is an event for displaying a story related to a character appearing in the nurture game. Note that story events may change an ability parameter or an aptitude parameter in addition to a story being displayed.

Here, the scenario event includes a first hint event, a second hint event, a first ability event, a second ability event, an aptitude event, and a story event. The exclusive event and the support event include a first hint event, a second hint event, a first ability event, and a second ability event. Note that the exclusive event may include a story event.

In the present embodiment, the turn-start processing includes processing of determining a scenario event and processing of determining an exclusive event. The processing of determining a scenario event and the processing of determining an exclusive event are not illustrated and described here. The turn-start processing includes “processing of determining whether or not a first event occurs”, “processing of determining a special character ID”, “processing of determining an effect ID”, “processing of determining whether a character is placed and the training item to be placed”, “processing of setting a friendship training possible state”, “processing of determining an increase value of an ability parameter”, and “processing of setting a second event possible state” as illustrated in FIG. 66. Although various other processing is executed in the turn-start processing, the processing illustrated in FIG. 66 will be sequentially described here.

### Processing of Determining Whether First Event Occurs

In the processing of determining whether the first event occurs, the first event to be caused to occur is determined through a lottery from among the support events associated with all of the support cards provided by the administrator. At this time, the success probability of a support event associated a support card registered in the deck by the player in the preparation stage processing is set to a high value.

### Processing of Determining a Special Character ID

As described above, at the start of the turn, any one of the six types of game content is arranged in each of the total of eight selection items including rest, going out, race, and the five training items. Here, for each selection item, first, one of three types of special characters, that is, special character IDs, is determined through a lottery. In the lottery for determining the special character ID, the success probability of each special character ID is set as illustrated in FIG. 57A.

Here, in one turn, all of the three special characters are always arranged in at least one selection item. For example, after the special characters to be arranged in the eight selection items are determined, it is confirmed whether all of the three special characters are arranged in any one of the selection items. At this time, if all of the three special characters are not arranged, processing of forcibly changing any of the selection items to a special character that is not arranged may be executed. Alternatively, the lottery for the game content may be repeated for all of the eight selection items until all of the three special characters are arranged.

### Processing of Determining Effect ID

When the special character ID is determined, next, the effect ID is determined. Here, one of six types of effect IDs is determined through a lottery for each selection item. In the lottery for determining the effect ID, the success probability of each effect ID is set as illustrated in FIG. 57B. Thus, the game content specified by the special character ID and the effect ID are arranged for the eight selection items.

### Processing of Determining Whether Character is Placed and Training Item to be Placed

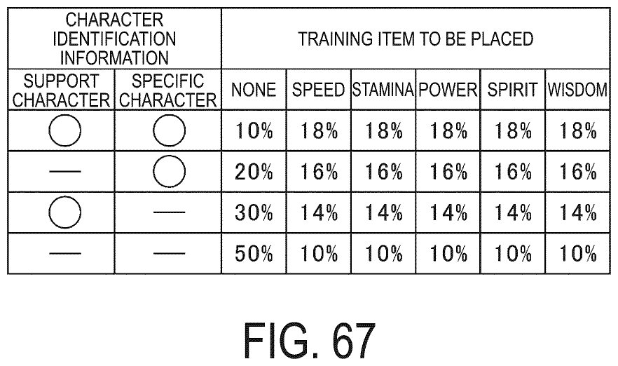

FIG. 67 is a diagram for describing the placing percentage for the training items. A placement determination table is stored in the player terminal 1 and the server 1000, and a training item in which a character is placed is determined based on the placement determination table. In the present embodiment, training items are determined for all support characters and story characters based on the character identification information.

Here, the placement determination table is provided for each piece of character identification information, and the placing percentage for each training item is different for each placement determination table. Specifically, according to the placement determination table for the support characters and the specific characters, the determination that the character is not placed in any training (“None” in the diagram) is set to 10%, and the determination that the character is placed in the training items of speed, stamina, power, spirit, and wisdom (“Speed”, “Stamina”, “Power”, “Spirit”, and “Wisdom” in the diagram) is set to 18%. The placement determination table for the support characters and the specific characters is used when the target character whose placement is to be determined is set as a support character and is set as a specific character.

Also, according to the placement determination table for the specific characters, the determination that the character is not placed in any training is set to 20%, and the determination that the character is placed in the training items of speed, stamina, power, spirit, and wisdom is set to 16%. The placement determination table for the specific characters is used when the target character is not set as a support character and is set as a specific character.

Also, according to the placement determination table for the support characters, the determination that the character is not placed in any training is set to 30%, and the determination that the character is placed in the training items of speed, stamina, power, spirit, and wisdom is set to 14%. The placement determination table for the support characters is used when the target character is set as a support character and is not set as a specific character.

Also, according to the placement determination table for other characters, the determination that the character is not placed in any training is set to 50%, and the determination that the character is placed in the training items of speed, stamina, power, spirit, and wisdom is set to 10%. The placement determination table for other characters is used when the target character is neither set as a support character nor a specific character. Note that the placement determination table for other characters may be used when the target character is a story character, for example.

Note that as described above, favored training is set for the support cards (support characters). When the target character is a support character, based on the placement determination table illustrated in FIG. 67, a change may be made so that the selection probability of the favored training set for the support card is increased. In addition, for example, an effect of increasing the placement probability for a predetermined training item may be associated with some or all of the support cards (support characters). For a support character associated with such an effect, changes are made to increase the placement probability in the predetermined training item.

Note that each training item is provided with an upper limit number for character placement. Here, “5” is set as the upper limit number for character placement for all of the training items. Thus, the number of placed characters placed in one training item is “5” at the maximum.

As described above, the training item to be associated with the character is determined for each character. At this time, the order of characters for determining a training item may be any order. Then, for example, in a case where placement of the upper limit number of placed characters has already been determined for a training item for which placement of a character has been determined, it may be determined that the character is not placed in any training item. Alternatively, the training item whose placement upper limit number has already been reached may be excluded from the lottery, and the placement probability of the other training items may be changed.

However, the placement upper limit number is not essential, and the placed character may be placed in the training item according to the lottery result. In addition, a method of determining a training item in which a character is placed is not particularly limited.

When the placed character is determined as described above, the placed character is associated with the training item. Then, the placement information in which the training item and the placed character are associated with each other is stored in the player terminal 1 and the server 1000.

### Processing of Setting Friendship Training Possible State

Referring back to FIG. 66, when the placement information is determined as described above, the friendship training possible state setting is performed. Specifically, a support character is extracted from the characters placed in the training item. Then, it is determined whether the setting condition for the friendship training possible state is satisfied for the extracted support character. As described above, here, the setting conditions for the friendship training possible state are that the training item in which the support character is placed is the favored training and that the bond parameter associated with the support character is equal to or greater than the predetermined value.

Then, the friendship training possible information is associated with the support character that satisfies the setting conditions for the friendship training possible state. Also, the friendship training possible information is associated with the training item in which the support character satisfying the setting conditions for the friendship training possible state is placed. Thus, the friendship training possible state is set.

### Processing of Determining Increase Value of Ability Parameter

In a turn in which training can be executed, an increase value of the ability parameter at the time of training success is determined for each training item.

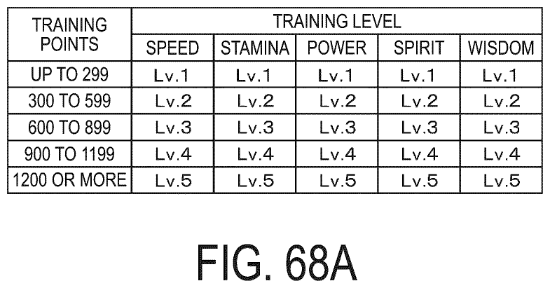

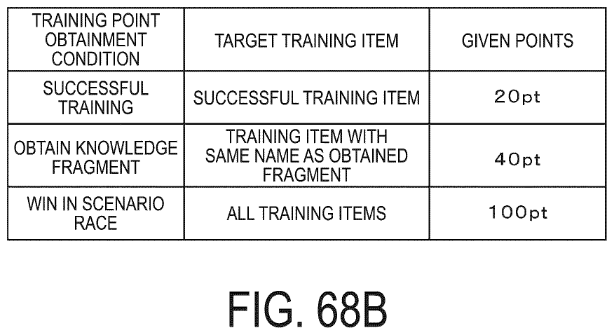

FIG. 68A is a diagram for describing training levels. FIG. 68B is a diagram for describing obtainment conditions for training points. As illustrated in FIG. 68A, the training level is set to increase in accordance with the training points obtained by the nurture target character. Specifically, the training points are provided for each of the five training items, namely, speed, stamina, power, spirit, and wisdom. That is, the nurture target character obtains five types of training points provided for the training items.

The training level of a training item having training points of 299 or less is set to “level 1”. In addition, the training level of a training item having training points of 300 to 599 is set to “level 2”, the training level of a training item having training points of 600 to 899 is set to “level 3”, the training level of a training item having training points of 900 to 1199 is set to “level 4”, and the training level of a training item having training points of 1200 or more is set to “level 5”.

The nurture target character obtains training points when any of the three obtainment conditions illustrated in FIG. 68B is satisfied. Specifically, when the training is successful, 20 training points are obtained for the successful training item. In addition, when the knowledge fragment is obtained, 40 training points are obtained for a training item with the same name as the effect of the obtained knowledge fragment. For example, when a knowledge fragment associated with a power effect is obtained, the nurture target character obtains 40 training points for power.

In addition, when the nurture target character wins a scenario race, 100 training points are obtained for all of the five types. As described above, in the present embodiment, the scenario race is executed three times after the end of a predetermined turn. In this scenario race, as with other races, the nurture target character competes with other characters for placings, and various race types such as short distance, mile, medium distance, and long distance are provided. Here, a race of the same type as the type of the distance which the nurture target character has run the most number of times up until the scenario race is held is determined as the race type of the scenario race.

Here, a case where the training level increases in accordance with training points has been described. However, the condition for increasing the training level is not limited thereto. For example, the training level may be increased or decreased by a lottery. Alternatively, the training level may be changed according to the turn number. Furthermore, the training level may increase in accordance with the number of times training has been performed. Note that the training level is not essential.

In the present embodiment, when the training selected by the player has been performed and has been successful, the value of a predetermined ability parameter is increased by the performed training item.

Specifically, in the present embodiment, when speed training is performed and it is successful, the values of the ability parameters for speed and power are increased.

In addition, when stamina training is performed and the training is successful, the values of the ability parameters for stamina and spirit are increased.

In addition, when power training is performed and the training is successful, the values of the ability parameters for stamina and power are increased.

In addition, when spirit training is performed and the training is successful, the values of the ability parameters for speed, power, and spirit are increased.

In addition, when wisdom training is performed and the training is successful, the values of the ability parameters for speed and wisdom are increased.

In the present embodiment, the value of the ability parameter to be increased when the training is successful is calculated by adding a value obtained by adding a fixed increase value determined corresponding to the performed training item and training level to a bonus additional value to be described below to the fixed increase value.

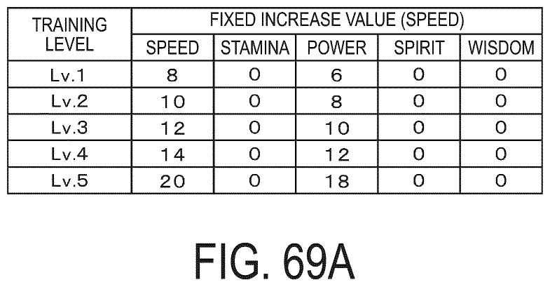

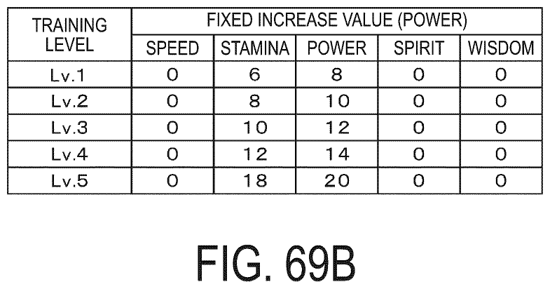

FIG. 69A is a diagram for describing a fixed increase value (speed) table. FIG. 69B is a diagram for describing a fixed increase value (power) table. That is, FIG. 69A indicates the fixed increase value when the training item is speed. Also, FIG. 69B indicates the fixed increase value when the training item is power.

As illustrated in FIGS. 69A and 69B, the fixed increase value table stores fixed increase values determined corresponding to the performed training item and the training level. Further, in the present embodiment, as illustrated in FIGS. 69A and 69B, the ability parameter is set to increase more as the training level is higher.

Although description is omitted here, fixed increase value tables in a case where stamina, spirit, and wisdom are selected as the training item are also provided.

In the present embodiment, a large number of additional conditions for the ability parameters are provided. An example of the additional conditions includes that the specific character or the support character is placed in the training item. In this case, a predetermined additional value is added to the fixed increase value. Further, for example, a growth rate may be set in advance for each training item for each nurture target character. In this case, the fixed increase value is multiplied by the growth rate for each training item.

Here, the effects of the knowledge fragments, the first crystals, and the second crystals and the special effect of the Goddess' Wisdom are included in the additional condition.

As described above, when the additional condition is satisfied, the additional value is added to the fixed increase value or the fixed increase value is multiplied by a predetermined addition rate. Then, the calculated value is finally multiplied by the friendship bonus addition rate. The friendship bonus addition rate is used when a friendship bonus possible state is set for the training item. In addition, the friendship bonus addition rate is calculated for each placed character placed in the training item.

In this example, the friendship bonus addition rate is 20%, and three placed characters for which the friendship bonus possible state is set are placed in the same training item. In this case, the friendship bonus addition rate is 60%. In this manner, the increase value of the ability parameter increases by being multiplied by the friendship bonus addition rate.

### Processing of Setting Second Event Possible State

Referring back to FIG. 66, a state in which a second event can occur is set for a support character placed in any of the training items. A second event is selected through a lottery from among the support events (second events) associated with the support characters (support cards) placed in the respective training items.

In the present embodiment, processing is executed to determine whether to set a second event possible state for all of the support characters placed in the training items. When the player selects the training in which the support character for which the second event possible state is set is placed, the second event occurs after the training is performed.

Note that the second event possible state may be set for each of a plurality of support characters placed in one training item. In this case, when the training is executed, only one of the second events for which the possible state is set may be executed. In addition, all the second events for which the possible state is set may be executed.

As described above, in the nurture main game, ability parameters of the nurture target character can be increased as the player progresses through the turns. The ability parameters increase with the success of training or the occurrence of various events. In the nurture main game, when all the turns are finished, the nurture game ends. If the goal set for each character is not achieved during the nurture main game, the nurture game ends at this point.

Here, when the nurture game ends, the nurture target character nurtured in the nurture game is stored as a nurtured character. More strictly, the information relating to the nurtured character nurtured in the nurture game (hereinafter referred to as nurtured character information) is stored in association with the player ID. The nurtured character information is stored in both the player terminal 1 and the server 1000. The nurtured character information stored in association with the player ID includes an ability parameter, an aptitude parameter, an obtained skill, inheritance information, and the like.

When the nurture game ends, the evaluation score of the nurtured character is calculated. Here, the evaluation score is calculated based on the ability parameters, the aptitude parameters, the obtained skills, race results, team race results, and the like at the end of the nurture game. Note that the method of calculating the evaluation score, in other words, a calculation formula for calculating the evaluation score, is prepared in advance, and the evaluation score is calculated based on a predetermined calculation formula. The calculation method and the calculation formula for the evaluation score are not particularly limited. For example, the evaluation score may be calculated based only on a parameter that affects a race result when a nurtured character has run in a race in a team competition game or another game, such as an ability parameter, an aptitude parameter, an obtained skill, or the like at the end of the nurture game.

A nurture rank is set for the nurtured character, based on the evaluation score. The nurture rank is an indicator of the strength of the nurtured character, and a range of evaluation score is associated with each nurture rank. For example, a nurture rank of “A+” is given to a nurtured character having an evaluation score ranging from 13000 to 14499, and a nurture rank of “S” is given to a nurtured character having an evaluation score ranging from 14500 to 15499. In this manner, by giving the nurture rank based on the evaluation score, the approximate strength of the nurtured character is made easy to understand. The nurtured character information includes the evaluation score and the nurture rank.

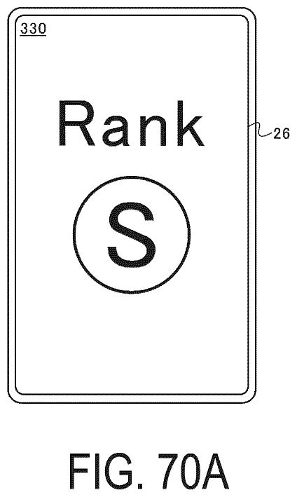

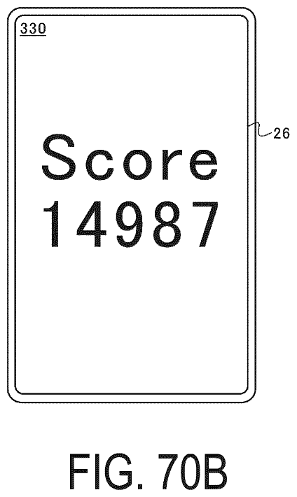

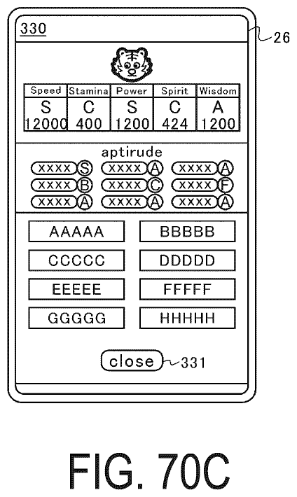

FIG. 70A is a first diagram for describing the nurture completion screen 330. FIG. 70B is a second diagram for describing the nurture completion screen 330. FIG. 70C is a third diagram for describing the nurture completion screen 330. When the nurture game ends, the nurture completion screen 330 is displayed on the display 26 as illustrated in FIG. 70A. On the nurture completion screen 330, the nurture rank of the nurtured character is first displayed, and thereafter, the evaluation score is displayed as illustrated in FIG. 70B.

When a predetermined amount of time elapses after the evaluation score is displayed, the ability parameter, the aptitude parameter, and the obtained skill of the nurtured character are displayed on the nurture completion screen 330 as illustrated in FIG. 70C. At this time, a close operation portion 331 is provided on the nurture completion screen 330. When the close operation portion 331 is tapped, the nurture completion screen 330 is hidden, and the home screen 100 is displayed on the display 26.

When the nurture game ends, a lottery for a factor to be obtained by the nurtured character is performed, and factor information is stored in association with the nurtured character. Although not illustrated, the player can display the factor information obtained by the nurtured character on the nurture completion screen 330. The lottery for a factor is executed according to preset conditions for each factor type. The factor obtaining probability and the like are set based on the result of the nurture game.

Next, the functional configuration of the player terminal 1 and the server 1000 for executing the above-described nurture game will be described.

### Functional Configuration of Player Terminal 1

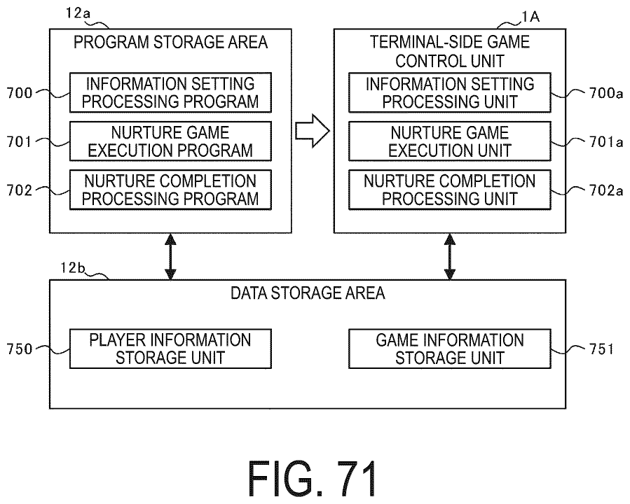

FIG. 71 is a diagram for describing the configuration of the memory 12 in the player terminal 1 and the function as a computer. The memory 12 is provided with a program storage area 12a and a data storage area 12b. When the game is started, the CPU 10 stores a terminal-side game control program (module) in the program storage area 12a.

The terminal-side game control program includes an information setting processing program 700, a nurture game execution program 701, and a nurture completion processing program 702. Note that the programs listed in FIG. 71 are examples, and many other programs are provided in the terminal-side game control program.

In the data storage area 12b, a player information storage unit 750 and a game information storage unit 751 are provided as storage units that store data. Note that the data storage area 12b is provided with a large number of other storage units. Here, information directly related to a game such as a nurture game (hereinafter referred to as game information) is stored in the game information storage unit 751. Note that various types of information during the progress of each game such as the nurture game are also temporarily stored in the game information storage unit 751. Thus, all information related to the nurtured character nurtured in the nurture game is stored in the game information storage unit 751. In addition, for example, all information other than the game information, such as information related to the player or another player, setting information of the player terminal 1, and the like, is set as player information. The player information is stored in the player information storage unit 750.

The CPU 10 operates each program stored in the program storage area 12a and updates the data in each storage unit of the data storage area 12b. Then, the CPU 10 causes the player terminal 1 (computer) to function as a terminal-side game control unit 1A by running each program stored in the program storage area 12a. The terminal-side game control unit 1A includes an information setting processing unit 700a, a nurture game execution unit 701a, and a nurture completion processing unit 702a.

To be specific, the CPU 10 runs the information setting processing program 700 to cause the computer to function as the information setting processing unit 700a. Similarly, the CPU 10 runs the nurture game execution program 701 and the nurture completion processing program 702 to cause the computer to function as the nurture game execution unit 701a and the nurture completion processing unit 702a.

When various types of information are set in the player terminal 1, the information setting processing unit 700a stores information related to the setting in the player information storage unit 750 as player information. When the information in the player information storage unit 750 is updated, the information setting processing unit 700a transmits the update information to the server 1000.

The nurture game execution unit 701a executes all processing related to the nurture game. To be specific, the nurture game execution unit 701a executes the preparation stage processing and the nurture stage processing.

The nurture completion processing unit 702a stores nurtured character information including the ability parameter, the aptitude parameter, the obtained skill, the inheritance information, the factor information, the type of the character used for nurturing, and the like of the nurtured character at the time of completion of the nurture game.

### Functional Configuration of Server 1000

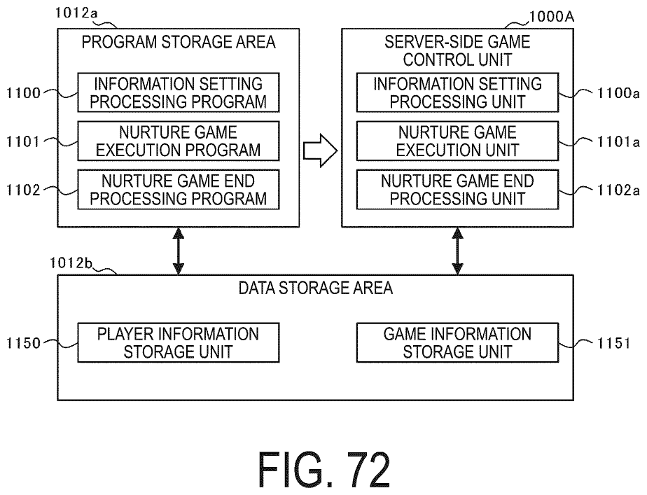

FIG. 72 is a diagram for describing the configuration of the memory 1012 in the server 1000 and the function as a computer. The memory 1012 is provided with a program storage area 1012a and a data storage area 1012b. When the game is started, the CPU 1010 stores a server-side game control program (module) in the program storage area 1012a.

The server-side game control program includes an information setting processing program 1100, a nurture game execution program 1101, and a nurture game end processing program 1102. Note that the programs listed in FIG. 72 are examples, and many other programs are provided in the server-side game control program.

In the data storage area 1012b, a player information storage unit 1150 and a game information storage unit 1151 are provided as storage units that store data. Note that the data storage area 1012b is provided with a large number of other storage units. Here, the game information of all the players is stored in the game information storage unit 1151 in association with the player ID. The player information of all the players is stored in the player information storage unit 1150 in association with the player ID.

The CPU 1010 operates each program stored in the program storage area 1012a and updates the data in each storage unit of the data storage area 1012b. Then, the CPU 1010 causes the server 1000 (computer) to function as a server-side game control unit 1000A by running each program stored in the program storage area 1012a. The server-side game control unit 1000A includes an information setting processing unit 1100a, a nurture game execution unit 1101a, and a nurture game end processing unit 1102a.

To be specific, the CPU 1010 runs the information setting processing program 1100 to cause the computer to function as the information setting processing unit 1100a. Similarly, the CPU 1010 runs the nurture game execution program 1101 and the nurture game end processing program 1102 to cause the computer to function as the nurture game execution unit 1101a and the nurture game end processing unit 1102a.

When various types of information are set in the player terminal 1, the information setting processing unit 1100a updates the player information in the player information storage unit 1150, based on the update information received from the player terminal 1. In addition, the information setting processing unit 1100a measures time and updates the game points of each player.

The nurture game execution unit 1101a executes all processing related to the nurture game.

When the nurture game ends, the nurture game end processing unit 1102a derives the evaluation score, nurture rank, and the like for the nurtured character. In addition, the nurture game end processing unit 1102a determines the factor to be obtained by the nurtured character through a lottery. The game information storage unit 1151 stores nurtured character information including the ability parameter, the aptitude parameter, the obtained skill, the inheritance information, the factor information, the type of the character used for nurturing, and the like of the nurtured character associated with the player ID.

Note that the information setting processing unit 700a in the player terminal 1 and the information setting processing unit 1100a in the server 1000 are the same in that both store player information, but are different from each other in the specific content of processing and the range of stored player information. In addition, the nurture game execution unit 701a in the player terminal 1 and the nurture game execution unit 1101a in the server 1000 are the same in that they execute processing related to the nurture game, but they have different roles, that is, different ranges of responsibility.

Processing performed by each functional unit in the player terminal 1 and the server 1000 will be described below with reference to a flowchart.

### Processing of Player Terminal 1 and Server 1000 Processing Related to Nurture Game

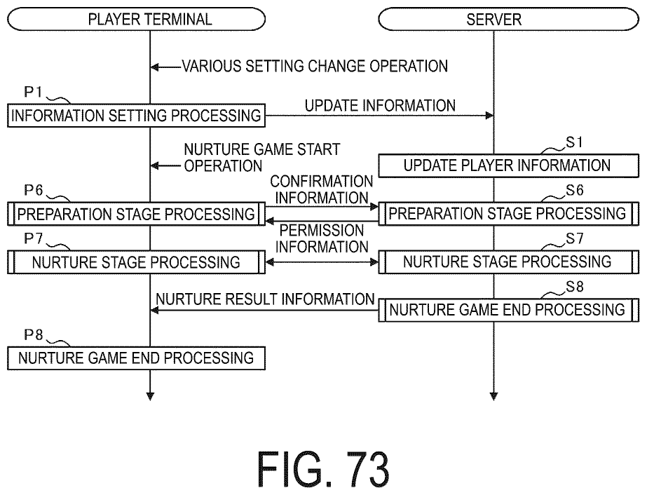

FIG. 73 is a sequence diagram for describing processing of the player terminal 1 and the server 1000 related to the nurture game. In the following description, the processing in the player terminal 1 is denoted by Pn (n is an arbitrary integer). Processing in the server 1000 is denoted by Sn (n is an arbitrary integer).

When the player performs various setting change operations on the player terminal 1, the information setting processing unit 700a of the player terminal 1 performs information setting processing of updating the player information storage unit 750, based on the operation input of the player (P1). In this information setting processing, the update information is transmitted to the server 1000. In the server 1000, when the update information is received, the information setting processing unit 1100a updates the player information of the player information storage unit 1150 (S1).

The player information updated in P1 and S1 includes, for example, profile information that can be set by the player. In addition, for example, when an operation of adding another player as a friend or an operation of removing a friend is input as a setting change operation, friend information that is information related to friends is updated. In P1 and S1, each of the information setting processing unit 700a and the information setting processing unit 1100a manages the game points spent to execute the nurture game. When the game points are less than the upper limit value, the information setting processing units 700a and 1100a measure time and give a predetermined value of game points to the player at predetermined time intervals.

When a nurture game start operation for starting the nurture game is input to the player terminal 1, the nurture game execution unit 701a executes the preparation stage processing (P6). Further, during the preparation stage processing, communication processing is executed between the player terminal 1 and the server 1000. In the server 1000, the nurture game execution unit 1101a executes the preparation stage processing, based on the information received from the player terminal 1 (S6).

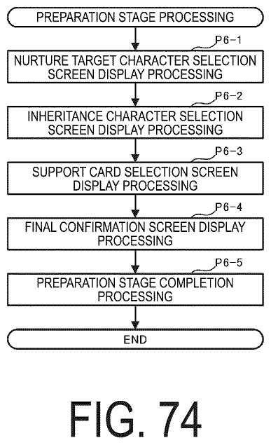

FIG. 74 is a flowchart for describing the preparation stage processing (P6) in the player terminal 1. The nurture game execution unit 701a of the player terminal 1 executes nurture target character selection screen display processing (P6-1). Here, the nurture game execution unit 701a displays the nurture target character selection screen 150 and temporarily registers, based on the operation input of the player, the nurture target character.

Specifically, the nurture game execution unit 701a switches the display screen of the display 26 when a display switching operation for switching the screen display is input by the player. When a press and hold operation of the character icon 151 on the nurture target character selection screen 150 is input, the character detail screen 160 is displayed by the nurture game execution unit 701a. When the strengthening operation portion 163b is operated on the character detail screen 160, the character strengthening screen 165 is displayed. When a selection operation (operation of the character icon 151) is input on the nurture target character selection screen 150, the nurture game execution unit 701a temporarily stores the character corresponding to the character icon 151 selected via input and switches the display screen.

When a confirmation operation (operation of the next operation portion 154) is input on the nurture target character selection screen 150, the nurture game execution unit 701a temporarily registers the temporarily stored character as the nurture target character. In addition, the nurture game execution unit 701a obtains, from the server 1000, information related to a representative character extracted in accordance with a predetermined extraction condition, such as a representative character of a friend, and displays the inheritance character selection screen 170.

Next, the nurture game execution unit 701a executes inheritance character selection screen display processing (P6-2). Here, the nurture game execution unit 701a switches the display screen of the display 26 when a display switching operation is input. When a selection operation (operation of the nurtured character icon 182) is input on the nurtured character list screen 180, the nurture game execution unit 701a temporarily stores the character corresponding to the nurtured character icon 182 operated for selection as the inheritance character and switches the display screen.

In addition, when a confirmation operation (operation of the next operation portion 154) is input on the inheritance character selection screen 170, the nurture game execution unit 701a displays the support card organization screen 190 on the display 26.

Next, the nurture game execution unit 701a executes support card selection screen display processing (P6-3). Here, when a selection operation (operation of the card icon 201 of the support card) is input, the nurture game execution unit 701a temporarily stores the support card corresponding to the card icon 201 operated for selection and switches the display screen.

When a display switching operation for switching the display of the screen is input while the support card organization screen 190 is being displayed, the nurture game execution unit 701a switches the display screen of the display 26. When a confirmation operation (operation of the start operation portion 193) is input, the nurture game execution unit 701a displays a final confirmation screen 205 on the display 26.

Next, the nurture game execution unit 701a executes final confirmation screen display processing (P6-4). Here, the nurture game execution unit 701a switches the display screen of the display 26 when a display switching operation for switching the screen display is input.

When a selection operation (operation of the select operation portion 206c) is input on the preset selection screen 205A, the nurture game execution unit 701a temporarily stores reservation selection information corresponding to the preset operated for selection and switches the display screen.

When a confirmation operation (operation of the start operation portion 205b) is input on the final confirmation screen 205, the nurture game execution unit 701a executes preparation stage completion processing (P6-5). Here, the nurture game execution unit 701a determines whether the game points are equal to or greater than a predetermined value (for example, 30) and, if the game points are equal to or greater than the predetermined value, transmits the confirmation information to the server 1000.

Note that the confirmation information includes information for identifying the nurture target character, the inheritance character, and the support card that are temporarily registered. When the confirmation information is received, the preparation stage processing (S6) is executed in the server 1000. Although details will be described later, in the server 1000, it is determined whether to permit execution of the nurture main game using the nurture target character, the inheritance character, and the support card which are temporarily registered.

When permission information is received from the server 1000 after the confirmation information is transmitted, the nurture game execution unit 701a registers the temporarily registered nurture target character. In addition, the nurture game execution unit 701a registers the nurtured character temporarily stored as the inheritance character and the temporarily stored support card in the deck.

Further, the nurture game execution unit 701a registers the character ID of the character set as the specific character, based on the specific character information. The nurture game execution unit 701a also sets initial character identification information. The nurture game execution unit 701a also registers the reservation selection information on the temporarily stored preset. Accordingly, the preparation stage completion processing ends, and the nurture main game starts.

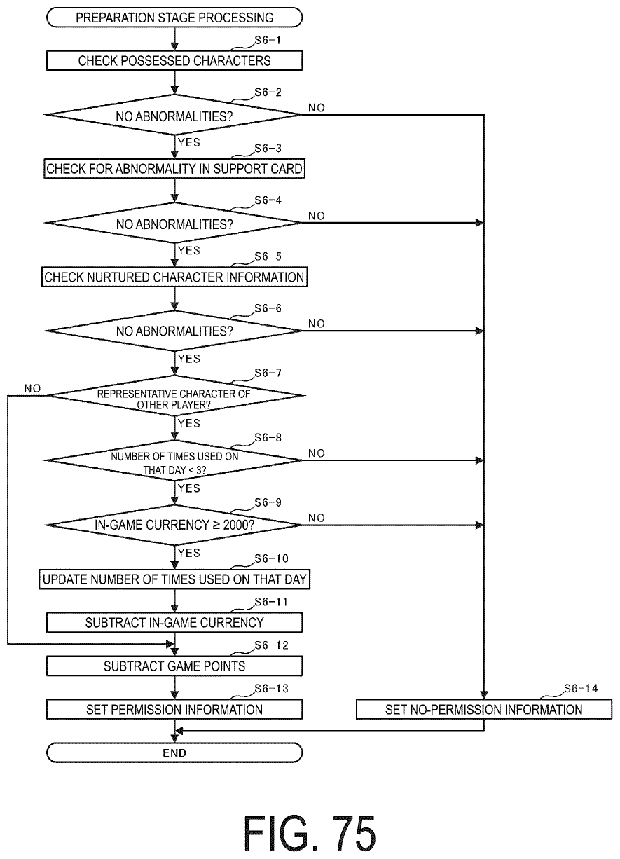

FIG. 75 is a flowchart for describing the preparation stage processing (S6) in the server 1000. When receiving the confirmation information, the nurture game execution unit 1101a confirms the possessed characters of the player stored in the player information storage unit 1150 (S6-1). If the nurture target character selected by the player is included in the possessed characters, the nurture game execution unit 1101a determines that there is no abnormality (S6-2).

If there is no abnormality in the nurture target character selected by the player (YES in S6-2), the nurture game execution unit 1101a checks whether there is an abnormality in the support card selected by the player (S6-3). In S6-3, it is determined that there is an abnormality when a support card not possessed by the player is selected, when the rental card selected by the player is not associated with the player ID of the player, when the support character overlaps with the nurture target character, or the like.

If there is no abnormality in the support card selected by the player (YES in S6-4), the nurture game execution unit 1101a checks the nurtured character information stored in the game information storage unit 1151 (S6-5). When the nurtured character selected by the player as the inheritance character is associated with the player ID of the player, that is, when the nurtured character nurtured by the player is selected as the inheritance character, the nurture game execution unit 1101a determines that there is no abnormality in the inheritance character (YES in S6-6).

When it is determined that there is no abnormality in the inheritance character, the nurture game execution unit 1101a determines whether a representative character of another player is included in the nurtured characters selected as the inheritance character by the player (S6-7). When a representative character of another player is included (YES in S6-7), the nurture game execution unit 1101a determines whether the number of uses on the day is less than three (S6-8).

When the number of uses on the day is less than three (YES in S6-8), the nurture game execution unit 1101a determines whether the predetermined in-game currency possessed by the player is 2000 or greater (S6-9). That is, in S6-8 and S6-9, it is determined whether the forming condition is satisfied. When the player possesses 2000 or greater in-game currency (YES in S6-9), the nurture game execution unit 1101a adds “1” to the number of times used on that day (S6-10). In addition, the nurture game execution unit 1101a subtracts 2000 from the amount of possessed predetermined in-game currency stored in the player information storage unit 1150 (S6-11).

Further, the nurture game execution unit 1101a subtracts a predetermined value (for example, 30) from the game points of the player (S6-12). Then, in a case where there is no abnormality in the nurture target character, the inheritance character, and the support card and the forming condition for using the representative character of another player is satisfied, the nurture game execution unit 1101a sets permission information (S6-13) and causes the player terminal 1 to receive the permission information. On the other hand, in a case where there is an abnormality in the nurture target character, the inheritance character, or the support card or the forming condition for using the representative character of another player is not satisfied, the nurture game execution unit 1101a sets no-permission information (S6-14) and causes the player terminal 1 to receive the no-permission information. When the no-permission information is received, the final confirmation screen 205 is displayed on the player terminal 1, and a predetermined error is notified.

Referring back to FIG. 73, when the preparation stage processing (P6, S6) ends, in the player terminal 1, the nurture game execution unit 701a executes the nurture stage processing (P7). Further, during the nurture stage processing, communication processing is executed between the player terminal 1 and the server 1000. In the server 1000, the nurture game execution unit 1101a executes the nurture stage processing, based on the information received from the player terminal 1 (S7).

Hereinafter, the nurture stage processing (P7) executed in the player terminal 1 and the nurture stage processing (S7) executed in the server 1000 will be described. However, here, in order to facilitate understanding, the processing in the player terminal 1 and the processing in the server 1000 will be described by appropriately changing the order.

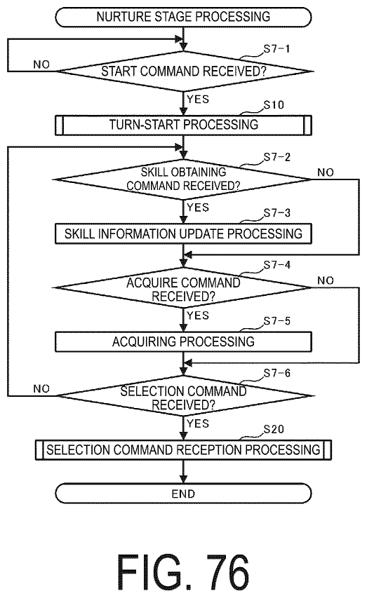

FIG. 76 is a flowchart for describing the nurture stage processing in the server 1000. The nurture game execution unit 1101a of the server 1000 waits for reception of a start command from the player terminal 1 (S7-1). When the start command is received (YES in S7-1), the nurture game execution unit 1101a executes the turn-start processing (S10). Note that the start command is transmitted from the player terminal 1 to the server 1000, for example, when processing or a performance related to the current turn is completed.

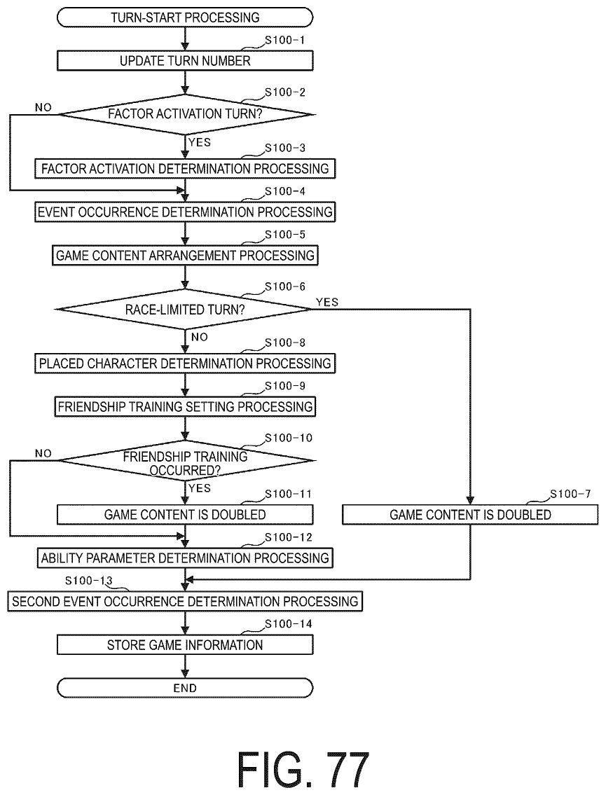

FIG. 77 is a flowchart for describing the turn-start processing in the server 1000. The nurture game execution unit 1101a of the server 1000 updates the current turn number (S100-1). If the current turn is a factor activation turn (YES in S100-2), the nurture game execution unit 1101a executes factor activation determination processing (S100-3). Here, whether to activate a factor is determined for each registered inheritance character.

Also, the nurture game execution unit 1101a executes event occurrence determination processing (S100-4). Here, the nurture game execution unit 1101a determines an event to be generated in the current turn for the scenario event, the exclusive event, the first event, or the like. Here, the event occurrence rate and the like are corrected based on the special effect of the Goddess' Wisdom that is currently activated.

The nurture game execution unit 1101a executes game content arrangement processing of arranging the game content in the selection item (S100-5). Here, in the case where the turn is a turn in which game content can be arranged in a selection item and the number of knowledge fragments currently possessed is less than eight, the “processing of determining a special character ID” and the “processing of determining an effect ID” in FIG. 66 described above are executed. In this manner, the selection item is associated with the game content.

If the current turn is a race-limited turn (YES in S100-6), the nurture game execution unit 1101a doubles the game content arranged in the race (S100-7). Accordingly, the game content to be obtained is doubled by entering in the target race set for each nurture target character.

If the current turn is not a race-limited turn (NO in S100-6), the nurture game execution unit 1101a executes placed character determination processing (S100-8). Here, for each of the support character and specific character such as a story character, the nurture game execution unit 1101a determines whether to place and the training item to be placed in through a lottery based on the placement table (FIG. 67). At this time, when the training item to be placed is determined, the nurture game execution unit 1101a stores the character in association with the determined training item.

Next, the nurture game execution unit 1101a executes friendship training setting processing (S100-9). Here, the “Processing of setting the friendship training possible state” described using FIG. 66 is executed. That is, the nurture game execution unit 1101a extracts a support character placed in any one of the training items. Then, it is determined whether each setting condition for the friendship training possible state is satisfied for the extracted support character. The nurture game execution unit 1101a associates the friendship training occurrence information with the support character satisfying the setting condition of the friendship training possible state. Also, the friendship training possible information is associated with the training item in which the support character satisfying the setting conditions for the friendship training possible state is placed.

Here, when the friendship bonus is activated as the special effect, the friendship training possible information is associated regardless of the favored training of the support character arranged at the training item.

Then, when the friendship training possible state is set (YES in S100-10), the nurture game execution unit 1101a doubles the arranged game content for the training item for which the friendship training possible state is set (S100-11). Accordingly, in a case where the friendship training occurs when the training is successful, the game content to be obtained is doubled.

Note that in S100-7 and S100-11, when a plurality of pieces of game content are associated with one selection item, the number of obtainable game content of the same game content is doubled. However, when a plurality of pieces of game content are associated with one selection item, two or more different pieces of game content may be associated with one selection item. In this case, for example, the game content to be arranged may be determined by an additional lottery in S100-7 and S100-11.

Next, the nurture game execution unit 1101a executes ability parameter determination processing (S100-12). Here, the “processing of determining the increase value of the ability parameter” described using FIG. 66 is executed. That is, the nurture game execution unit 1101a selects any one of the five training items as a processing target. The nurture game execution unit 1101a obtains the training level of the ability parameter that is the processing target and determines the fixed increase value.

In addition, the nurture game execution unit 1101a obtains the placement information on the placed character and determines the additional value. In addition, the nurture game execution unit 1101a determines whether other additional conditions such as the currently activated effects of the knowledge fragments, first crystals, and second crystals or the special effects of the Goddess' Wisdom are satisfied and determines the final increase value of the training item that is the processing target based on the satisfied additional condition. The determination of the final increase value for the ability parameter is executed for each training item.

Although a detailed description is omitted, in the ability parameter determination processing, an energy consumption amount or an energy recovery amount when each training item is executed is determined. The nurture game execution unit 1101a calculates a failure rate of training for each training item, based on the energy of the nurture target character. Here, the energy consumption amount, the energy recovery amount, and the training failure rate are corrected based on the currently activated effects of the knowledge fragments, the first crystals, and the second crystals or the special effect of the Goddess' Wisdom.

Next, the nurture game execution unit 1101a executes second event occurrence determination processing (S100-13). Here, the “Processing of setting the second event possible state” described using FIG. 66 is executed. In other words, the nurture game execution unit 1101a determines whether to execute a support event set in advance for the support card associated with the training item through a lottery. Here also, the support event occurrence rate and the like are corrected based on the special effect of the Goddess' Wisdom that is currently activated.

Then, the nurture game execution unit 1101a stores the information determined in the above processing as the game information received by the player terminal 1 (S100-14).

Referring back to FIG. 76, when an obtain skill command indicating obtainment of any base skill is received from the player terminal 1 after the turn-start processing has ended (YES in S7-2), skill information such as the skill obtainment information is updated by the nurture game execution unit 1101a (S7-3). Here, the obtainment information is associated with the obtained skill. Here, the nurture game execution unit 1101a subtracts the skill points required to obtain the skill from the currently possessed skill points. Here, the updated skill information is caused to be received by the player terminal 1 by the nurture game execution unit 1101a.

When an acquire command indicating acquirement of the Goddess' Wisdom is received from the player terminal 1 (YES in S7-4), the nurture game execution unit 1101a executes acquiring processing (S7-5). Here, the processing of updating the Goddess' Wisdom obtainment information, the processing of activating the special effects, and the processing of setting the effective period (the number of turns) of the active effects of the special effects are executed. Further, the server 1000 waits until a selection command is received from the player terminal 1 (S7-6).

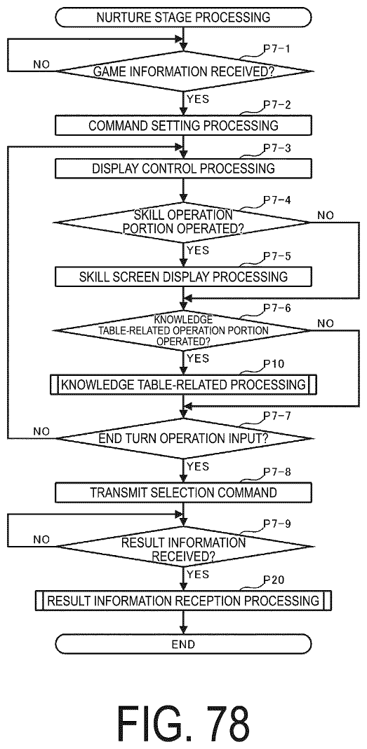

FIG. 78 is a flowchart for describing the nurture stage processing in the player terminal 1. The nurture game execution unit 701a of the player terminal 1 waits for reception of game information from the server 1000 (P7-1). Then, when the game information is received (YES in P7-1), the nurture game execution unit 701a executes command setting processing (P7-2). Here, processing of setting a command that can be selected by the player is executed based on the current turn number.

Further, the nurture game execution unit 701a executes display control processing of displaying a game screen, based on the received game information (P7-3). Here, the nurture game execution unit 701a displays the top screen 210, the training screen 220, and the like, based on the received game information. Specifically, the nurture game execution unit 701a displays the game content at the eight selection items on the top screen 210 and the training screen 220. Also, the nurture game execution unit 701a displays the placed character icon 228 for each training item on the training screen 220. The nurture game execution unit 701a performs display control of the stats display portion 213. Further, the nurture game execution unit 701a causes the operation portion corresponding to the training item set to the friendship training possible state and the training operation portion 215b of the top screen 210 to display an effect.

When the skill operation portion 215c is operated (YES in P7-4), the nurture game execution unit 701a executes skill screen display processing (P7-5) to display the skill screen 230. When the knowledge table-related operation portion associated with the knowledge table is operated (YES in P7-6), the nurture game execution unit 701a executes knowledge table-related processing (P10). The knowledge table-related operation portion includes, for example, the knowledge table check icon 217, the close operation portion 300a, the check effect operation portion 300b, the acquiring operation portion 300c, the history icon 300d, the special character display region 305, the information icon 310c, and the close operation portion 310d.

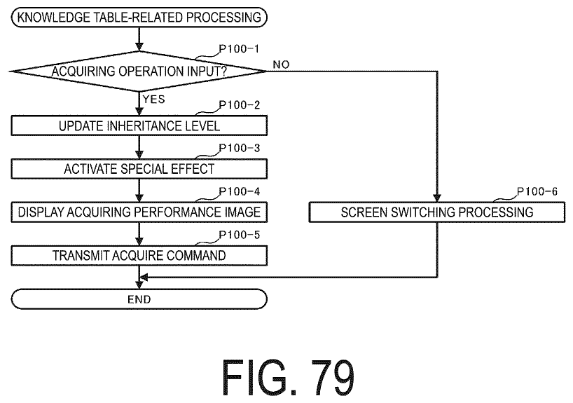

FIG. 79 is a flowchart for describing the knowledge table-related processing in the player terminal 1. When the acquiring operation to instruct acquirement of the Goddess' Wisdom is input (YES in P100-1), the nurture game execution unit 701a updates the inheritance level of the special character associated with the Goddess' Wisdom (P100-2). The nurture game execution unit 701a also activates the special effect (P100-3). Here, the effective period (the number of turns) set for the active effect is set.

The nurture game execution unit 701a displays an acquiring performance image indicating acquiring of the Goddess' Wisdom (P100-4). The player may be allowed to set whether to display the acquiring performance image. In this case, if the setting is set to display the acquiring performance image, the acquiring performance image is displayed. If the setting is set to not display the acquiring performance image, the acquiring performance image is not displayed. The nurture game execution unit 701a transmits an acquire command to the server 1000 (P100-5). When an operation of the knowledge table-related operation portion other than the acquiring operation is input (NO in P100-1), the nurture game execution unit 701a switches the screen of the display 26 (P100-6).

Referring back to FIG. 78, the nurture game execution unit 701a switches the display screen of the display 26 based on the operation input by the player until the turn end operation is input (NO in P7-7). Here, the turn end operation is an operation of ending the current turn and includes an operation of the rest operation portion 215a, the infirmary operation portion 215d, the going out operation portion 215e, the speed operation portion 221, the stamina operation portion 222, the power operation portion 223, the spirit operation portion 224, and the wisdom operation portion 225; an operation of determining a race event of a race; and the like.

When the turn end operation is input (YES in P7-7), the nurture game execution unit 701a transmits a selection command corresponding to the turn end operation input by the player to the server 1000 (P7-8). Thereafter, the player terminal 1 waits until the result information is received from the server 1000 (NO in P7-9).

Referring back to FIG. 76, when a selection command is received from the player terminal 1 (YES in S7-6), the nurture game execution unit 1101a executes selection command reception processing (S20).

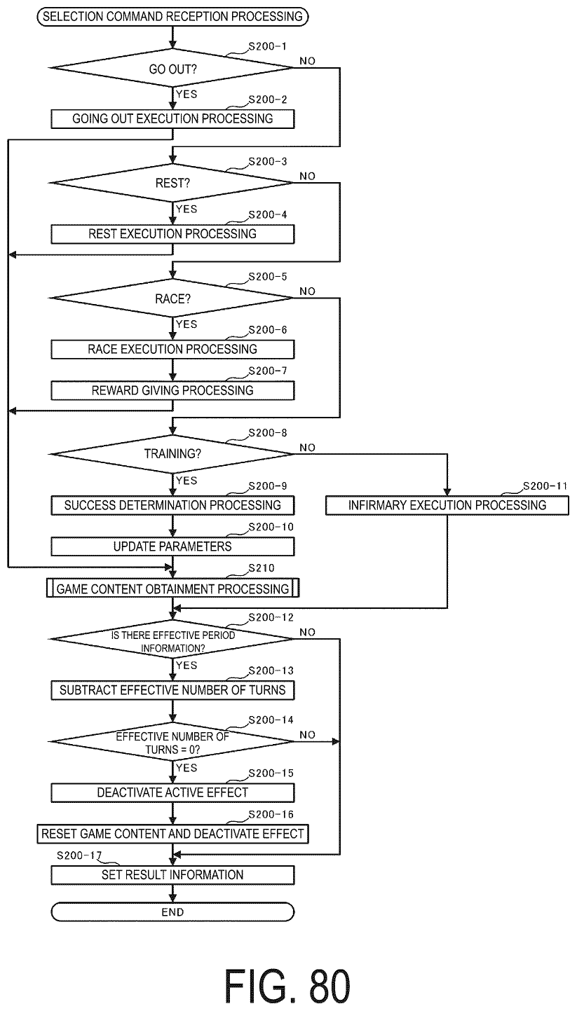

FIG. 80 is a flowchart for describing the selection command reception processing in the server 1000. When the selection command indicating an operation input of the going out operation portion 215e is received (YES in S200-1), the nurture game execution unit 1101a executes going out execution processing (S200-2). Here, a going out event is determined that increases the energy and mood parameters. Further, the parameters for the energy and mood are updated based on the determined going out event.

When the selection command indicating an operation input of the rest operation portion 215a is received (YES in S200-3), the nurture game execution unit 1101a executes rest execution processing (S200-4). Here, a rest event is determined that increases the energy parameter. Further, the parameter for the energy is updated based on the determined rest event.

When the selection command indicating an operation input to start a race is received (YES in S200-5), the nurture game execution unit 1101a executes race execution processing (S200-6). Here, a race simulation is executed based on the parameters of the nurture target character and the NPCs that run in the race. Further, the nurture game execution unit 1101a executes reward giving processing of giving a reward to the player (S200-7). Here, a reward is determined based on the result of the simulation, that is, the placing, the race development, and the like of the nurture target character, and the determined reward is given to the player.

When the selection command indicating execution of any training is received (YES in S200-8), the nurture game execution unit 1101a executes success determination processing (S200-9). Here, the success or failure of the training is determined based on the failure rate calculated in advance. Then, the nurture game execution unit 1101a updates various parameters based on the determination result of S200-9 (S200-10). Here, the ability parameters and the like are updated as determined in S10-12 at the start of the training. In this case, the value of the bond parameter of the placed character is updated.

When the selection command indicating an operation input of the infirmary operation portion 215d is received (NO in S200-8), the nurture game execution unit 1101a executes infirmary execution processing (S200-11). Here, for example, the minus parameters of the nurture target character are cancelled.

When the going out execution processing (S200-2), the rest execution processing (S200-4), the race execution processing (S200-6), and the training success determination processing (S200-9) are executed, the nurture game execution unit 1101a executes the game content obtainment processing (S210).

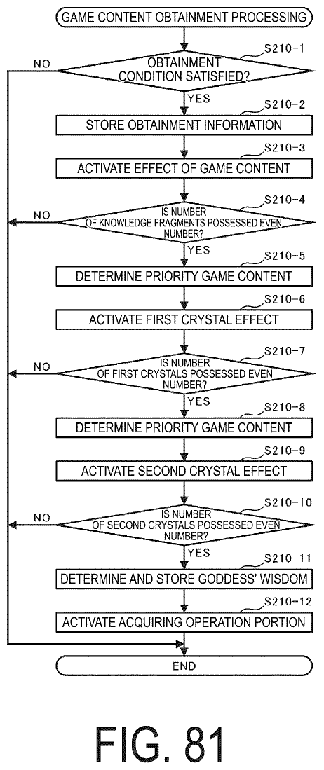

FIG. 81 is a flowchart for describing the game content obtainment processing in the server 1000. When the obtainment condition is satisfied (YES in S210-1), the nurture game execution unit 1101a stores obtainment information on the game content (S210-2). Here, obtained game content is stored as knowledge fragments. Specifically, the special character ID, the effect ID, and the priority information including information based on the order of storage are stored in a predetermined storage area. Note that here, as the obtainment conditions, the execution of the going out execution processing (S20-2), the rest execution processing (S20-4), and the race execution processing (S20-6) and the success of the training are set.

The nurture game execution unit 1101a activates the effect of the obtained game content (S210-3). Then, when the number of possessed knowledge fragments is an even number (YES in S210-4), the nurture game execution unit 1101a determines the priority game content (S210-5). Here, the priority game content is determined based on the priority information of the group to which the newly stored knowledge fragment belongs. Then, the nurture game execution unit 1101a determines a first crystal including the special character ID associated with the priority game content and the effect ID determined through a lottery and activates the effect associated with the effect ID (S210-6). Here, the priority information including information based on the order of storage as the first crystal is associated with game content corresponding to the first crystal.

Then, when the number of possessed first crystals is an even number (YES in S210-7), the nurture game execution unit 1101a determines the priority game content (S210-8). Here, the priority game content is determined based on the priority information of the group to which the newly stored first crystal belongs. Then, the nurture game execution unit 1101a determines a second crystal including the special character ID associated with the priority game content and the effect ID determined through a lottery and activates the effect associated with the effect ID (S210-9).

When the number of possessed second crystals is an even number (YES in S210-10), the nurture game execution unit 1101a determines and stores the Goddess' Wisdom (S210-11). Here, the Goddess' Wisdom is determined based on two second crystals serving as parents. Then, the nurture game execution unit 1101a activates the acquiring operation portion 300c (S210-12).

Referring back to FIG. 80, when there is effective period information indicating the effective period of the special effect (YES in S200-12), the nurture game execution unit 1101a counts down the number of turns of the effective period (effective number of turns) (S200-13). When the effective number of turns is 0 (YES in S200-14), the nurture game execution unit 1101a deactivates the active effect which is the special effect (S200-15).

Further, the nurture game execution unit 1101a resets all of the currently possessed game content (the knowledge fragments, the first crystals and the second crystals, and the Goddess' Wisdom) (S200-16). Here, the nurture game execution unit 1101a deactivates the effects based on the knowledge fragments, the first crystals, and the second crystals.

Then, the nurture game execution unit 1101a sets result information including: the results of the going out execution processing, the rest execution processing, the race execution processing, the reward giving processing, the infirmary execution processing, and the success determination processing; and various updated information and causes the player terminal 1 to receive the result information (S200-17).

Referring back to FIG. 78, when the player terminal 1 receives the result information from the server 1000 (YES in P7-9), the nurture game execution unit 701a executes result information reception processing (P20).

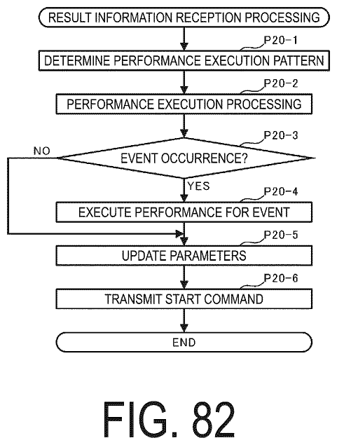

FIG. 82 is a flowchart for describing the result information reception processing in the player terminal 1. The nurture game execution unit 701a determines, based on the received result information, the performance execution pattern (P20-1). Then, the nurture game execution unit 701a executes a performance in the execution pattern determined in P20-1 (P20-2). Here, when the training in which the friendship training possible state is set is successful, a friendship-training-exclusive performance is executed.

Specifically, in P20-1, the nurture game execution unit 701a specifies a character associated with the successful training item and associated with the friendship training possible information. Then, the nurture game execution unit 701a determines the execution pattern of the friendship-training-exclusive performance corresponding to the specified character and the executed training item. In the friendship-training-exclusive performance determined at this time, the character associated with the friendship training possible information is displayed.

When the second event occurs (YES in P20-3), the nurture game execution unit 701a executes a performance for the occurring event (P20-4). Also, the nurture game execution unit 701a updates the parameters, based on the received result information (P20-5). When all the performances to be executed in the current turn are finished, the nurture game execution unit 701a transmits a start command to the server 1000 (P20-6). In this manner, the current turn is ended in the player terminal 1. Then, when the server 1000 receives the start command, thereafter, processing related to the next turn is executed by processing similar to that described above.

Referring back to FIG. 73, in the server 1000, when the nurture stage processing described above ends (S7), the nurture game end processing unit 1102a executes the nurture game end processing (S8).

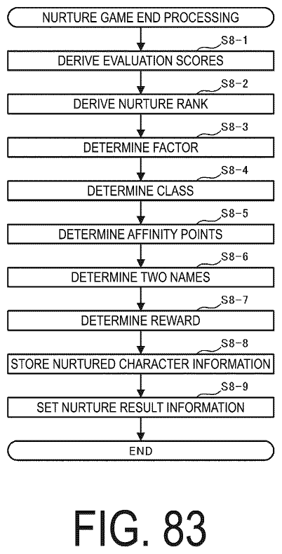

FIG. 83 is a flowchart for describing the nurture game end processing in the server 1000. The nurture game end processing unit 1102a derives evaluation scores, based on various parameters of the nurture target character (S8-1). Further, the nurture game end processing unit 1102a derives a nurture rank, based on the derived evaluation scores (S8-2).

In addition, the nurture game end processing unit 1102a determines the factor to be obtained by the nurtured character (S8-3). Further, the nurture game end processing unit 1102a determines a class, based on the number of fans obtained (S8-4). Further, the nurture game end processing unit 1102a determines affinity points, based on a predetermined parameter such as the nurture rank, the number of fans, or the like (S8-5). Although a detailed description is omitted, the affinity points are points given not to the nurtured character but to a character serving as a source of the nurtured character.

A plurality of story screens are provided for each character, and an unlock condition is set for some of the story screens. There is a story screen in which affinity points are set as an unlock condition, and when the affinity points are equal to or greater than a threshold, the player can view the story screen.

Further, the nurture game end processing unit 1102a determines two names (S8-6). Here, the condition achieved in the nurture main game is confirmed, and two names to be obtained by the nurtured character are determined. Further, the nurture game end processing unit 1102a determines a reward to be given to the player (S8-7). The nurture game end processing unit 1102a stores nurtured character information including the evaluation scores, the nurture rank, the ability parameters, the aptitude parameters, the obtained skills, the inheritance information, the factor information, the class, the two names, and the like in association with the player ID of the player in the game information storage unit 1151 (S8-8). In addition, the nurture game end processing unit 1102a sets nurture result information and causes the player terminal 1 to receive the nurture result information (S8-9).

Referring back to FIG. 73, when the player terminal 1 receives the nurture result information, the nurture completion processing unit 702a executes the nurture game end processing (P8). Here, the nurture completion processing unit 702a stores the received nurture result information in the game information storage unit 751. The nurture completion processing unit 702a displays the nurture completion screen 330 (see FIGS. 70A, 70B, and 70C) on the display 26 based on the nurture result information.

The above-described nurture game is realized via the above-described processing. Also, the nurtured character information related to the nurtured character nurtured (created) via the nurture game is stored in association with a player ID. The processing in the player terminal 1 and the server 1000 described above are merely examples. Further, each item of processing described above may be executed only by the player terminal 1 or only by the server 1000.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present disclosure.

The game properties and the processing in the player terminal 1 and the server 1000 described in the above embodiment are merely examples. In the embodiment described above, the command that can be selected by the player each turn and that ends the turn is merely an example. For example, in the embodiment described above, only a part of the command for ending the turn may be provided.

In the embodiment described above, the number of pieces of game content that the player can obtain by selecting selection items, that is, the number of knowledge fragments, is eight. Then, if eight knowledge fragments are obtained, the Goddess' Wisdom, that is, the special effect, is determined. That is, when the number of obtained pieces of game content reaches the specified number (eight), the player can select the acquiring operation portion 300c. In other words, when the number of obtained pieces of game content reaches the upper limit, the player can activate the special effect.

However, the acquiring operation portion 300c may be selectable when the number of obtained pieces of game content reaches a predetermined number less than the specified number (upper limit). In this case, the Goddess' Wisdom may be generated based on the game content possessed when the acquiring operation portion 300c is operated.

In the embodiment described above, the Goddess' Wisdom is generated based on eight knowledge fragments. However, for example, the Goddess' Wisdom may be generated based on some of the eight knowledge fragments, such as an odd-numbered or even-numbered knowledge fragment in the order of obtainment.

In the embodiment described above, after possessing the Goddess' Wisdom, the player can acquire the Goddess' Wisdom at any timing. However, for example, the special effect may be activated at the same time as eight knowledge fragments are obtained and the Goddess' Wisdom is generated.

In the embodiment described above, the effect is associated with the game content, and the effect is activated based on the obtainment of the game content. However, the effect associated with the game content is not essential. This effect is deactivated as the effective period of the passive effect of the Goddess' Wisdom expires. However, the effect associated with the game content may be permanently activated until the nurture game has ended.

In the embodiment described above, when the game content is obtained, priority information based on the obtainment order and the storage order of the game content is stored in association with the game content. At this time, the player cannot select or change the priority information associated with the game content. However, the priority information may be associated with the game content (knowledge fragment) based on the operation input of the player. For example, when the game content is obtained, the knowledge table dialog 300 is displayed, and it is possible to select which display portion of the fragment display region 301 to set the knowledge fragment, which is game content, in. Then, based on the operation input by the player, the display portion set with the knowledge fragment is determined. Accordingly, the priority information is associated with the game content based on the operation input of the player.

In the embodiment described above, processing of, in a game including a plurality of turns, allowing the player to select, for each of the plurality of turns, any of a plurality of commands for ending the turn (in the embodiment described above, for example, P7-2), processing of causing the game to progress based on the command selected by the player (in the embodiment described above, for example, S20), and processing of ending the turn based on the command being selected (in the embodiment described above, for example, P20-6) are executed.

However, the content and the method of progressing through the game in the embodiment described above are merely examples. For example, the game to which the present invention is applicable is not limited to a turn-based game. Further, the game genre is not limited to a nurture game, and the present invention is applicable to any game genre such as a role playing game or a simulation game.

In the embodiment described above, game content is stored as first game content (in the embodiment described above, for example, a knowledge fragment) based on the selection of a command. However, for example, the game content may be stored based on a predetermined event being executed by a successful lottery, a plurality of options being presented and a predetermined option being selected, a predetermined skill being obtained, or the like.

In the embodiment described above, the game content associated with the selection items is determined through a lottery. However, the game content associated with each selection item may be determined in advance. In this case, the same game content is arranged in each selection item in all of the turns. Alternatively, the game content associated with each selection item may be determined in advance for each turn.

In the embodiment described above, processing of associating game content with a plurality of commands (in the embodiment described above, for example, S10-5) is executed. Then, the game content associated with the command selected by the player is stored as the first game content. However, the processing of associating the game content with the command is not essential. For example, each turn, one piece of game content may be determined through a lottery for each turn, and the game content determined through a lottery may be obtainable regardless of the command selected by the player. At this time, the player may be able to select whether to obtain the game content. Alternatively, the game content may be determined in advance for each turn, and one piece of game content may be obtained regardless of the command selected by the player. In this case, the priority information may be associated with the game content based on the operation input of the player.

In the embodiment described above, a plurality of pieces of second game content are generated by executing processing of generating second game content (in the embodiment described above, for example, the first crystal and the second crystal) from a plurality of pieces of first game content a plurality of times. Further, processing (in the embodiment, for example, S21-11) of determining a third parameter (in the embodiment, for example, a special character ID associated with the first crystal or the second crystal) based on the first parameter (in the embodiment, for example, a special character ID associated with the knowledge fragment) associated with the first game content corresponding to each of the plurality of pieces of second game content and generating third game content (in the embodiment, for example, the Goddess' Wisdom) associated with the determined third parameter is executed.

Note that in the embodiment described above, the second crystal is generated, and the Goddess' Wisdom is generated based on the second crystal. However, the second crystal is not essential. For example, in the embodiment described above, the Goddess' Wisdom may be generated based on the four first crystals.

In the embodiment described above, any one of the special effects associated with the three types of special characters provided in advance is determined. However, the special effect may be determined through a lottery or the like each time. For example, in a case where, as the special effect, the ability parameter increases, an increase value or a correction value of the ability parameter may be randomly determined.

In the embodiment described above, the inheritance level is managed for each special character, and the higher the inheritance level, the greater the benefit of the special effect. However, the inheritance level is not essential, and the same special effect may be always activated regardless of the number of times the Goddess' Wisdom has been acquired.

In the embodiment described above, two pieces of game content may be obtained in one turn. In a case where two pieces of game content can be obtained, for example, it may be suggested that two pieces of game content can be obtained by displaying “×2” at the spirit operation portion 224 of FIG. 56. The upper limit of the number of pieces of game content that can be obtained in one turn is not particularly limited.

In any case, the information processing program causes a computer to execute the following processing.

### Processing Executed by Computer

Processing of storing one of the plurality of types of game content associated with the first parameter (in the embodiment, for example, a special character ID associated with a knowledge fragment) as first game content (in the embodiment, for example, a knowledge fragment) when a preset obtainment condition is satisfied (in the embodiment, for example, S21-2).

Processing of associating the priority information with the first game content (in the embodiment, for example, S21-2).

Processing of determining one of the plurality of first game content as priority first game content based on the priority information (in the embodiment, for example, S21-5).

Processing of determining a second parameter (in the embodiment, for example, a special character ID associated with the first crystal or the second crystal) based on the first parameter associated with the priority first game content and generating second game content (in the embodiment, for example, the first crystal or the second crystal) associated with the determined second parameter (in the embodiment, for example, S21-6 and S21-9).

Note that in the embodiment described above, the first parameter of the priority first game content corresponds as is to the second parameter of the second game content. However, the first parameter of the first game content and the second parameter of the second game content may be partially or entirely different from each other. For example, it is assumed that one piece of second game content is generated with two pieces of first game content as parents. In this case, one of the two pieces of first game content becomes priority first game content, and the other becomes non-priority first game content. Then, 80% of the first parameter of the priority first game content and 20% of the first parameter of the non-priority first game content may be inherited by the second game content. Even in this case, it can be said that the second parameter is determined based on the first parameter associated with the priority first game content, and the second game content associated with the determined second parameter is generated.

Also, the information processing program may cause a computer to execute the following processing.

### Processing Executed by Computer

Processing of storing one of the plurality of types of game content associated with the first parameter (in the embodiment, for example, a special character ID associated with a knowledge fragment) as first game content (in the embodiment, for example, a knowledge fragment) when a preset obtainment condition is satisfied (in the embodiment, for example, S21-2).

Processing of associating the priority information with the first game content (in the embodiment, for example, S21-2).

Processing of setting a lottery ratio for lottery processing of determining one of the plurality of pieces of first game content based on priority information associated with each of the plurality of pieces of first game content. Processing of executing lottery processing based on the set lottery ratio.

Processing of determining a second parameter based on the first parameter of the first game content determined in the lottery processing and generating second game content associated with the determined second parameter.

For example, in the embodiment described above, in S21-5, the nurture game execution unit 1101a sets the lottery ratio for the lottery processing based on the priority information. At this time, for example, the success probability of the priority game content stored in an odd-numbered position is set to any lottery ratio higher than 50%, and the success probability of the non-priority game content stored in an even-numbered position is set to any lottery ratio lower than 50%. Then, the nurture game execution unit 1101a executes the lottery processing based on the set lottery ratio. The nurture game execution unit 1101a may determine a second parameter based on the first parameter of the first game content determined in the lottery processing and generate second game content associated with the determined second parameter.

In this case, for example, the special character ID of the knowledge fragment, which is a non-priority game content, stored in an even-numbered position may be inherited by the first crystal or the second crystal. However, according to this modified example, the special character ID of the priority game content is more likely to be inherited by the first crystal or the second crystal than the special character ID of the non-priority game content. Thus, in this modified example, strategic performance for which command to select is required as in the embodiment described above. That is, the same effect as that of the above-described embodiment is also realized by this modified example.

Note that in this modified example, only a part of the first parameter of the first game content determined in the lottery processing may be inherited by the second parameter. In addition, the second parameter may be calculated by multiplying the first parameter of the first game content determined in the lottery processing by a predetermined coefficient.

Note that some of the functions of the nurture game described in the embodiment described above may not be provided. A part or all of the processing in the player terminal 1 described above may be executed in the server 1000. Similarly, a part or all of the processing in the server 1000 described above may be executed in the player terminal 1. Thus, communication between the player terminal 1 and the server 1000 is not essential, and for example, all of the programs for executing the game may be stored in the player terminal 1.

An information processing program for executing the processing in the above-described embodiment and various modified examples may be stored in a non-transitory computer-readable storage medium and provided as a storage medium. Furthermore, a game terminal apparatus including the storage medium may be provided. In addition, the above-described embodiment and various modified examples may correspond to an information processing method of implementing each function and the steps illustrated in the flowcharts.

In another aspect, an information processing program according to the present disclosure causes a computer to execute processing of storing one of the plurality of types of game content associated with the first parameter as the first game content based on a preset obtainment condition being satisfied, processing of associating priority information with the first game content, processing of determining one of the plurality of pieces of first game content as the priority first game content based on the priority information, and processing of determining a second parameter based on the first parameter associated with the priority first game content and generating second game content associated with the determined second parameter.

In another aspect, an information processing program according to the present disclosure causes a computer to execute processing of storing one of the plurality of types of game content associated with the first parameter as the first game content based on a preset obtainment condition being satisfied, processing of associating priority information with the first game content, processing of setting a lottery ratio for lottery processing for determining one of the plurality of pieces of first game content based on the priority information associated with each piece of first game content, processing of executing the lottery processing based on the set lottery ratio, and processing of determining a second parameter based on the first parameter of the first game content determined via the lottery processing and generating second game content associated with the determined second parameter.

The priority information may include information based on the order in which the game content is stored as first game content, or information based on a storage area where the game content is stored.

The processing of associating the priority information with the first game content may associate the priority information with the first game content based on an operation input of the player.

The processing of generating the second game content may further include generating a plurality of pieces of second game content by executing processing of generating the second game content from a plurality of pieces of the first game content multiple times, and the information processing program may further cause a computer to execute processing of determining a third parameter based on the first parameter associated with the first game content corresponding to each piece of second game content and generate third game content associated with the determined third parameter.

The information processing program may further cause a computer to execute processing of, in a game including a plurality of turns, allowing a player to select, for each of the plurality of turns, any of a plurality of commands for ending the turn, processing of progressing through the game based on the command selected by a player, and processing of ending the turn based on a command being selected. Also, the processing of storing the game content as the first game content may include storing the game content as the first game content based on a command being selected.

The information processing program may further cause the computer to execute processing of associating the game content with a plurality of commands, and the processing of storing the game content as the first game content may include storing the game content associated with the command selected by a player as the first game content.

In another aspect, an information processing method according to the present disclosure causes one or more computers to execute processing of storing one of the plurality of types of game content associated with the first parameter as the first game content based on a preset obtainment condition being satisfied, processing of associating priority information with the first game content, processing of determining one of the plurality of pieces of first game content as the priority first game content based on the priority information, and processing of determining a second parameter based on the first parameter associated with the priority first game content and generating second game content associated with the determined second parameter.

In another aspect, an information processing method according to the present disclosure causes one or more computers to execute processing of storing one of the plurality of types of game content associated with the first parameter as the first game content based on a preset obtainment condition being satisfied, processing of associating priority information with the first game content, processing of setting a lottery ratio for lottery processing for determining one of the plurality of pieces of first game content based on the priority information associated with each piece of first game content, processing of executing the lottery processing based on the set lottery ratio, and processing of determining a second parameter based on the first parameter of the first game content determined via the lottery processing and generating second game content associated with the determined second parameter.

In another aspect, a game apparatus according to the present disclosure includes one or more computers, the one or more computers execute processing of storing one of the plurality of types of game content associated with the first parameter as the first game content based on a preset obtainment condition being satisfied, processing of associating priority information with the first game content, processing of determining one of the plurality of pieces of first game content as the priority first game content based on the priority information, and processing of determining a second parameter based on the first parameter associated with the priority first game content and generating second game content associated with the determined second parameter.

In another aspect, a game apparatus according to the present disclosure includes one or more computers, the one or more computers execute processing of storing one of the plurality of types of game content associated with the first parameter as the first game content based on a preset obtainment condition being satisfied, processing of associating priority information with the first game content, processing of setting a lottery ratio for lottery processing for determining one of the plurality of pieces of first game content based on the priority information associated with each piece of first game content, processing of executing the lottery processing based on the set lottery ratio, and processing of determining a second parameter based on the first parameter of the first game content determined via the lottery processing and generating second game content associated with the determined second parameter.

What is claimed is:

1. A non-transitory computer readable medium storing a program causing a computer to execute:
processing of, in a game including a plurality of turns, allowing a player to select, for each of the plurality of turns (hereinafter referred to as “the turn”), any of a plurality of commands for ending the turn;
processing of storing obtainment information on a predetermined game content, based on the command selected by a player;
processing of ending the turn, based on the command being selected;
processing of determining a special effect to activate in a case where a special command is selected by a player, based on a predetermined number of pieces of the predetermined game content obtained; and
processing of activating the special effect determined, in a case where the special command is selected.

2. The non-transitory computer readable medium according to claim 1, wherein
the special effect includes a time-limited effect with the number of turns set as an effective period, and
the time-limited effect is active during the effective period.

3. The non-transitory computer readable medium according to claim 1, wherein the program further causes the computer to execute:
processing of activating a first effect associated with the predetermined game content obtained, based on obtainment of the predetermined game content, and
processing of deactivating the first effect, based on the special command being selected.

4. The non-transitory computer readable medium according to claim 1, wherein the program further causes the computer to execute:
processing of allowing a player to select the special command in a case where the number of obtained pieces of the predetermined game content reaches a specified number.

5. The non-transitory computer readable medium according to claim 1, wherein the program further causes the computer to execute:
processing of determining a plurality of second effects, based on a plurality of pieces of the predetermined game content, the number of which is less than the predetermined number,
the processing of determining the special effect includes determining the special effect, based on the second effects.

6. The non-transitory computer readable medium according to claim 1, wherein
the processing of determining the special effect includes determining a special effect from among a plurality of types of the special effect provided in advance.

7. The non-transitory computer readable medium according to claim 6, wherein the program further causes the computer to execute:
processing of managing, for each of the plurality of types of the special effect, information associated with the number of times the special effect has been activated,
a benefit of the special effect provided during the game increases with an increase in the number of times the special effect has been activated.

8. The non-transitory computer readable medium according to claim 1, wherein the program further causes the computer to execute:
processing of displaying an image corresponding to the special effect in association with the special command selectable by a player.

9. An information processing method performed by one or more computers, the method comprising:
processing of, in a game including a plurality of turns, allowing a player to select, for each of the plurality of turns (hereinafter referred to as “the turn”), any of a plurality of commands for ending the turn;
processing of storing obtainment information on a predetermined game content, based on the command selected by a player;
processing of ending the turn, based on the command being selected;
processing of determining a special effect to activate in a case where a special command is selected by a player, based on a predetermined number of pieces of the predetermined game content obtained; and
processing of activating the special effect determined, in a case where the special command is selected.

10. A game apparatus comprising one or more computers, the one or more computers executing:
processing of, in a game including a plurality of turns, allowing a player to select, for each of the plurality of turns (hereinafter referred to as “the turn”), any of a plurality of commands for ending the turn;
processing of storing obtainment information on a predetermined game content, based on the command selected by a player;
processing of ending the turn, based on the command being selected;
processing of determining a special effect to activate in a case where a special command is selected by a player, based on a predetermined number of pieces of the predetermined game content obtained; and
processing of activating the special effect determined, in a case where the special command is selected.
